(19) United States
(12) Patent Application Publication
(10) Pub. No.: US 2012/0080530 A1
(43) Pub. Date: Apr. 5, 2012

(54) PhonExpress Account-Code Electronic system (P.E.A.C.E. System) & PhonExpress system card/Slip-card

(76) Inventor: PATRICIA GRACE MARTIN, Lincoln, NE (US)

(21) Appl. No.: 12/898,681

(22) Filed: Oct. 5, 2010

(51) Int. Cl. G06K 19/06

(52) U.S. Cl. 235/494

(57) ABSTRACT

World P.E.A.C.E. Systems' PhonExpress Account-Code Electronic System & ONE PhonExpress system card, two operational Open/Close keys that protracts-out and retracts back-in a concealed slip-card, hidden into ONLY ONE PhonExpress account-code card.

Combining all usage into ONE CARD enables Capabilities for everyone to carry all Identification, medication, background history, and independently control their own account-code transactions; activate, access, send, receive, transfer, any type funds of currency, credit and obtain send, retrieve, transfer, print-out any type of informational data documents, records, mail, Electronic Shopping, immediate purchase, delivery anywhere, for any kind of merchandize and supplies.

Electronic operations Methods; of Four Portals: Four Slip-ports, Seven PhonExpress keys, electronic slip-port, receipts distribution, printer attachments, built into telephones, cellular telephones, telephone adapters, computerized keyboards, electronic entry-ways, TV remotes and various other machines: transmission P.E.A.C.E Base unit, P.E.A.C.E converter.

With the demands of today's society, people always on the go, with stress and pressure to beat a time frame. To withdraw funds from accounts at bank, ATM's, or wire funds to loved one in need, get a money-order and send it off in time, or run to pay a bill, buy groceries or pick up medications, always something! Everyone always try to run everywhere, trying to be at two places at once. Always people shopping everywhere, and getting frustrated in trying to find the right account card. There are so many account cards for everything and for every type of business or company. Along with people always have to run to go get copings and paying for each document or records of any informational data, sometimes missing dead-lines because of time frame on waiting for documents to come in the mail. Even with the Stock market. Finding there is no time to relax with family. There seems never enough time to get things done, before banks and stores closes.

Until Now, The P.E.A.C.E. system and its electronic capabilities of a One World System enable everyone the ability to independently operate and privately control his or her own account transactions. Activate access, transfer, send and receive any type of account funds with both currency and credit. Along with the ability to receive and transfer any type of informational data, and shopping, purchasing products, paying for products immediately, which enables people to have everything delivered to their doorstep or office.

P.E.A.C.E. is a One World System with its PhonExpress Account and Code Electronic System which can be done also with digital transmission communicating simultaneously of either original electronic or digital operations through PhonExpress telephones, PhonExpress adapters for original telephones, PhonExpress cellular telephones, PhonExpress computer keyboard, PhonExpress TV remote. Along with PhonExpress various adapters for: stores, convenient stores, pay at the pumps, into cars, taxi cabs, electronic entryways, libraries, schools, collages, government offices, buses, trains, airplanes, airports, pop/food machines, and more. Electronically communicating either original or digital signals through P.E.A.C.E. systems base unit or direct-line of either original or digital signals of transmission through P.E.A.C.E. system Converter relays and converses with either original or digital signals to and from business or company's computerized resource servers. With using only ONE PhonExpress system card and it's concealed PhonExpress slip-card.

### CROSS-REFERENCE TO RELATED APPLICATIONS

Earlier Inventors had made Telecommunications; Bell Invented the Telephone, Telephone adapters, Telephone systems, and then Inventors invented Cellular Telephones. P.S.T.N. Public Switches Telephone Networks, many Inventors invented different ways of Transmitting Signals with different Networks WAN Wide Area Networks, LAN Local Area Networks.

Inventors invented many different electronic devices and systems. M.T.O.S. Mobile Telephone Office Switching, Account Systems, Code Systems, Scanners, Data Processing Systems, Via Wireless Communication devices, Transmitting devices, Translation of signals device. To Satellite systems, Electronic Accountant device, Processing program device, Laser devices, Laser aLay, Electronic transmitting devices, Fiber-optic cable and Radio waves to transmit signals through Gateway dishes relaying and transmitting signals to Satellite back and forth. Along with these Inventors, inventions of many different Account cards, of either Currency or Credit that enables activation and accessibility to accounts at Banks, and other Financial institutes, and also usage of accounts by going to an ATM machines, or out to a department store along with usage of Credit card machines, accessing credit accounts wherever credit is established.

Inventors invented Electronic machines that enable people to swipe Account cards or Credit account cards when People are out shopping at Department, or Convenient, Grocery stores. Account cards are used only where it states for that certain Account card or Credit cards or Store card is usable. Accessing account funds to pay for merchandize when shopping at that place of Business or Companies. Inventors invented many different Computer devices and Computer systems E.D.P Electric Data Processing, C.P.U's Central Processing Units, A.D.P Automatic Data Processing, T.D.D Deaf Device, G.S.I Bar-Coding system, Electronic Communication devices for almost everything.

Then Inventors invented the Internet system where people can access accounts on the computer with Internet access, enables people worldwide to shop on line, check Bank accounts, many different options with usage of computers with Internet accessibility. With all this Technology, People have had a lot of problems. With Account hackers, Check frauds, Account frauds, Mail-order frauds, stolen or lost Checks, Checks' bouncing becomes very Costly. People had been robbed, while using their Debit cards at ATM machines.

There are so many different Account cards and all kinds of Credit cards either get stolen or lost; there are some issues where it is not that safe in public places for shopping. People getting scammed or their Identity stolen, because people give out vital information to strangers to open accounts at banks or to strangers over the Internet.

Inventors invented a way to paying bills, usage over the Telephone or Cellular telephone, by either the caller place a call to the company or a business, and giving out vital information, speaking to a person (a stranger) at a business or company of whom they have a bill with. The caller gives out personal information of their name, routing number, account number and authorizes a certain amount for which the company post to remove out that account number given. Then that company or business is able to post amount to pay on the bill, of an amount of funds required for payment on the bill account. This process does Not make funds available, funds are not immediate, this account process takes time and a lot of paper work, 48 hours before account transaction is finished. This process is Very time-consuming and the caller had to give-out vital information about themselves and their account.

Then Inventors invented a way of Automatic Bill Pay on an account. This process is used with a Computerized Voice or Teller that a person calls and contacts the company or business of a bill that is owed and gives vital information out. Speaking to Computerized Voice or Teller, the person gives their name, and routing number, account number and authorizing company or business to remove automatically a certain amount out every month and place it to that bill account. This does cause problems for caller, if the caller forgets that this certain amount is to be taken automatically out of that account or/and is not able to have that amount in their account at the time the bank processes the amount. This is not always accurate with keeping on track, keeps repeating it, then disconnects a person. Or if a person is not fast enough for the computerized voice it will disconnect and the person has to start all over. Then there is where a person would only get to talk with a computerized voice instead of either getting the business taken care of with a real person or handling the business themselves. This does become very costly.

Then Inventors invented a way of paying on billing accounts through accessibility of Internet services, with a computer or on a telephone or cellular telephone. This process requires that the caller needs to have a computer or a telephone or a cellular telephone with accessibility to the Internet and its services, and the person has to have knowledge of a computer or how this operates on telephone, cellular telephone along with knowledge of the usage of the Internet. Then the caller is able to access and enter into a web-site through the Internet to the location of the place for the bill and then has to find their account of the bill. Then the person/caller is able to see how much the bill is through the Internet web-site. Person/caller wants to make a payment, through the services of the Internet, this requires, entry of that persons personal account data giving vital information out, name and account number through Internet banking web site. Then entering an amount of funds that will be removed out of that account number entered in. this is great except the person has to establish a computer or a telephone or a cellular telephone with accessibility with Internet serves, this can become very costly and Internet services does cost extra.

Inventors invented a way to send informational data, by usage of a Scanner, Fax machine, this process is where a person's has to leave the privacy of residence and goes out to a place that has Faxing machine, or if able to own their own Fax machine. When a person does go out to a place that has usage for Faxing, there is a price for each page Faxed, of any informational data. The person (customer) then has to fill out forms, and enters their vital information, their name, address, phone number and the name of the person of whom the papers is to be Faxed to, to send the information along with writing out name of person or/and company, or business. Then the person has to make sure to have the right number, and phone number or code number of place, and addresses of both (themselves the customer, the sender) and receiver of the informational data. Then the process of informational data faxing papers is Faxed and sent to another place, and then the person (customer) of the Faxing pays for this process.

Inventors invented a way to Electronically Wire money, with sending funds. This process is that a person has to leave the privacy of their residence or office, and go out in any kind of weather, to the get money from account at bank. Then the person has to find a place that has the ability to Electronically Wire the funds. Then the person fills out paper, giving vital information, their name, address, and amount of funds to send, along with name of who is to receive the amount of funds and the address of place. This process takes time, it can be very costly, and then that person pays for the Electronic Wiring of funds. The more the amount of funds is to wire, the more the cost will be to send.

Inventors invented a way to send funds by Money Order, this process requires that the person has to leave privacy of residence or office, even in unfavorable weather to go and purchase a Money Order, and send it through the mail to pay the bill. The person has to go to bank and get the funds (money) then has to find a place that distributes Money Orders. Then the person purchases the Money order, either at a bank or some other business establishment, the price of a Money Order can be different depends on where a person goes to purchase the Money Order. Then the person pays the amount of money that is needed or wants on the Money Order, plus the cost for the money order. Also the Money Orders can increase in price with the amount to be sent, and then the person fills out Money Order of the name of the place to who is to receive the Money Order, and also the person signs their name and address then has to purchase an envelope and then puts the Money Order into an envelope. Then the person has to purchase the cost of a postage stamp, and places that on the envelope and sends it in the mail. With this process the person is taking a chance that the funds may not get to place in time. Or the mail could get lost or returned.

Inventors invented a way to purchase products with Account cards, Debit cards, Credit cards, Rechargeable card, In-store Credit cards, there is so many different Account cards and Credit cards, that a person uses, or misplaces, or gets stolen, this is very costly to replace. Example: a person runs to one store, using the credit card that is issued for that store, then goes to another store that has issued a different credit card or/and also uses their account card to purchase items. There is so many different credit cards and account cards that enables a person to have a lot of fun and it is so much easier to run and spend, run and spend, run and spend, using all different kinds of credit cards here and there along with using account cards. But in the long run some people get carried away and end up owing so many different credit companies, or some people realize later they are over drawn on their accounts of currency at the bank. This in-turn becomes very costly, and some people get in so much debt that they have to file bankruptcy.

As we know, in this world there are too many account cards

Inventors invented a way for account card usage with debit cards that can be used at ATM machines, and other businesses, companies at certain times of the day or night, which the person has to leave here there to take care of their business.

Inventors invented another-card: for usage with accounts with credit, wherever credit is established. Every credit company issues out their own credit cards. That has to be used where their credit card states. Which there are so many credit cards, it's hard to carry all them and keep track of every card, and credit accounts.

Inventors invented another-card: a way a person wouldn't need to carry any currency at all, by placing funds directly on a Rechargeable account card.

Inventors invented another-card: a way a person is able to use telephone without having change to place a call. They invented a Phone card. Where prepaid minutes are placed on and taken off when ever used for telephone calls.

Inventors invented another-card: a way a person carries Identification on different cards, by usage of a Driver's License, Social Security card, Birth Certificates.

Inventors invented another-card: for a person to carry all medical history placed on their-own card, for hospitals medical card, Pacemaker/ICD cards, along with inventing tags to display health alert problems, stating Diabetic, Heart, Secures, and Allergic to penicillin, High blood pressure.

Inventors invented another-card: for a person to carry insurance information easier, with usage of insurance cards to show insurance identification.

Inventors invented another way, easier for businesses to keep track of purchased items. this enables businesses to keep the amount of money that a customer purchased the item/items with. when a customer returns the item/items without a receipt the customer is given an In-store credit card, that carries the amount of that item/items that the customer returned, also when a customer returns item/item with a receipt that business offer to give the customer an option to have the amount of funds for those returned item/items to be placed on a In-store credit card. Then that amount goes on credit, and is placed on an in-store credit card that is to be used only at that store, or the customer may have the funds of currency returned to them.

All these cards and plus more-cards; debit cards, bank cards, credit cards, check cards, employee cards, time cards, Money cards, School lunch cards, Library cards, Fax machine cards, Book store cards, Money cards when you don't own a debit card. Telephone cards, Pre-minute card, ID cards, Social Security cards, Insurance cards, Medical cards, EBT cards, Unemployment cards, Identification cards. And more . . . . More . . . . There are so many different cards that carry funds with currency or credit, so many different cards that carry vital informational data, which is great, but with so many different cards to carry and keep track of makes this very hard for a lot of people.

Many inventors invented many different kinds of electronic devices and systems to run accordingly, each individual device and computerized systems are made for certain operational functions to complete each electronic task. Electronic binary system of numbers and codes, electronic laser aLay system, electronic accountant device, telephone systems, telephone cellular systems, via telephone transmitting systems, digital signals transmittal device, electronic faxing devices, electronic scanner device, computerized account systems, electronic digital data systems, computerized inventory systems, via satellite systems, computerized processing programs.

Through the years inventors have improved many different ways to transfer funds in and out of accounts. Made different ways to purchase products and pay with account cards or credit account cards. This made a quicker way to retrieve information through faxing machines, and through Internet access and printer.

Through computers to purchase internet, or to pay or purchase items, bills, etc. . . . must need to enter personal info and account numbers, along with address which has made everything easier, but there seems to be a lot of internet hacking and stealing of account numbers and peoples personal information.

People watch allot of TV, and with live TV which people like to purchase products but they no way of doing so unless they call in to company or business to place an order and give vital information of account numbers over the telephone or send funds by money order or check through mail which this process takes time even weeks before receiving product purchased.

Then inventors invented a new way to send signals with digital signals for transmitting programs for television, everything is going digital signals for electronic transmission.

### FEDERALLY SPONSORED RESEARCH OR DEVELOPMENT

### RESEARCH OF INVENTION

2009 Invention

### Notarized: by Notary Republic: Cornhusker Bank, 11 & Cornhusker, Lincoln, Nebr.

“”Aug. 5, 2009 LITMAN LAW OFFICES:

Docket No. 31723.00 Utility and Design Patent LTD: Preliminary Patentability Patent Search: Processed by, Registered Patent Agent; Horace L. Flournoy Richard C. Litman NO evidence Found of this said Invention. Wanted preparation and filing of patent application to obtain “Patent Pending”

Mailing address: P.O Box 15035 Crystal City Station Arlington Va. 22215

Street Address Patent Law Building 3717 Columbia Pike Arlington Va. 22204

Internet Address www.4patent.com

“”Nov. 11, 2009:

Lambert & Lambert, Inc

Invention Marketing and Licensing

rell Blvd. Suite 200 St. Paul, Minn. 55125-2290

Terry Lambert, Vice President processed an Evaluation on my invention

Research and Development Company: Evaluated Invention: States Invention is good, did not qualify for their development because I was told I had not had a Patent Search done at this time of my Invention, nor did I have Invention Patented or Trademark. (But as dates shown above, I did have already On Aug. 5, 2009 a Patent Search done)

I replied; I had a Patent Search done in September of 2009, but Lambert & Lambert Research and Development, Stated there was no search done, and I did not have it Patent or Trademark. But I had not enough funding to proceed on with Litman Law, Patent Attorney. I myself now proceeding on and requesting a Patent

### BACKGROUND AND FIELD OF INVENTION

Everyone Benefits, P.E.A.C.E. system gives people advantages of controlling their own personal accounts themselves. Enabling through PhonExpress telephones, PhonExpress telephone adapters, PhonExpress cellular telephones, PhonExpress Store adapters, various PhonExpress adapters, PhonExpress computerized keyboard and PhonExpress TV remote operational changing keys and PhonExpress system card Portals and Slip-ports accesses, activates, account-code transactions for funds of either currency or credit, wherever credit is established. Without talking or giving out any vital information to another person or a computerized voice. Usage is either in privacy of residence or office anywhere anytime day or night worldwide.

P.E.A.C.E system enables people to pay on bills, receive paychecks, transfer, send, and receive account funds immediately without delay. Accounts at their fingertips without needing to rush-out in traffic to pay on any type of bills, or leave anywhere in unfavorable weather, to send or receive account funds to or from anyone. If away on vacation or at collage in need of funds, PhonExpress cellular telephones enable people to have account usage right by their side, day or night anytime worldwide. If in a hospital, unable to leave anywhere to go pay bills, with usage of PhonExpress telephones gives the availability for any type of account transactions, whether be accounts of currency or credit or to retrieve or send any type of informational data, quickly. P.E.A.C.E. system protects against identity theft, check frauds, mail-order frauds, thievery of classified informational data, shopping thievery.

P.E.A.C.E. system enables electronic shopping through PhonExpress account-code telephone systems it's as easy as making a call. Giving everyone the ability to relax more while taking their time shopping, for purchasing any products of choice. Shopping privately at residence with PhonExpress telephones, PhonExpress telephone adapters and PhonExpress cellular telephones, PhonExpress computerized keyboard and PhonExpress remote for TV.

PhonExpress electronic digital operations of purchasing products and immediately paying for products, or paying on bills directly to business or company's computerized resource server of accounts, or codes, data for obtaining products, paying for merchandise, account transactions or retrieving informational data. Enables People to have merchandise delivered at their doorstep or to any address they choose. Shopping is done anywhere, anytime, day or night, worldwide.

Shopping with P.E.A.C.E. made Life easier, without running here or there to different stores, dealing with crowds, or waiting and standing in long lines at a checkout stands to purchase items, dealing with bad weather, or children running about wanting everything. Or getting stressed out with worry of how much time is left to shop, needing to leave to pick up their children from school or get to the bank on time, before it closes.

Especially helpful enabling people who are disabled, handicapped, blind, vision impaired, deaf, hearing impaired, elderly, ill and hospitalized to shop for essentials, grocery's, medications without depending on a ride or needing to leave anywhere and have everything delivered to residence or wherever they're at. Enables everyone to purchase and pay for products themselves, with the ability of P.E.A.C.E. systems operations of account transactions, usage of either account with currency or credit, wherever credit is established. Enables businesses and companies to receive their funds immediately and electronically gives receipts to both FIG. II-III PhonExpress telephone which intern distributes receipts of date, time, account transaction, amount of payment, delivery time, where to be delivered and place of businesses or company computerized account resource system.

P.E.A.C.E. system enables the ability to access, retrieve and transfer any type of informational data through operations of FIG. II-III-IV-VII: PhonExpress electronic account-code telephone systems through and connectivity with a printer for larger informational data. People transfer and retrieve any type of informational data or by accessing PhonExpress telephone keys entering a code of informational data. There's no need for people to leave anywhere to send or receive informational data, to or from hospitals, police departments, schools, work, collages, businesses, company's banks. People retrieve prescriptions, having medication processed, paid for, and delivered, all through PhonExpress telephones, PhonExpress cellular telephones, PhonExpress telephone adapters and with printer usage. Costs are just as little PhonExpress call.

P.E.A.C.E. system usage of ONE FIG. I: PhonExpress system card, this establishes four electronic digital account-code Portals. These Portals are electronic entryways to account-code terminals. Activation is by sliding one of the portals of PhonExpress system card through PhonExpress e-system account-code slot-port located on either of FIG. II: PhonExpress telephones, FIG. III: PhonExpress telephone adapters, FIG. IV: PhonExpress cellular telephones FIG. VII: PhonExpress keyboard, FIGS. VIII: PhonExpress TV remote and FIGS. VIA, VIB, VIC, and VID. PhonExpress various adapters.

FIG. I PhonExpress system card usage's of account Portals with entry to either type of accounts of [1] Financial-line accounts of currency or [2] Credit-line with credit accounts, wherever credit is established. Enables account transaction of funds to be distributed immediately sending or receiving account funds. There is Now, No necessary need to carry any cash on hand or any of the (many) different credit cards. Funds are immediately transferred straight to or from any business or company's computerized account or credit account resource system.

P.E.A.C.E. system's FIG. I: PhonExpress system card two account-code Portals there is also two code Portals, one code Portal is [3] Security-line: entryway to electronic terminal with usage of codes for accessibility to retrieve and send or transfer any type of informational data. Code Portal [4] Consumers-line: entryway to electronic terminal of usage with codes for shopping, purchasing, and paying for any kind of merchandise delivery from anywhere worldwide to a person's doorstep or anywhere to address entered in. P.E.A.C.E. system establishes quick and easy four electronic main account-code Portals by usage of ONE FIG. I: PhonExpress system card which activates, accesses account funds, retrieve informational data, ability to shop and purchase products, anytime day or night Worldwide. Opening electronic entryways to FIG. X: P.E.A.C.E. system base unit terminals, with operations of PhonExpress FIG. II, FIG. III, FIG. IV, FIG. V, FIG. VI, VI-A, VI-B, VI-C, VI-D, VI-E, FIG. VII, FIG. VIII: PhonExpress usage without talking to anyone, or a computerized voice, there is no delay, or waiting in long lines or leaving anywhere, to acquire account funds, informational data, or merchandise. Transmitting digitally to computerized resource servers or direct connection with FIG. IX: P.E.A.C.E. Converter of computerized resource server.

FIG. I: PhonExpress system card enables activation of four electronic account-code Portals for entry to any accounts in account systems. Access funds immediately anywhere, wherever accounts are. Or Portals pertaining to codes for entry of any codes for informational data and shopping, which transmits electronically digital signals with usage of the account systems and binary code systems.

Along with FIG. I: PhonExpress system card has hidden inside a concealed FIG. I-I: PhonExpress slip-card, which establishes four electronic digital Slip-ports that are released by pressing on either open/close keys, located on the front/top of either right or left side of FIG. I: PhonExpress system card. Which intern protracts out the FIG. I-I: PhonExpress slip-card and by repressing the same open/close key retracts the FIG. I-I: PhonExpress slip-card back concealed into FIG. I: PhonExpress system card.

By using only the One FIG. I: PhonExpress system card Portals and its concealed FIG. I-I: PhonExpress slip-card Slip-ports enables cardholder more accessibility to various computerized digital accounts accessing by usage of either PhonExpress FIG. II-FIG. VIII: or anywhere account cards are used.

Enables people to have access to account funds of currency, credit or in-store credit and any informational data, Identification, Medical information. All funds and information are easy to carry and access through FIG. I: PhonExpress system card and through FIG. I-I: PhonExpress slip-card.

FIG. I-I: PhonExpress slip-card left side Slip-port [5] Reserve-line: and Slip-port [6] Express-line: Also on the right side enables a person Identification with FIG. I-I: Slip-port [7] IDH-line: Medical History with FIG. I-I: Slip-port [8] MDH-line: which would display on FIG. II-IV: PhonExpress telephones LCD screens.

FIG. I: PhonExpress system card; there is four main account-code portals out-side, along with FIG. I-I: PhonExpress system card, four Slip-ports that are concealed inside of FIG. I: PhonExpress system card. These Slip-ports protract out, by pressing either the left or right open/close keys on the top of FIG. I: PhonExpress system card. Which intern FIG. I-I: PhonExpress slip-card protracts out either two Slip-ports from left-side or two from the right-side, for usage of each five computerized digital accounts (of choice) needed and retracts back in by repressing the same open/close key again.

With P.E.A.C.E. system FIG. I: PhonExpress system card its concealed FIG. I-I: PhonExpress slip-card protracts out from the left-side is Two Slip-ports ‘top’ is [5] Reserve-line, that enables entry to five computerized digital account options for accessing funds of currency that have been placed directly into these computerized digital accounts. Which helps cardholder easy access to choice of one of the five computerized options to maintain budget, access funds of employment, unemployment, EBT and SSI Enables cardholder more access to the funds anywhere, anytime, Worldwide. Along with a Slip-port [6] Express-line that establishes usage of five electronic computerized digital account options. This enables by choice of usage in funds of credit to pay-at-pumps, in-store credit, prepaid minutes for usage of PhonExpress devices, funds of bus or taxi usage, enables accessing usage of business or companies discounts.

Through usage of the concealed FIG. I-I: PhonExpress slip-card electronic operations of Slip-ports accessing choice of either five computerized digital account options. Option 1: Express-fuel enables usage for cardholder to pay-at-the-pumps after receiving total amount for fuel. Option 2: Express-store enables usage for cardholder to use in-store credit wherever cardholder has established in-store credit. Option 3: Express-phone enables usage for minutes with any of the FIG. II-IV PhonExpress telephones. This enables cardholder more PhonExpress usage to place a call or use P.E.A.C.E. electronic operations of account-code transactions by placing minutes on this account and with usage of a call or an account transaction, account funds are used which takes minutes off. Option 4: Express-ride enables easy way of paying for bus or taxi instead of trying to find change or bus pass funds are handy and access is easy. Option 5: Express-disc used at various places of business or company. Every place has its own discount easy to access by entry of Express-disc and entering code number of store access that place of companies or business discounts and is immediately removed off of total price.

With usage of P.E.A.C.E. system FIG. I: PhonExpress system card, and releasing its concealed FIG. I-I: PhonExpress slip-card. To the right-side are Slip-ports of [7] IDH-line: This enables cardholder to have access to five computerized digital account options, which maintain informational data of cardholder. Access by cardholder's security code Option 1: ID-line: contains informational data of cardholders Name, DOB, Driver's license and Social Security number, Option 2: ED-line: enables cardholder to carry and access their educational history, diploma, collage and degrees. Option 3: Chan-line enables cardholder to change data of computerized accounts option 4 Employ-line is employment history, Option 5: BG-line is background and past history this enables a person to have all full usage, of identification, and various information which is held in electronic digital accounts. This is extremely helpful for Police officers, along with Paramedics to know who the person is. These Options are made accessible by the usage of the concealed FIG. I-I: PhonExpress slip-card. This enables access to check identification when needed. Just by sliding [7] IDH-line: Slip-port through FIG. II-FIG. IV: and FIG. VI-C, VI-E: PhonExpress slot-port electronically displays options of choice. By pressing number indicating option then entry of security code this enables information of either identification, background checks, education info on LCD screen, and enables for print-out if needed. Along with an easy access for people to display ID. With usage of P.E.A.C.E. system FIG. I: PhonExpress system card releases the concealed FIG. I-I: PhonExpress slip-card to the right under-side is [8] MDH-line Slip-port. This enables a person to have access to a Medical list containing of cardholder's health conditions, and a list of any Medication used by cardholder. This is held in an electronic digital account accessed from FIG. I-I: PhonExpress slip-card. Which enables access or to check any medical problems, and what medications that person is on or needs. By sliding [8] MDH-line: account through a FIG. II-IV: and FIG. VI-E: PhonExpress telephones slot-port electronically displays a list of Medical problems, Medication that is being used (by cardholder) on FIG. II-IV: and FIG. VI-C, VI-E: PhonExpress LCD screen and enables for a print-out if needed. This would be extremely useful for Doctors, Paramedics, Hospitals, Police Officers, as well as the person themselves.

All these different types of accounts accessible and wrapped up into one FIG. I: PhonExpress system card. Enables an easy way people have everything right at their fingertips.

FIG. X P.E.A.C.E.-system base unit, is combining computerized electronic transmission of digital signals and electronic binary number and code, electronic accountant, processing procedure's of systems together, usage through FIG. II: PhonExpress telephone, FIG. IV: PhonExpress cellular telephone, FIG. III: PhonExpress telephone adapters, FIG. V: PhonExpress store adapters, FIG. VII: PhonExpress computerized keyboard, FIG. VIII: PhonExpress TV remote. PhonExpress adapters are endless are used for FIG. VI-C: electronic entryways, schools, collages, libraries, government offices, FIG. VI-A: vehicles, taxi cabs, FIG. VI-B: buses, placed into FIG. VI-D: pop/food machines FIG. VI-E: hospitals and with usage of one FIG. I: PhonExpress system card. Benefits everyone adequate time and cost, with accounts, funds, retrieving information, shopping.

This invention relates to combining technology of electronic digital computerized systems together, is an electronic account-code transactional system, with currency and credit, classified informational data, purchasing products. Activation, accessing, processing programs of accounts and code systems through Communications of computerized transmittal digital signals data transmitting back and forth via satellite using FIG. X: PhonExpress account-code e-system base unit simultaneously combines digital signals, with direct communication systems electronic devises to operations of FIG. IX: P.E.A.C.E. converter. Retrieving data through wide area networks (WAN), local area networks (LAN) from other computerized resource servers systems. Activation, accessibility through revised FIG. II-FIG. VIII: PhonExpress telephones, PhonExpress desk telephones, PhonExpress cellular telephones, PhonExpress telephone adapters, PhonExpress computerized keyboards, PhonExpress TV remote and various PhonExpress adapter devices and with usage of One FIG. I: PhonExpress system card.

This invention relates to combination of electronic technology of transmitting digital signals computerized digital data, electronic communication, electronic laser aLay processing program of electronically transmitting signals of digital data with the binary system of numbers and codes. Electronic accountant transmits signal to and from computerized resources of accounts, credit accounts, codes, business inventory and prices.

Transmission through FIG. II: PhonExpress telephones, FIG. IV: PhonExpress cellular telephones, FIG. III: PhonExpress telephone adapters, and FIG. VII: PhonExpress computerized keyboard and FIG. VIII: PhonExpress remote for TV to and from FIG. X: P.E.A.C.E. system base unit electronic processing programming of transmission. Transmitting signals to FIG. IX: P.E.A.C.E. converter that is connected to computerized resources system. Digital signals transmitted through via telephone, to via satellite, to FIG. X: P.E.A.C.E. system base unit with operations of processing accounts, prices, retrieving inventory of items, informational data. Specifically, enables a quick and easy time frame for accurate account transactions, sending or receiving funds immediately, of currency and credit, along with transferring and retrieving any type of classified information data, along with purchasing any kind of merchandise.

FIG. X: P.E.A.C.E.-system base unit digital transmission through FIG. IX: P.E.A.C.E. converter's connections of business or companies resource servers. P.E.A.C.E. system's operational methods used through FIG. II-VIII: PhonExpress device systems and FIG. I: PhonExpress system card. This PhonExpress account-code electronic system is capable to be used in privacy of residence, offices, and businesses, anytime anywhere worldwide.

Demands that are on today's society, people always in a hurry to get things done, quick and easy. Always on the go, running around in any kind of weather, trying to meet deadlines on paying bills, or purchasing this or that using all kinds of account cards. Everyone tries to keep up with the demands of the modern world. It becomes very stressful and time consuming never having enough time to relax, in the privacy of home or at the office.

With today's terrorism, identity theft, cost of living, gas prices on the rise, makes it harder for people to go places or want to shop. This becomes extremely hard and very costly for some people, whom have no transportation, are disabled, handicapped, vision impaired, blind, hearing impaired deaf, elderly, to be able to leave, to access funds, pay on bills, purchase grocery's, prescriptions, and mechanize at stores, banks, pharmacies. Some people at work or office, during their lunch hour, try to beat the time, with leaving to get funds from the bank, or pay on a bill, purchase a product, because some businesses are closed before they are able to get off of work or out of office. When a loved one is in school, away at college, or overseas and is need for funds quickly, this consumes a lot of time, wiring funds, could take days, possible weeks and is very costly.

Now, the operations of FIG. X: P.E.A.C.E. system base unit and digital transmission of direct-line to FIG. IX: PEACE converter. Through usage of FIG. II: PhonExpress telephones, FIG. IV: PhonExpress cellular telephones, PhonExpress FIG. III: telephone adapters, and FIG. VII: PhonExpress computerized keyboard, FIG. VIII: PhonExpress TV remote usage of ONE FIG. I: PhonExpress system card. People are able to have account transactions at their fingertips. Enables everyone to independently, in the privacy of residence or office anytime, day or night anywhere Worldwide, have complete control and accuracy over their own account transactions, activating, accessing, sending or receiving, transferring account funds with any accounts of currency or credit. Purchasing products, paying for products, paying bills, receiving checks, retrieve and transfer informational data or classified informational data.

FIG. X: P.E.A.C.E.-system operations with FIG. II-FIG. VIII: PhonExpress telephones, PhonExpress cellular telephones, PhonExpress computerized keyboards, PhonExpress TV remotes, and PhonExpress various adapters for usage of FIG. I: PhonExpress system card is for everyone. Very economical cost is as less as a FIG. II-FIG. IV: PhonExpress telephone call.

Extremely helpful for disabled, vision impaired, blind, hearing impaired, deaf, people hospitalized elderly, military men and women. Enables people immediate funds, financial accuracy, Enables account transactions, Shopping, retrieving information anytime, Worldwide over FIG. II-FIG. VIII: PhonExpress telephones, PhonExpress cellular telephones, PhonExpress computerized keyboard, PhonExpress TV remote, and PhonExpress system adapters.

P.E.A.C.E. System's enables to help people to transfer medical records, without needing to go from one doctor's office to sign papers, to have them transferred to another doctor's office. This process is quick and fast. With in no time doctors are able to have medical records in minutes. Enables to help people to keep track of where EBT accounts are used, and unemployment accounts are used. Whether or not used for the right purpose.

P.E.A.C.E. system enables a variety of protection and carries great benefits against identity theft of accounts and a persons' identification, by the person accessing activating accounts and code themselves personally, having control over their own accounts and codes.

### SPECIFICATION OF PROTECTION AND BENEFITS

1. Protection against account identity theft, frauds, hackers Informational data thievery,
2. No Account card charges
3. No ATM charges or amount fees, Protection against thievery
4. No Bank charges,
5. No fee amount for opening account,
6. No monthly fees
7. No Mix-up with transaction of account funds
8. No Checks
9. Protection against Check frauds,
10. Protection against bouncing Checks
11. No Credit card charges
12. No Embarrassments with Mix-up of account cards
13. Helps Paramedics, Police to be able to retrieve Identification of a person who is unconscious
14. Helps Paramedics, Doctors are able to retrieve any medical history on a person and medications quick
15. Protection against Identity theft: with mail, Mail-order fraud
16. Protection against Shoot-outs at business establishments, Thievery of merchandize (not paid for)
17. Protection against Thievery or Losing one of the many account cards (with currency or credit) ID cards, Military ID cards, Medical cards, SS card, Bank card,
18. Protection against Thievery of carry any currency on person
19. Enables more usage with Account-Code or Code-Account for any transactions, used with digital signals or without on FIG. II-FIG. VIII PhonExpress systems, at ones fingertips, made more privately at place of residence or office activating, accessing accounts of either currency or credit, along with retrieving classified information in seconds, electronic shopping made faster and easier just a phone call away,
20. Enables more usage of Account-Code or Code-Account transactions over FIG. II-VIII PhonExpress systems through cellular telephone, telephones, computerized keyboard, TV remotes, Activating accounts, accessing accounts in vehicles, on planes, on boats, on trains, vacations, away at collages, overseas, anywhere-anytime
21. Enables more usage of Account-Code or Code-Account transactions over FIG. III PhonExpress adapter that is connected to original telephone
22. Account-Code or Code-Account activated, accessed without speaking to anyone or a computerized voice
23. Self-control over Account usage of checking, savings, bonds, insurance's, CD's, medical, medication lists, EBT, unemployment, stocks, phones, bills, records, documents, school lunches, collage funds, school homework, background checks, identification, telephone minutes, medical information, doctor records, police records, any place that has account numbers and account cards
24. Builds up economy
25. More employment
26. Easier for businesses to maintain and access their accounts and codes
27. Less stress
28. No delays
29. No crowds
30. No waiting
31. No long lines
32. No need to carry cash
33. Very economical
34. Less cost
35. Profits everyone
36. Less time consuming
37. Less traffic
38. Less gas usage
39. Read-outs or Print-outs made easy with FIG. I-1 Slip-card Slip-port accounts of [7] IDH-line of Identification, background check, [8] MDH-line of Medical history, Medication usage of cardholder
40. Extremely useful and benefits everyone, our military men and woman, people who are disabled, handicapped, vision impaired, blind, hearing impaired, deaf, elderly Gives more independence
41. Enables People More security and more time relaxing and handy for everyone
42. Everything in One FIG. I PhonExpress system card and concealed FIG. I-1 Slip-card
43. Enables people Self-usage of their very own personal accounts concealed within FIG. I: PhonExpress system card, when in need, access by pressing on one of the open/close keys that protracts out FIG. I-I Slip-card and retracts back in on either the Left-side or Right-side of choice.
44. FIG. I: PhonExpress system card is usage of any type of Account-Code and Code-Account all in One
45. Everyone themselves is able to electronically access, retrieve, transfer informational data, transfer prescriptions to pharmacies, background checks, weather be schools, jobs, police records.
46. Enables people themselves immediate action over their own Account-Code and Code-Account transactions Accessing their own medical information, classified records, any type of accounts with funds, credit, information, records any type of classified information, from FIG. IX: P.E.A.C.E. converter connected to any businesses or companies computerized resource system Send or transfer any type of funds or any type of classified information, quickly to anyone, away at college, overseas, on vacation worldwide
47. This is all used over FIG. II: PhonExpress telephones, FIG. III: PhonExpress telephone adapters, FIG. IV: PhonExpress cellular telephones, FIG. V: PhonExpress store adapter, FIG. VI, VI-A, VI-B, VI-C, VI-D, VI-E PhonExpress various adapters, FIG. VII: PhonExpress computerized keyboard and FIG. VIII: PhonExpress TV remote-keypad
48. ONE FIG. I: PhonExpress system card established with usage of two open/close keys either protracts-out or retracts back-in the concealed FIG. I-1: Slip-card
49. Enables Transmission, analyzing process, translating data, transforming Account-Code and Code-Account data into digital signals, transmitting electronically through FIG. X: P.E.A.C.E. system base unit and its electronic usage through FIG. Ix P.E.A.C.E. Converter and its direct-line and connection to any and all business or companies computerized resource server
50. Enables with FIG. VIII: PhonExpress TV remote shopping and purchasing directly from Live TV sale programs with delivery
51. Enables with FIG. VII: PhonExpress computerized keyboard shopping and purchasing directly through the computer without usage of accounts used over the internet, only through P.E.A.C.E. system
52. Enables easy Identification and background checks at any FIG. VI-C PhonExpress adapters for electronic doorways, for offices, schools, collages, airports, police departments, government offices FIG. VI-E hospitals, doctors Enables easy pay for electronic account transactions, sending, receiving, transferring funds with FIG. VI-A, VI-B, VI-PhonExpress adapter for buses, or taxi cabs, just one swipe while boarding a bus, or taking a ride with taxi cab,
53. Maintaining Self-control over Account-Code transactions with-out leaving anywhere, running place to place, activating and accessing their own account transactions, inventory on account records themselves, availability to setup financial plans personally, controlling own account records independently and personally anytime to anywhere
54. FIG. I: PhonExpress system card Portal [2] Credit-line: entry to an electronic terminal that pertains to credit, wherever credit accounts are established.
55. Enables for activation and accessibility to any credit account with any place of business, that the person has credit established, usage with entry of route number, credit account number and cardholder's security code, usage with any FIG. II-FIG. VIII PhonExpress systems telephones, telephone adapters, cellular telephones, computerized keyboards, TV remotes, anytime day or night Worldwide.
56. Receiving account or credit account funds immediately
57. FIG. I: PhonExpress system card Portal [1] Financial-line: entry to an electronic terminal that pertains to accounts of currency
58. Enables activation and accessibility to any amount of funds with any accounts with currency, with entry of route number, account number and card-holder's security code, usage on any FIG. II-FIG. VIII PhonExpress systems anytime day or night Worldwide.
59. ONE FIG. I: PhonExpress system card: establishes four main account-code portal terminals
60. FIG. I: PhonExpress system card with in, is concealed FIG. I-I Slip-card establishes four accounts and electronic computerized terminal of options directly on and through account usage of FIG. I-I Slip-card
61. FIG. I-1 PhonExpress slip-card Slip-port [5] Reserve line: enables cardholder entry to access five options of digital computerized accounts, which provides another different way for accessing funds, funds of either currency or credit placed on different computerized account options from different sources Enables easy-way of budgeting, handier for any type of funds for cardholder to self-control.
62. FIG. I-I Slip-card and its Slip-port [6] Express-line: entry ways to five electronic computerized options
63. Electronic entry to five computerized accounts by usage through one account-code line, activating [6]Express-line by sliding through FIG. II-FIG. VIII PhonExpress systems slot-port which then PhonExpress telephones, PhonExpress cellular telephones, or PhonExpress adapters electronically displays on LCD screens, Computerized screens, three computerized electronic options to choose from
64. Enables people more independence and keeping track of account flow with either of currency or credit, more accurate and precise
65. FIG. VIII: PhonExpress remote for TV, has made it easier to purchase products from live viewing and immediately pay for items with delivery.
66. FIG. VII: PhonExpress keyboard for computers enables shopping and paying immediately for products more protection and private without entering vital information over the web site.
67. Extremely fast and efficient Enables people themselves to have control over account-code transactions
68. Enables Everything done at residence or office people not have to go anywhere or worrying weather conditions
69. FIG. I: Portal B [4] Consumers-line: entry to electronic digital code terminal, which P.E.A.C.E. system electronically connects a direct line to FIG. IX: P.E.A.C.E. converter that is electronically connected to business or companies resource server of data inventory and prices transmitting digital signals simultaneously to and from FIG. II-FIG. VIII PhonExpress systems of telephones, telephone adapters, computerized keyboard, TV remote, cellular telephones, store adapters. Engaging into FIG. X: P.E.A.C.E. Base unit terminal system for electronic operations, processing account-code transactions transmitting digital signals with FIG. IX: P.E.A.C.E. converter that's connected to business or companies computerized resource systems.
70. P.E.A.C.E. establishes a fast and easy way to shop electronically, purchase products immediately for any kind of merchandise, products, buying groceries, medications, transportation tickets etc usage at home in seconds quick and easy, over PhonExpress systems of telephone, telephone adapter, computerized keyboard, TV remote, have everything delivered to their doorstep, or anywhere anytime, day or night to anywhere, worldwide
71. Controlling in-store accounts easier with usage one of FIG. I: PhonExpress system card it's concealed FIG. I-I Slip-card Slip-port [6] Express-line and its one out of five electronic computerized options Option 2 Express-store
72. FIG. VII—PhonExpress computerized keyboard, enables sharing the usage, changing the computer keyboard system into PhonExpress keyboard. While shopping on internet PhonExpress keyboard will obtain informational data of items and prices, chosen, PhonExpress interacts with Internet, Without any information given over the Internet totally through different terminals of transmission of digital signals enables for a different process of account-code transactions with funds of currency or credit accounts through transmission of digital signals to satellite to FIG. X: P.E.A.C.E. system base unit to any of FIG. IX: P.E.A.C.E. converters connected to business or companies resource servers.
73. FIG. VIII: PhonExpress TV remote enables electronic shopping through TV digital signals air wave easy and fast over Live TV programs and with the sales easy for obtaining and purchasing product plus have everything delivered through digital TV
74. FIG. I: Portal [3] Security-line entry to electronic digital code terminal, obtaining informational data to transfer, retrieve, or send any type of, records, documents which FIG. X: P.E.A.C.E. system base unit electronically connects a direct transmission line to FIG. IX: P.E.A.C.E. converter that is connected to business or companies resource server for codes obtaining informational data and transmitting digital signals to and from PhonExpress telephones, PhonExpress cellular telephones, PhonExpress telephone adapters, PhonExpress computerized Enables people to transfer medical records to one place to another without having to go and sign papers to release medical records from one doctors office to fax to another doctor's office.
75. PhonExpress operations enables people to have Mail transmitted to residence or office anywhere the person accesses mail from. Instead of the usage of a Mailbox. this enables all people to receive their Mail faster and easier, Not having to go anywhere, under any type of weather conditions, people are able to have their Mail Printed-out Any type of paper Mail can be transmitted electronically accessed anywhere, but packages still be delivered to address.
76. Enables people to transfer Medical records to one place to another without having to go and sign papers to release medical records from one doctor's office to fax to another doctor's office.
77. FIG. I-I Slip-card: Slip-port [7] IDH-line is an entry to access five options of digital computerized accounts, containing cardholder's informational data of personal Identification and history. Enables people to carry all informational data of ID, education, employment and background history, placed directly into digital computerized accounts Which comes in handy without hunting for it, access only by security codes.
78. FIG. I-I Slip-card: Slip-port [8] MDH-line is an entry to access five options of digital computerized accounts, access informational data containing Medical informational data of cardholder's present medical problems, list of present medication, Medical history childhood medical records. Enables cardholder to carry on them any Medical informational data and to have all their medical records handy of present health problems, present usage of medications, past medical history, childhood medical records. Access only by security codes and enables for a list of prescription medications a person is using to be printed out with connection to a Printer for larger printouts, and P.E.A.C.E. receipts.
79. Electronically accessing, retrieving themselves, or transferring informational data, or transferring prescriptions to pharmacies, background checks, weather be schools, jobs, police records, medical information, classified records, any type of accounts with funds, credit, information, records any type of classified information, from FIG. IX: P.E.A.C.E. converter connected to any businesses or companies computerized resource system Send or transfer any type of funds or any type of classified information, quickly to anyone, away at college, overseas, on vacation worldwide

### BRIEF SUMMARY

PhonExpress Account-Code Electronic System P.E.A.C.E operational with account- and code systems through PhonExpress seven operational keys, card slot-port, receipt dispensers and with Printer attachments. P.E.A.C.E. system's PhonExpress is built into telephones, telephone adapters, cellular telephones, store adapters, computerized keyboard, electronic doorway systems and TV remotes. This usage is with only one single PhonExpress system card/slip-card. Enables everyone more independence and controlling their own account transactions, activation, accessibility, and processing any type of account funds, with either currency or credit wherever credit is established. With sending or retrieving any type of informational data, purchasing any kind of merchandize, at their own residence or office and everything delivered at doorstep, anytime day or night anywhere, worldwide. This is all easily done at residence, office, hospitals, work, in a car, on vacation.

PhonExpress Account-Code Electronic System establishes ONE FIG. I: PhonExpress system card which enables electronic entryways to four main account-code portal terminals that enables activation and accessibility with security codes to any type of accounts-codes transactions; accounts of currency or credit, accessing codes for informational data, shopping anywhere. Plus by using one of the FIG. I: PhonExpress system card open/close keys, will automatically protract and retract from either side a concealed FIG. I-I: PhonExpress slip-card. Which holds four more entry's to Slip-ports. Each Slip-port establishes accessibility by security codes to five options for electronic digital computerized accounts. Establishes help for the cardholder to maintain budget and accessing funds of either currency, credit, food stamps in accounts. These computerized accounts contain distribution of funds for employment, unemployment, SSI, EBT. This enables cardholder to also carry informational data such as identification, present health problems, medical history, and present usage of medications, transmitting signals to data from medical devices, accessing funds of credit, in-store credit, or prepaid PhonExpress minutes, business or companies' discounts.

P.E.A.C.E system's ONE World System enables everyone anytime, worldwide to shop more and purchase products, food fast and easy from stores, restaurants, fast food, medications from pharmacies, and have everything delivered to doorstep. More sufficient for people to control their own account-code transactions themselves, sending or receiving, transferring funds, informational data accurately without any unnecessary charges or fees, giving people the advantage to no-longer carry any cash funds or having the necessity of any of the many other cards anymore. P.E.A.C.E. system establishes more protection, against identity theft, hackers, and terrorism, not necessary for any other account cards, identification card, medical card and many credit cards.

All easily done at residence, office, hospitals, work, in a car, on vacation anytime day or night anywhere, worldwide.

This All is accessibility with only ONE FIG. I: PhonExpress system card. As little cost of a PhonExpress call.

### BRIEF DESCRIPTION OF SEVERAL VIEWS OF DRAWINGS AND FIGURES

In the drawings, closely related figures have the same number but different alphabetic suffixes.

FIG. I-F: PhonExpress system card: SIDE 1: “Front view” Showing: SIDE 1:

FIG. I-F: K: PhonExpress Title emblem

FIG. I-F: LK1: Left Open/Close key

FIG. I-F: RK2: Right Open/Close key

FIG. I-F: B: Digital account-code numbers engraved on SIDE 1: of FIG. I-F: PhonExpress system card

FIG. I-F: B1: Number [1] Portal

FIG. I-F: B2: Name of Portal Financial-line

FIG. I-F: B3: Engraved Braille Write

FIG. I-F: C: Digital account-code numbers engraved on SIDE 1: of FIG. I-F: PhonExpress system card

FIG. I-F: C1: Number [2] Portal

FIG. I-F: C2: Name of Portal Credit-line

FIG. I-F: C3: Engraved Braille Write

FIG. I-F: D: Not showing Concealed left-side Slip-Ports [5] Reserve-line of FIG. I-1F Slip-card

FIG. I-F: E: Not showing Concealed right-side Slip-Ports [7] IDH-line of FIG. I-1F Slip-card

FIG. I-B: PhonExpress system card: SIDE 2 “Back-side” view Showing: SIDE 2:

FIG. I-B: F: PhonExpress Title emblem

FIG. I-B: G: Digital account-code numbers engraved on SIDE 2: of FIG. I-B: PhonExpress system card

FIG. I-B: G1: Number [3] Portal

FIG. I-B: G2: Name of Portal Security-line

FIG. I-B: G3: Engraved Braille Write

FIG. I-B: H: Digital account-code numbers engraved on SIDE 2: of FIG. I-B: PhonExpress system card

FIG. I-B: H1: Number [4] Portal

FIG. I-B: H2: Name of Portal Consumers-line

FIG. I-B: H3: Engraved Braille Write

FIG. I-B: I: Not showing Concealed left side Slip-Ports [6] Express-line of FIG. I-1B: Slip-card

FIG. I-B: J: Not showing Concealed right side Slip-Ports [8] MDH-line of FIG. I-1B: Slip-card

FIG. I-FL: PhonExpress system card: SIDE 1: “Front ‘Left-side’ view” Showing: Slip-Port viewing

FIG. I-F: K: PhonExpress Title emblem

FIG. I-F: LK1: Left Open/Close key

FIG. I-F: RK2: Right Open/Close key

FIG. I-F: B: Digital account-code numbers engraved on SIDE 1: of FIG. I-F: PhonExpress system card

FIG. I-F: B1: Number [1] Portal

FIG. I-F: B2: Name of Portal Financial-line

FIG. I-F: B3: Engraved Braille Write

FIG. I-F: C: Digital account-code numbers engraved on SIDE 1: of FIG. I-F: PhonExpress system card

FIG. I-F: C1: Number [2] Portal

FIG. I-F: C2: Name of Portal Credit-line

FIG. I-F: C3: Engraved Braille Write

FIG. I-I-F: D: Showing Concealed Left-side Slip-Ports [5] Reserve-line of FIG. I-1F Slip-card

FIG. I F: E: Not showing concealed right-side Slip-Ports [7] IDH-line of FIG. I-1F Slip-card

FIG. I-FR: PhonExpress system card: SIDE 1: “Front ‘Right-side’ view” Showing: Slip-Port viewing

FIG. I-F: K: PhonExpress Title emblem

FIG. I-F: LK1: Left Open/Close key

FIG. I-F: RK2: Right Open/Close key

FIG. I-F: B: Digital account-code numbers engraved on SIDE 1: of FIG. I-F: PhonExpress system card

FIG. I-F: B1: Number [1] Portal

FIG. I-F: B2: Name of Portal Financial-line

FIG. I-F: B3: Engraved Braille Write

FIG. I-F: C: Digital account-code numbers engraved on SIDE 1: of FIG. I-F: PhonExpress system card

FIG. I-F: C1: Number [2] Portal

FIG. I-F: C2: Name of Portal Credit-line

FIG. I-F: C3: Engraved Braille Write

FIG. I-F: D: Not showing concealed left-side Slip-Port [5] Reserve-line of FIG. I-1F Slip-card

FIG. I-I F: E: Showing Concealed Right-side Slip-Ports [7] IDH-line of FIG. I-1F Slip-card

FIG. I-BL: PhonExpress system card SIDE 2: “Back-‘Left-side’ view” Showing view of concealed FIG. I-1B: Slip-card

FIG. I-B: F: PhonExpress Title emblem

FIG. I-B: G: Digital account-code numbers engraved on SIDE 2: of FIG. IB: PhonExpress system card

FIG. I-B: G1: Number [3] Portal

FIG. I-B: G2: Name of Portal Security-line

FIG. I-B: G3: Engraved Braille Write

FIG. I-B: H: Digital account-code numbers engraved on SIDE 2: of FIG. IB: PhonExpress system card

FIG. I-B: H1: Number [4] Portal

FIG. I-B: H2: Name of Portal Consumers-line

FIG. I-B: H3: Engraved Braille Write

FIG. I-B: I: Showing concealed Left-side Digital account-code numbers engraved of FIG. I-1B Slip-card

FIG. I-B: I1: Number [6] Slip-Ports

FIG. I-B: I2: Name of Slip-Ports Express-line

FIG. I-B: I3: Engraved Braille Write

FIG. I-I B: J: Not Showing Concealed Right-side Slip-Ports [8] MDH-line of FIG. I-1B: Slip-card

FIG. I-BR: PhonExpress system card SIDE 2: “Back-‘Right-side’ view” Showing view of concealed FIG. I-1B: Slip-card

FIG. I-B: F: PhonExpress Title emblem

FIG. I-B: G: Digital account-code numbers engraved on SIDE 2: of FIG. IB: PhonExpress system card

FIG. I-B: G1: Number [3] Portal

FIG. I-B: G2: Name of Portal Security-line

FIG. I-B: G3: Engraved Braille Write

FIG. I-B: H Showing Digital account-code numbers engraved of FIG. IB: PhonExpress system card

FIG. I-B: H1: Number [4] Portal

FIG. I-B: H2: Name of Portal Consumers-line

FIG. I-B: H3: Engraved Braille Write

FIG. I-B: I: Not showing Concealed Left-side Slip-Port [6] Express-line of FIG. I-1B: Slip-card

FIG. I-I B: J: Showing concealed Right-side Digital account-code numbers engraved of FIG. I-1B: Slip-card

FIG. I-B: J1: Number [8] Slip-Ports

FIG. I-B: J2: Name of Slip-Ports MDH-line

FIG. I-B: J3: Engraved Braille Write

PhonExpress system's operational keys: OF LOCATION OF KEYS:

FIG. II: 1 PhonExpress telephone, FIG. II: 2 PhonExpress desk telephone

FIG. II: A: [P] PhonExpress key

FIG. II: A1: [A] Account-Code key

FIG. II: A2: [S] System key

FIG. II: A3: Slot-port

FIG. II: A4: ENTER key

FIG. II: A5: SAVE key

FIG. II: A6: C/C/C: Cancel/Copy/Change

FIG. II: A7: PhonExpress key “for PhonExpress electronic usage”

FIG. II: A8: [*] Star key “YES”

FIG. II: A9: [#] Pound key “NO”

FIG. II: A10: Receipt distribution

FIG. II: A11: Lights “for incoming calls, funds, informational data”

FIG. II: A11a: Lights “for incoming calls, funds, informational data”

FIG. II: A12: LCD Screen

FIG. II: A13: Speakers “tone sounds for incoming calls, funds, informational data”

FIG. II: A13a: Speakers “tone sounds for incoming calls, funds, informational data”

FIG. II: A14: P.E.A.C.E. Title emblem

FIG. II: A15: Vibration device “for incoming calls, funds, informational data”

FIG. II: A15a: Vibration device “for incoming calls, funds, informational data”

FIG. II: A15b: Vibration device “for incoming calls, funds, informational data”

FIG. II: A15c: Vibration device “for incoming calls, funds, informational data”

FIG. II: A16: Voice synchronizer “obtain voice change into digital data”

FIG. II: A16a: Voice synchronizer “obtain voice change into digital data”

ATTACHMENTS

FIG. II: A17: Out-let cord

FIG. II: A18: connection for Printer cord plugs in

FIG. II: A19: connection for Computer cord plugs in

FIG. II: A19a: connection for Flash-drive

FIG. II: A20: connection for USB drive

FIG. II: A20b: Plate “separating cords”

FIG. II: A PhonExpress Telephone Adapter

FIG. II: A: [P] PhonExpress key

FIG. II: A1: [A] Account-Code key

FIG. II: A2: [S] System key

FIG. II: A3: Slot-port

FIG. II: A4: ENTER key

FIG. II: A5: SAVE key

FIG. II: A6: C/C/C: Cancel/Copy/Change

FIG. II: A7: PhonExpress key “for PhonExpress electronic usage”

FIG. II: A8: [#] Pound key “NO”

FIG. II: A9: [*] Star key “YES”

FIG. II: A10: Receipt distribution

FIG. II: A11: Lights “for incoming calls, funds, informational data”

FIG. II: A11a: Lights “for incoming calls, funds, informational data”

FIG. II: A12: LCD Screen

FIG. II: A13: Speakers “tone sounds for incoming calls, funds, informational data”

FIG. II: A13a: Speakers “tone sounds for incoming calls, funds, and informational data”

FIG. II: A14: P.E.A.C.E. Title emblem

FIG. II: A15: Vibration device “for incoming calls, funds, and informational data”

FIG. II: A15a: Vibration device “for incoming calls, funds, and informational data”

FIG. II: A15b: Vibration device “for incoming calls, funds, and informational data”

FIG. II: A15c: Vibration device “for incoming calls, funds, and informational data”

FIG. II: A16: Voice synchronizer “obtain voice change into digital data”

FIG. II: A16a: Voice synchronizer “obtain voice change into digital data”

Attachments

FIG. II: A17: Out-let cord FIG. III: A17a connection to an original telephone

FIG. II: A18: connection for Printer cord plug in

FIG. II: A19 connection for Computer cord plug in

FIG. III:-FIG. III: A-MAKINGS PhonExpress Cellular Telephone (original or flip)

FIG. III: A: [P] PhonExpress key

FIG. III: A1: [A] Account-Code key

FIG. III: A2: [S] System key

FIG. III: A3: Slot-port

FIG. III: A4: ENTER key

FIG. III: A5: SAVE key

FIG. III: A6: C/C/C: Cancel/Copy/Change

FIG. III: A7: PhonExpress key “for PhonExpress electronic usage”

FIG. III: A8: [#] Pound key “NO”

FIG. III: A9: [*] Star key “YES”

FIG. III: A11: Lights “for incoming calls, funds, informational data”

FIG. III: A11a: Lights “for incoming calls, funds, informational data”

FIG. III: A12: LCD Screen

FIG. III: A13: Speakers “tone sounds for incoming calls, funds, and informational data”

FIG. III: A13a: Speakers “tone sounds for incoming calls, funds, and informational data”

FIG. III: A13b: Speakers “tone sounds for incoming calls, funds, and informational data”

FIG. III: A14: P.E.A.C.E. Titled emblem

FIG. III: A15: Vibration device “for incoming calls, funds, and informational data”

FIG. III: A15a: Vibration device “for incoming calls, funds, and informational data”

FIG. III: A15b: Vibration device “for incoming calls, funds, and informational data”

FIG. III: A15c: Vibration device “for incoming calls, funds, and informational data”

FIG. III: A16: Voice synchronizer “obtain voice change into digital data”

FIG. III: A16a: Voice synchronizer “obtain voice change into digital data”

Attachments

FIG. III: A17: Out-let cord

FIG. III: A17a: connection for Car charger out-lets

FIG. III: A18: Printer cord plug in

FIG. III: A19: connection for Computer cord plug in

FIG. III: A19a: connection for flash-drive

FIG. III: A20: connection for USB drive

FIG. III: A20a: Plate “separating cords”

FIG. IV: PhonExpress Store Adapter

FIG. IV: A: [P] PhonExpress key

FIG. IV: A1: [A] Account-Code key

FIG. IV: A2: [S] System key

FIG. IV: A3: Slot-port

FIG. IV: A5: ENTER key

FIG. IV: A7: PhonExpress “for PhonExpress electronic usage”

FIG. IV: A8: [#] Pound key “NO”

FIG. IV: A9: [*] Star key “YES”

FIG. IV: A14: P.E.A.C.E. Titled emblem

FIG. IV: A17: connection for Out-let cord

FIG. IV: A19a: connection for Computer cord plug in

FIG. V: PhonExpress TV Remote

FIG. V: A: [P] PhonExpress key

FIG. V: A1: [A] Account-Code key

FIG. V: A2: [S] System key

FIG. V: A3: Slot-port

FIG. V: A4: ENTER key

FIG. V: A5: SAVE key

FIG. V: A6: C/C/C Cancel/Copy/Change

FIG. V: A7: PhonExpress “for PhonExpress placement electronic usage”

FIG. V: A8: [#] Pound key “NO”

FIG. V: A9: [*] Star key “YES”

FIG. V: A14: P.E.A.C.E. Titled emblem

FIG. V: A22: Digital eye transmits digital signals through TV digital serves

FIG. VI-FIG. VI A, FIG. VI B, FIG. VI C, FIG. VI D, FIG. VI E, FIG. VI F PhonExpress Adapter

FIG. VI: Varity of PhonExpress adapters

FIG. VI: A PhonExpress Vehicles adapters

FIG. VI: B PhonExpress Bus adapters

FIG. VI: C PhonExpress Electronic door adapters' entryways for “schools, colleges, government offices, airports, hospitals EST.

FIG. VI: D PhonExpress Machines adapters for obtaining Food-drinks, for making payments

FIG. VI: E PhonExpress Electronic ICD Transmitters adapters to Hospitals

FIG. VI A: [P] PhonExpress key

FIG. VI A1: [A] Account-Code key

FIG. VI A2: [S] System key

FIG. VI A3: Slot-port

FIG. VI A5: ENTER key

FIG. VI A6: C/C/C: Cancel/Copy/Change

FIG. VI A8: [#] Pound key “NO”

FIG. VI A9: [*] Star key “YES”

FIG. VI A10: Receipt distribution

FIG. VI A14: P.E.A.C.E. Titled emblem

FIG. VII: PhonExpress Computerized Keyboard

FIG. VII: A: [P] PhonExpress key

FIG. VII: A1: [A] Account-Code key

FIG. VII: A2: [S] System key

FIG. VII: A3: Slot-port

FIG. VII: A4: ENTER key

FIG. VII: A5: SAVE key

FIG. VII: A6: C/C/C=Cancel/Copy/Change

FIG. VII: A7: PhonExpress “for PhonExpress electronic usage”

FIG. VII: A8: [#] Pound key “NO”

FIG. VII: A9: [*] Star key “YES”

FIG. VII: A10: Receipt distribution

FIG. VII: A14: P.E.A.C.E. Titled emblem

P.E.A.C.E. ATTACHMENTS: FIG. II: PhonExpress Telephone PAGES 14-43
Enables for account-code transactions of currency, credit, in-store credit and/or electronic shopping obtaining, retrieving informational data, anytime, day or night anywhere worldwide

FIG. II: A17 PLUG IN TO OUT-LET

FIG. II: A18 CONNECTION TO PRINTER

FIG. II: A19 CONNECTION TO COMPUTER

FIG. II: A19a CONNECTION TO FLASH DRIVE

FIG. II: A20 USB DRIVE

FIG. II: A20b PLATE DIVIDED CONNECTIONS

P.E.A.C.E. ATTACHMENTS: FIG. IIA: PhonExpress Telephone Adapters PAGE 15-43
Enables for account-code transactions of currency, credit, in-store credit and/or electronic shopping obtaining, retrieving informational data, anytime, day or night anywhere worldwide

FIG. IIA: A17 PLUG IN TO OUT-LET

FIG. IIA: A17a CONNECTION TO ORIGINAL TELEPHONE

FIG. IIA: A18 CONNECTION TO PRINTER

FIG. IIA: A19 CONNECTION TO COMPUTER

FIG. IIA: A19a CONNECTION TO FLASH DRIVE

FIG. IIA: A20b PLATE DIVIDED CONNECTIONS

P.E.A.C.E. ATTACHMENTS: FIG. III: PhonExpress Cellular Telephone PAGE 16-43
Enables for account-code transactions of currency, credit, in-store credit and/or electronic shopping obtaining, retrieving informational data, anytime, day or night anywhere worldwide

FIG. III: A17b CONNECTION FOR CAR CHARGER

FIG. III: A17c PLUG-IN TO OUT LET

FIG. III: A18a-A10—CONNECTION TO PRINTER

FIG. III: A19 CONNECTION TO COMPUTER

FIG. III: A19a CONNECTION TO FLASH DRIVE

FIG. III: A20 connection for USB DRIVE

FIG. III: A20b PLATE DIVIDED CONNECTIONS

P.E.A.C.E. ATTACHMENTS: FIG. IV: PhonExpress Store Adapter PAGE 17-43

Enables for account-code transactions of currency, credit, in-store credit anytime, day or night anywhere worldwide

FIG. IV: A17 PLUG IN TO OUT-LET

FIG. IV: A19b CONNECTION TO CASH-REGISTER

VIEWED IN DRAWINGS: PAGES 21, 22, 23, 24, 25

In the drawings, closely related figures have the same number but different alphabetic suffixes.

### P.E.A.C.E. DRAWINGS:

FIG. II: PhonExpress telephone, FIG. II: A PhonExpress telephone adapter FIG. III: PhonExpress cellular telephone,

FIG. IV: PhonExpress Store Adapter:
Enables for account-code transactions of currency, credit, in-store credit and/or electronic shopping anytime, day or night anywhere worldwide

FIG. V: PhonExpress TV Remote
Enables for account-code transactions of currency, credit, in-store credit and/or electronic shopping anytime, day or night anywhere worldwide

### A20a DIGITAL EYE:

FIG. IV: PhonExpress store adapter FIG. VI-A-FIG. VI-E: VARIOUS PhonExpress adapters VIEWED PAGE 22-27

FIG. VI-A: PhonExpress car adapter
Enables paying for taxi-rides, enables for account-code transactions of currency, credit, anytime, day or night anywhere worldwide

FIG. VI-B: PhonExpress bus adapter
Enables paying for bus-rides, enables for account-code transactions of currency, credit, anytime, day or night anywhere worldwide

FIG. VI-C: PhonExpress entry way detector adapter
Enables paying court fees, identification for entryways enables for account-code transactions of currency, credit anytime, day or night anywhere worldwide

FIG. VI-D: PhonExpress machine adapter
Enables paying for pop/food at machines

FIG. VI-E: PhonExpress machine adapter
Enables quick readings for informational data for ICD/Pacemakers

FIG. VII: PhonExpress computerized keyboard
Enables for account-code transactions of currency, credit, in-store credit and/or electronic shopping obtaining, retrieving informational data, anytime, day or night anywhere worldwide

### MAKINGS VIEWED IN DRAWINGS: PAGES

FIG. I METAL MOLD PLATE 1: FIG. I-MP1

FIG. I PhonExpress system card

FIG. I-F is ‘Front-side’ of PhonExpress system card

FIG. I-FPa B is ‘Front-side/Portal’ of PhonExpress system card//FIG. I-FPa B: [1] Financial-line

FIG. I-FPb C is ‘Bottom-side/Portal’ of PhonExpress system card//FIG. I-FPb C: [2] Credit-line

### Portals

FIG. I-F-[LK1] Left-side Open/Close key

FIG. I-F-[RK2] Right-side Open/Close key

FIG. I-I F ‘Front-side’ Slip-card

FIG. I-I B ‘Back-side’ Slip-card

FIG. I-I F MP2-K7 Square Battery

FIG. I-I F MP2-K7a Cavity for Square Battery

FIG. I-I F LK5 LEFT Three computerized strips

FIG. I-I F RK6 RIGHT Three computerized strips

Four Wires Two wires AND Two wire

FIG. I-F [K1]/I-F [K2] Two Computerized Chip

FIG. I-I PhonExpress slip-card

FIG. I-I L Left-side PhonExpress Slip-card

FIG. I-I LSPa-D Top-Left-side of PhonExpress Slip-card//Slip-Port D [5] Reserve-line

FIG. I-I LSPb-I Bottom-Left-side of PhonExpress Slip-card//Slip-Port I [6] Express-line

FIG. I-I—R Right-side of PhonExpress Slip-card

FIG. I-I RSPa-E (Top-Right-side) of PhonExpress Slip-card//Slip-Port E [7] IDH-line:

FIG. I-I RSPb-J (Bottom-Right-side) of PhonExpress Slip-card//Slip-Port J [8] MDH-line:

FIG. I-B (backside) PhonExpress system card

FIG. I-BPa-G [3] Security-line:

FIG. I-BPb-H [4] Consumers-line:

### FIGURES OF LISTINGS

### VIEW DRAWING PAGE 28, 29, 30, 31, 32, 33, and 34

DRAWING VIEWED OF PAGES 29-34

FIG. I PhonExpress system card and hidden FIG. I-I Slip-card

Inside view Top-Bottom

FIG. I-F MPP1: PP1 FIG. I ‘Front-side’ Plastic Plate 1

FIG. I-MMP2: MP2 Metal Plate 2: shield and block electronic transmission

FIG. I-I F MPP3: PP3 FIG. I-I ‘Front-side’ Plastic Plate 3

FIG. I-I MMP4: MP4 Metal Plate 4

FIG. I-IB MPP5: PP5 FIG. I-I ‘Back-side’ Plastic Plate 5

FIG. I MMP6: MP6 Metal Plate 6: shield and block electronic transmission

FIG. I-B MPP7: PP7 FIG. I ‘Back-side’ Plastic Plate 7

FIG. K1: Left-side Open/Close keys

FIG. K2: Right-side Open/Close keys

FIG. L-K1a: Left-side open/close coverings

FIG. R-K2a: Right-side open/close coverings

FIG. I-FB: [1] Financial-line engraved Codes for Front-side’ Portal

FIG. I-FC [2] Credit-line engraved Codes for Front-side’ Portal

FIG. ‘L-K3a: two wires

FIG. L-K3: computerized plate-form

FIG. IB [3] Security-line engraved Codes for Back-side’ Portal

FIG. IB [4] Consumers-line engraved Codes for Back-side’ Portal

FIG. 7 Flat square battery: 1/16 of inch high ½ inch by ½ inch in length

### MAKINGS VIEWED IN DRAWINGS: PAGES 28-43

FIG. I PhonExpress system card and concealed FIG. I-I Slip-card

FIG. I-F: “Front-view” two Portals and Two Open/Close keys

FIG. I-F: PPI: Plastic Plate with Portals [1] Financial-line and [2] Credit-line

FIG. I-F: MP2: Not showing view of Metal Plate

FIG. I-I F: PP3: Plastic Plate with Slip-ports [5] Reserve-line and [7] IDH-line

FIG. I-I C: MP4: Not showing view of Metal Plate

FIG. I-I B: PP5: Not showing view of Plastic Plate

FIG. I-B: MP6: Not showing view of Metal Plate:

FIG. I-B PP7: Not showing view of Plastic Plated

FIG. I-B ‘Back view”

FIG. I-B: PP7: Plastic Plate with Portals [3] Security-line and [4] Consumers-line

FIG. I-B: MP6: Not showing view of Metal Plate

FIG. I-I B: PP5: Plastic Plate with Slip-ports [6] Express-line and [8] MDH-line

FIG. I-I C: MP4: Not showing view of Metal Plate

FIG. I-I F: PP3: Not showing view of Plastic Plate

FIG. I-F: MP2: Not showing view of Metal Plate

FIG. I-F: PP1: Not showing view of Plastic Plate

### MAKINGS VIEWED IN DRAWINGS: FIG. I PAGE 29-43

FIG. I: PhonExpress system card and concealed FIG. I-I Slip-card

FIG. I-F: PP1: Plastic Plate 1

FIG. I-F: B: Engraved code for Portal [1] Financial-line

FIG. I-F: B1: Number engraved

FIG. I-F: B2: Name of Portal engraved

FIG. I-F: B3: Engraved Braille write

FIG. I-F: L-K1a: Left-side Open/Close key

FIG. I-F: K: Emblem

FIG. I-F: R-K2a: Right-side of Open/Close key

FIG. I-F: C: Engraved code for Portal [2] Credit-line

FIG. I-F: C1 Number engraved

FIG. I-F: C2 Name of Portal engraved

FIG. I-F: C3 Engraved Braille write

FIG. I: MP2: Metal Plate 2

FIG. I-F: L-K1b: computerized chip, that operates the Left Open/Close key this protracts and retract FIG. I-I Slip-card

FIG. I-F: L-K3: the computer chip is embedded and connection to computerized strip; empowers the computer chip

FIG. I-F: L-K3a: Two wire that maintain connection with computerized chip and battery cavity; engages electronic charge

FIG. I-F: L-K5a computerized strip that operates the Left-side open/close key

FIG. I-F: R-K6a computerized strip that operates the Right-side open/close key

FIG. I-F: R-K4a Two wires that maintain connection with computerized chip and battery cavity; engages electronic charge

FIG. I-F: R-K4 the computer chip is embedded and connection to computerize strips this empowers the computer chip

FIG. I-F: R-K2b computerized chip, that operates the Right Open/Close key: protracts and retract FIG. I-I Slip-card

### MAKINGS IN DRAWINGS: PAGES 29-43

FIG. I: PhonExpress system card and concealed FIG. I-I Slip-card

FIG. I-I F: PP3: Plastic Plate 3

FIG. I-I F: D: Engraved code for Slip-port [5] Reserve-line

FIG. I-I F: D 1 Number engraved

FIG. I-I F: D 2 Name of Slip-port engraved

FIG. I-I F: D 3 Engraved Braille write

FIG. I-I F: E Engraved code for Slip-port [7] IDH-line

FIG. I-I F: E 1 Number engraved

FIG. I-I F: E 2 Name of Slip-port engraved

FIG. I-I F: E 3 Engraved Braille write

FIG. I-I C: MP4: Metal Plate 4

FIG. I-I C: L-K 3b Two wire that extend through embedded to maintain connection with computerized chip and battery cavity which engages electronic charge

FIG. I-I C: L-K 5b computerized strip that operates the Left-side open/close key

FIG. I-I C: K 7a: this is battery cavity for Flat-thin battery is placed that electronic charge of power for operations of open/close keys

FIG. I-I C: K 7: Flat-thin battery

FIG. I-I C: K 7b it is shown in view as a see through covering but this covering is not see through it is made of Thin Metal plate

FIG. I-I C: R-K 6b computerized strip that operates the Right-side open/close key

FIG. I-I C: R-K 4b Two wire that extend through embedded to maintain connection with computerized chip and battery cavity which engages electronic charge

FIG. I-I B: PP5: not shown but is bottom of FIG. I-I Slip-card

FIG. I-B: MP6: not shown but is metal plate that blocks transmission of opposite portals

FIG. I-B: PP7 this is FIG. I-B the back-side of PhonExpress card

### MAKINGS VIEWED IN DRAWINGS: PAGE 30-43

FIG. I: PhonExpress system card and concealed FIG. I-I Slip-card

FIG. I-F PP1: Plastic Plate 1

FIG. I-F: L-K 1a Left covering for open/close key

FIG. I-F: L-K 1b Left computerized chips for open/close key

FIG. I-F: L-K 3a the computer chip is embedded and connections to computerize strip this empowers the computer chip

FIG. I-F: L-K 5a embedded computerized strip that operates the Left-side open/close key

FIG. I-F: B Portal [1] Financial-line

FIG. I-F: C Portal [2] Credit-line

FIG. I-F: K PhonExpress Emblem

FIG. I-F: R-K6a embedded computerized strip that operates the Left-side open/close key

FIG. I-F: R-K 2a Right covering’ for open/close keys

FIG. I-F: R-K 2b Right computerized chips for open/close key

FIG. I-F: R-K 4a the computer chip is embedded and connections to computerize strip this empowers the computer chip

FIG. I-F MP2: Metal Plate 2

FIG. I-F: L-K 5b computerized strip that operates the Left-side open/close key

FIG. I-F: L-K 3b Two wire that maintain connection with computerized chip and battery cavity which engages electronic charge

FIG. I-F: R-K 4b Two wire that maintain connection with computerized chip and battery cavity which engages electronic charge

FIG. I-F: R-K 6b computerized strip that operates the Right-side open/close key

FIG. I-I F: PP3 Plastic Plate 3

FIG. I-I F: D Not shown is two Slip-ports

FIG. I-I F: E Not shown is two Slip-ports

### MAKINGS IN DRAWINGS: PAGE 30-43

FIG. I: PhonExpress system card and concealed FIG. I-I Slip-card

FIG. I-I C: MP4 Metal Plate 4

FIG. I-I C: L-K3b Two wire that extend through and maintain connection with computerized chip and battery cavity which engages electronic charge

FIG. I-I C: K7a: this is battery cavity for Flat-thin battery is placed that electronic charge of power for operations of open/close keys

FIG. I-I C: K7: Flat-thin battery

FIG. I-I C: K7b it is shown in view as a see through covering but this covering is not see through it is made of Thin Metal plate

FIG. I-I C: R-K4b Two wire that extend through and maintain connection with computerized chip and battery cavity which engages electronic charge

FIG. I-I B: PP5 Plastic Plate 5

FIG. I-I B: I and FIG. I-I B: J Not shown is two Slip-ports

FIG. I: MP6 Metal Plate 6

Not shown

FIG. I-B: PP7 Plastic Plate 7

FIG. I-B: G and FIG. I-B: H Not shown is two Portals

### MAKINGS VIEWED IN DRAWINGS: PAGE 31-43

FIG. I: PhonExpress system card and concealed FIG. I-I Slip-card

STEP 1: FIG. I-F: PP1 Plastic Plate 1

FIG. I-F: B: Engraved code for Portal [1] Financial-line

FIG. I-F: C: Engraved code for Portal [2] Credit-line

FIG. I-F: K: PhonExpress Emblem

FIG. I-F: L-K 1a: Left covering for open/close key

FIG. I-F: L-K 1b: Left computerized chips for open/close key

FIG. I-F: L-K 3: the computer chip is embedded and connection to computerized strip; empowers the computer chip

FIG. I-F: R-K 2a: Right covering’ for open/close keys

FIG. I-F: R-K 2b: Right computerized chips for open/close key

FIG. I-F: R-K 4: the computer chip is embedded and connection to computerize strips this empowers the computer chip

STEP 2: FIG. I-F: PP1 Plastic Plate 1

FIG. I-F: B: Engraved code for Portal [1] Financial-line

FIG. I-F: C: Engraved code for Portal [2] Credit-line

FIG. I-F: K: PhonExpress Emblem

FIG. I-F: L-K 1a: Left covering for open/close key

FIG. I-F: L-K 3: the computer chip is embedded and connection to computerized strip; empowers the computer chip

FIG. I-F: L-K 5a: embedded computerized strip that operates the Left-side open/close key

FIG. I-F: R-K 2a: Right covering’ for open/close keys

FIG. I-F: R-K 4: the computer chip is embedded and connection to computerize strips this empowers the computer chip

FIG. I-F: R-K 6a: embedded computerized strip that operates the Left-side open/close key

FIG. I-F: R-K 3a: Two wire that maintain connection with computerized chip and battery cavity engages electronic charge

FIG. I-F: R-K 4a: Two wire that maintain connection with computerized chip and battery cavity engages electronic charge

### MAKINGS VIEWED IN DRAWINGS: PAGE 31-43

FIG. I: PhonExpress system card and concealed FIG. I-I Slip-card

STEP 3: FIG. I-F MP2: Metal Plate 2

FIG. I-F L-K 5a: embedded computerized strip that operates the Left-side open/close key

FIG. I-F L-K 1b: Left computerized chips for open/close key

FIG. I-F L-K 3: the computer chip is embedded and connection to computerized strip; empowers the computer chip

FIG. I-F L-K 3a: Two wire that maintain connection with computerized chip and battery cavity engages electronic charge

FIG. I-F R-K 6a: embedded computerized strip that operates the Left-side open/close key

FIG. I-F R-K 4: the computer chip is embedded and connection to computerize strips this empowers the computer chip

FIG. I-F R-K 2a: Right covering’ for open/close keys

FIG. I-F R-K 4a: Two wire that maintain connection with computerized chip and battery cavity engages electronic charge

STEP 4: FIG. I-F: MP2: Metal Plate 2

FIG. I-F: L-K 3a: Two wire that maintain connection with computerized chip and battery cavity engages electronic charge

FIG. I-F: L-K 5a: embedded computerized strip that operates the Left-side open/close key

FIG. I-F: R-K 4a: Two wire that maintain connection with computerized chip and battery cavity engages electronic charge

FIG. I-F: R-K 6a: embedded computerized strip that operates the Left-side open/close key

STEP 5: FIG. I-F: MP2: Metal Plate 2

FIG. I-F: R-K 4a: Two wire that maintain connection with computerized chip and battery cavity engages electronic charge

FIG. I-F: R-K 6a: embedded computerized strip that operates the Left-side open/close key

FIG. I-F: L-K 1b: Left computerized chips for open/close key

FIG. I=F: L-K 2b: Right computerized chips for open/close key

### MAKINGS VIEWED IN DRAWINGS: PAGE 32-43

FIG. I: PhonExpress system card and concealed FIG. I-I Slip-card

STEP 6: FIG. I-F: PP1: Plastic Plate 1

FIG. I-F: PP1: inside Visual of Slip-card

FIG. I-I F: PP3 Front-side Slip-card

FIG. I-I F: D: Engraved code for Slip-port [5] Reserve-line

FIG. I-I F: E: Engraved code for Slip-port [7] IDH-line

STEP 7: FIG. I-I C: MP4: Metal Plate 4

FIG. I-I C: L-K 5b: computerized strip that operates the Left-side open/close key

FIG. I-I C: K7a: this is battery cavity for Flat-thin battery is placed that electronic charge of power for operations of open/close keys

FIG. I-I C: L-K 1b: Left computerized chips for open/close key

FIG. I-I C: L-K 3a: Two wires that maintain connection with computerized chip and battery cavity; engages electronic charge

FIG. I-I C: K7a: this is battery cavity for Flat-thin battery is placed that electronic charge of power for operations of open/close keys

FIG. I-I C: R-K 2b: Right computerized chips for open/close key

FIG. I-I C: R-K 4a: Two wire that maintain connection with computerized chip and battery cavity engages electronic charge

FIG. I-I C: R-K 6b: embedded computerized strip that operates the Right-side open/close key

STEP 8: FIG. I-I C: MP4: Metal Plate 4

FIG. I-I C: K7: Flat-thin battery

FIG. I-I C: K7a: this is battery cavity for Flat-thin battery is placed that electronic charge of power for operations of open/close keys

### MAKINGS VIEWED IN DRAWINGS: PAGE 32-43

FIG. I: PhonExpress system card and concealed FIG. I-I Slip-card

COMBINED STEP 9: FIG. I-F: PP1: Plastic Plate 1

FIG. I-F: B: Engraved code for Portal [1] Financial-line

FIG. I-F: L-K 1b: Left computerized chips for open/close key

FIG. I-F: L-K 3a: Two wire that maintain connection with computerized chip and battery cavity engages electronic charge

FIG. I-F: C Engraved code for Portal [2] Credit-line

FIG. I-F: R-K 2b: Right computerized chips for open/close key

FIG. I-F: R-K 4a: the computer chip is embedded and connection to computerize strips this empowers the computer chip

STEP 10: FIG. I-I C: MP4: Metal Plate 4

FIG. I-I C: L-K 5b: computerized strip that operates the Left-side open/close key

FIG. I-I C: R-K 6b: computerized strip that operates the Right-side open/close key

FIG. I-I C: K7a: this is battery cavity for Flat-thin battery is placed that electronic charge of power for operations of open/close keys

FIG. I-I C: K7: Flat-thin battery

STEP 11: FIG. I-I C: MP4: Metal Plate 4

FIG. I-I C: L-K 5b: computerized strip that operates the Left-side open/close key

FIG. I-I C: K7a: this is battery cavity for Flat-thin battery is placed that electronic charge of power for operations of open/close keys

FIG. I-I C: K7: Flat-thin battery

FIG. I-I C: R-K 6b: computerized strip that operates the Right-side open/close key

STEP 12: FIG. I-I C: MP4: Metal Plate 4

FIG. I-I C: L-K 5b: computerized strip that operates the Left-side open/close key

FIG. I-I C: K 7b: it is shown in view as a see through covering but this covering is not see through it is made of Thin Metal plate

FIG. I-I C: R-K6b computerized strip that operates the Right-side open/close key

### MAKINGS VIEWED IN DRAWINGS: PAGE 33-43

FIG. I: PhonExpress system card and concealed FIG. I-I Slip-card

FIG. I-F: PP1: Plastic Plate 1

FIG. I-F K1 Left open/close key

FIG. I-F L-K1a Left covering for open/close key

FIG. I-F L-K1b computerized chip, that operates the Left Open/Close key this protracts and retract FIG. I-I Slip-card

FIG. I-F L-K3 the computer chip is embedded and connection to computerized strip this empowers the computer chip

FIG. I-F L-K1a Left covering for open/close key

FIG. I-F L-K1b computerized chip, that operates the Left Open/Close key this protracts and retract FIG. I-I Slip-card

FIG. I-F L-K3 the computer chip is embedded and connection to computerized strip this empowers the computer chip

FIG. I-F L-K3a Two wire that maintain connection with computerized chip and battery cavity; engages electronic charge

FIG. I-F: B: Engraved code for Portal [1] Financial-line

FIG. I-F: K: PhonExpress Emblem

FIG. I-F: C: Engraved code for Portal [2] Credit-line

FIG. I-F K2 Right open/close key

FIG. I-F R-K2a Right covering’ for open/close keys

FIG. I-F R-K2b Right computerized chip for open/close key

FIG. I-F R-K4 the computer chip is embedded and connection to computerize strips this empowers the computer chip

FIG. I-F R-K2a Right covering’ for open/close keys

FIG. I-F R-K2b Right computerized chip for open/close key

FIG. I-F R-K4 the computer chip is embedded and connection to computerize strips this empowers the computer chip

FIG. I-F R-K4a Two wire that maintain connection with computerized chip and battery cavity engages electronic charge

FIG. I-F L-K5a embedded computerized strip that operates the Left-side open/close key

FIG. I-F R-K6a embedded computerized strip that operates the Left-side open/close key

FIG. I-F: MP2: Metal Plate 2

FIG. I-F L-K5a embedded computerized strip that operates the Left-side open/close key

FIG. I-F R-K6a embedded computerized strip that operates the Left-side open/close key

### MAKINGS IN DRAWINGS: PAGE 33-43

FIG. I: PhonExpress system card and concealed FIG. I-I Slip-card

FIG. I-I F: PP3 Plastic Plate 3

FIG. I-I F L-K5a embedded computerized strip that operates the Left-side open/close key

FIG. I-I F R-K6a embedded computerized strip that operates the Left-side open/close key

FIG. I-I F L-K3a Two wire that maintain connection with computerized chip, battery cavity; engages electronic charge

FIG. I-I F R-K3 the computer chip is embedded connections to computerize strip this empowers the computer chip

FIG. I-I F R-K4 the computer chip is embedded connection to computerize strips this empowers the computer chip

FIG. I-I F R-K4a Two wire that maintain connection with computerized chip, battery cavity engages electronic charge

FIG. I-I C: MP4 Metal Plate 4 FIG. I-I C L-K5a embedded computerized strip that operates the Left-side open/close key

FIG. I-I C L-K1b computerized chip, that operates the Left Open/Close key this protracts & retract FIG. I-I Slip-card

FIG. I-I C L-K3 the computer chip is embedded, connection to computerized strip this empowers the computer chip

FIG. I-I C L-K3a Two wire maintain connection with computerized chip, battery cavity; engages electronic charge

FIG. I-I C K7a this is battery cavity for Flat-thin battery is placed that electronic charge of power for operations of open/close keys

FIG. I-F: B: Engraved code for Portal [1] Financial-line

FIG. I-I: K7: Flat-thin battery

FIG. I-F: C: Engraved code for Portal [2] Credit-line

FIG. I-I C R-K2b Right computerized chip for open/close key

FIG. I-I C R-K4 the computer chip is embedded connection to computerize strips this empowers the computer chip

FIG. I-I C R-K4a Two wire maintain connection with computerized chip, battery cavity engages electronic charge

FIG. I-I C R-K6a embedded computerized strip that operates the Left-side open/close key

FIG. I-I B: PP5 Plastic Plate 5

FIG. I-I B I

FIG. I-I B J

FIG. I-B: MP6 Metal Plate 6

FIG. I-B: PP7 Plastic Plate 7

FIG. I-B G Portal Security-line

### MAKINGS IN DRAWINGS: PAGE 34-43

FIG. I: PhonExpress system card and concealed FIG. I-I Slip-card

FIG. I-F PP1

FIG. I-F MP2

FIG. I-I F PP3

FIG. I-I C MP4

FIG. I-I B PP5

FIG. I-B MP6

FIG. I-B PP7

FIG. I-F:

FIG. I-F: & FIG. I-I LF:

FIG. I-F: & FIG. I-I RF:

FIG. I-B:

FIG. I-B: & FIG. I-I LB:

FIG. I-B: & FIG. I-I RB:

### MAKINGS IN DRAWINGS: PAGE 35-43

### FIG. IX: P.E.A.C.E. Converter

In the drawings, closely related figures have the same number but different alphabetic suffixes.

### P.E.A.C.E. System's DIGITAL TRANSMISSIONAL DEVICES

FIG. B1: In-put processing of digital signals

FIG. B1a: Electronically transmit, obtain and relay communications of digital signals transmitting data in-put from FIG. X: P.E.A.C.E. system base unit, simultaneously with any of the FIG. II:-FIG. VIII: PhonExpress system devices

FIG. B1b: Plug-in to computerized resource servers, electronically relaying of digital signals transmitting data of in-put from business or companies computerized resource servers of either accounts, codes, binary codes, inventory and prices

FIG. B2: Out-put processing of digital signals

B2a: Electronically transmitting the obtained informational data and relaying communications of digital signals data transmitting out-put to FIG. X: P.E.A.C.E. system base unit, simultaneously with any of the FIG. II:-FIG. VIII: PhonExpress system devices

FIG. B2b: Plug-in to computerized resource servers, electronically obtaining informational data, transform and convert into digital signals relaying transmission of informational data out-put from business or companies computerized resource servers of either accounts, codes, binary codes, inventory and prices

### MAKINGS IN DRAWINGS: PAGE 35-43

### FIG. IX: P.E.A.C.E. Converter

In the drawings, closely related figures have the same number but different alphabetic suffixes.

FIG. B1: In-put of digital signals processing of transforms and converts, analyzes stores and transmits into digital data conversing with business or companies computerized resource server

FIG. B1a: Electronically retrieves transmission of digital signals, obtain and relay communications of digital signals transmitting data in-put from P.E.A.C.E. system base unit, simultaneously with any of the PhonExpress system devices

FIG. B1b: Transforms and converts computerized chip that analyzes incoming data

FIG. B1c: Analyzer computerized chip

FIG. B1d: Transmitter computerized chip

FIG. B1e: Conversing processor computerized chip

FIG. B1f: Plug-in to computerized resource servers, electronically relaying of digital signals transmitting data of in-put from business or companies computerized resource servers of either accounts, codes, binary codes, inventory and prices

FIG. B3: Chip computerized processor: programming processing of digital informational data

FIG. B2: Out-put processing of digital signals of transforms and converts, analyzes stores and transmits digital signals

FIG. B2f: Electronically transmitting the obtained informational data transformed into digital signals and relaying communications transmitting out-put of digital signals data to P.E.A.C.E. system base unit, simultaneously with any of the PhonExpress system devices

FIG. B2d: Transforms and converts computerized chip

FIG. B2c: Analyzer computerized chip analyzer that analyzes informational data

FIG. B2b: Transmitter computerized chip that translator converts incoming data from business or companies computerized resource server translates into digital signals

FIG. B2e: Conversing processor transmitter that translates informational data computerized chip

FIG. B2a: Plug-in retrieves informational data from computerized resource servers, electronically obtaining informational data, transform and convert into digital signals relaying transmission of informational data out-put from business or companies computerized resource servers of either accounts, codes, binary codes, inventory and prices

BRIEF DESCRIPTION OF SEVERAL VIEWS OF DRAWINGS AND FIGURES FIG. X: P.E.A.C.E.

### Base Unit MAKINGS IN DRAWINGS: FIG. X-A PAGE 36-43

FIG. C1: Satellite transmission of signals

FIG. C1a: Communication device

FIG. C1b: Accountant system

FIG. C1c: Satellite transmission radio devices

FIG. C2: Account translation system

FIG. C2a:/C2b: aLay laser system

FIG. C2c: Code translation system

FIG. C3: Electronic communication devices WAN wide area network

FIG. C3a: Transition communication relay device

FIG. C3b: Electronic fire-wall

FIG. C3c: Electronic identifier device

FIG. X: A P.E.A.C.E. Base Unit FIG. X-B PAGE 37-43

FIG. C1: Level 1

FIG. C1A: Synchronizer device coordinate

FIG. C1B: Receiver transmitter signals

FIG. C1C: Relay transmitter

FIG. C1D: Modulator altered to carry informational data

FIG. C1E: Electronic communicator amplitude modulation AM

FIG. C1F: Electronic transmitter identifier device

FIG. C2: Level 2

FIG. C2A: Electronic transmitter identifier device Translator

FIG. C2B: Analyzer of signals

FIG. C2C: Electronic computer programming

FIG. Computer processing system

FIG. C3: Level 3

FIG. C3A: Electronic account system

FIG. C3B: Back area electronic credit account system

FIG. C3C: Electronic accountant

FIG. C3D: aLay Electric laser scanner of data

FIG. C3E: EDP electronic binary code system electronic data processing the binary system binary code represents letters and numbers FIG. C3F: GSI bar-coding system COMBINED BOTH FIG. XA-XB PAGE 38-43

### P.E.A.C.E. Electronic Transmission PAGE 39-43

### ACCOUNT TRANSACTION: PAY BILLS: TRANSFER: FUNDS, SEND FUNDS:

FIG. X: P.E.A.C.E. Base Unit

FIG. XI: P.E.A.C.E. Converter (1, 2, 3)

FIG. I: PhonExpress card—FIG. I-I Slip-card

FIG. II-FIG. III-FIG. IV-FIG. VII

FIG. X: A

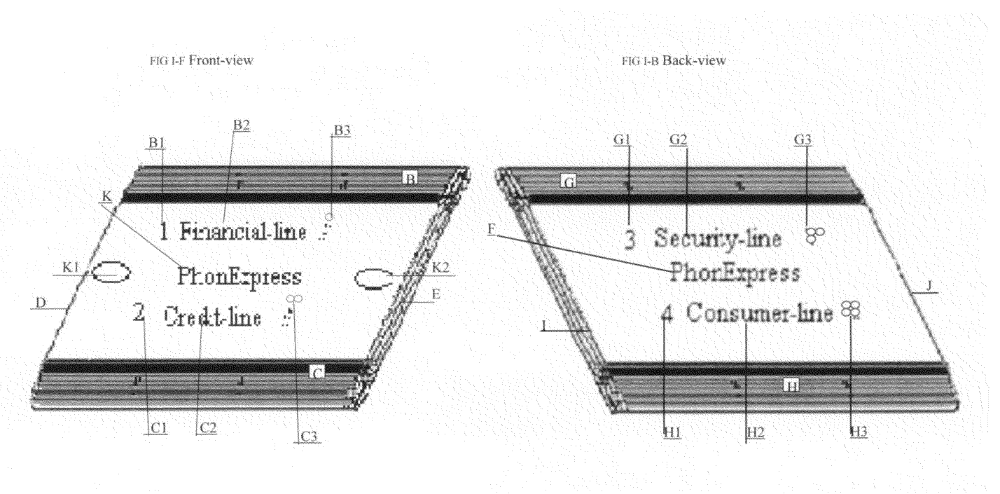

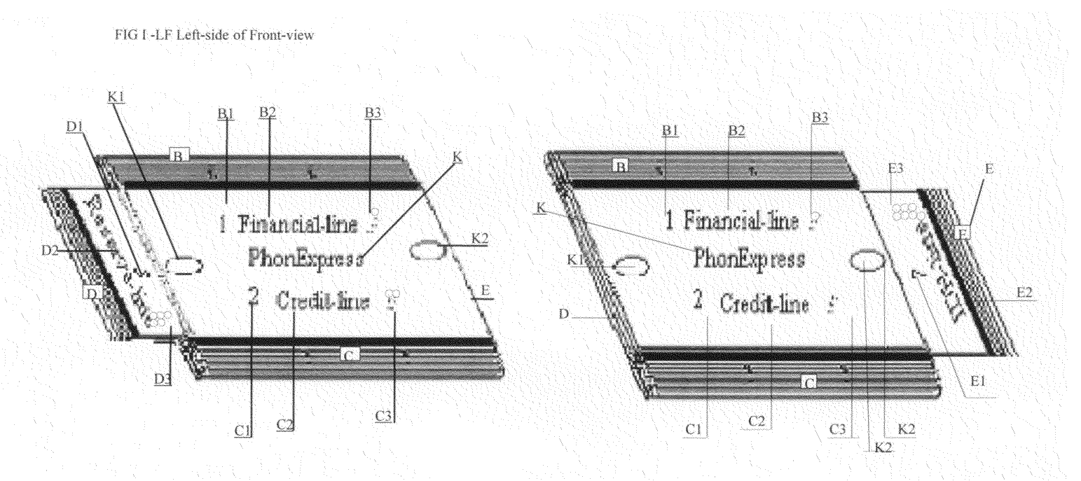

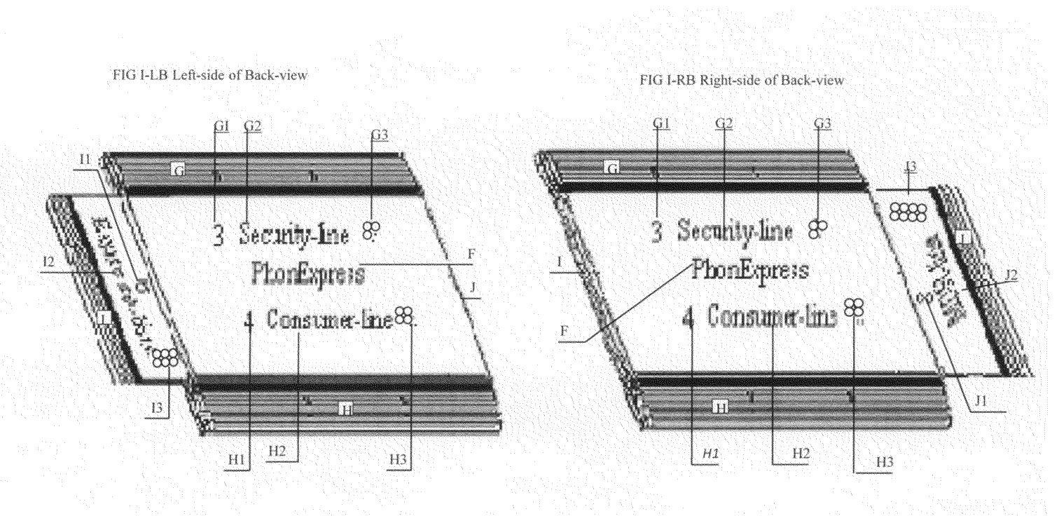

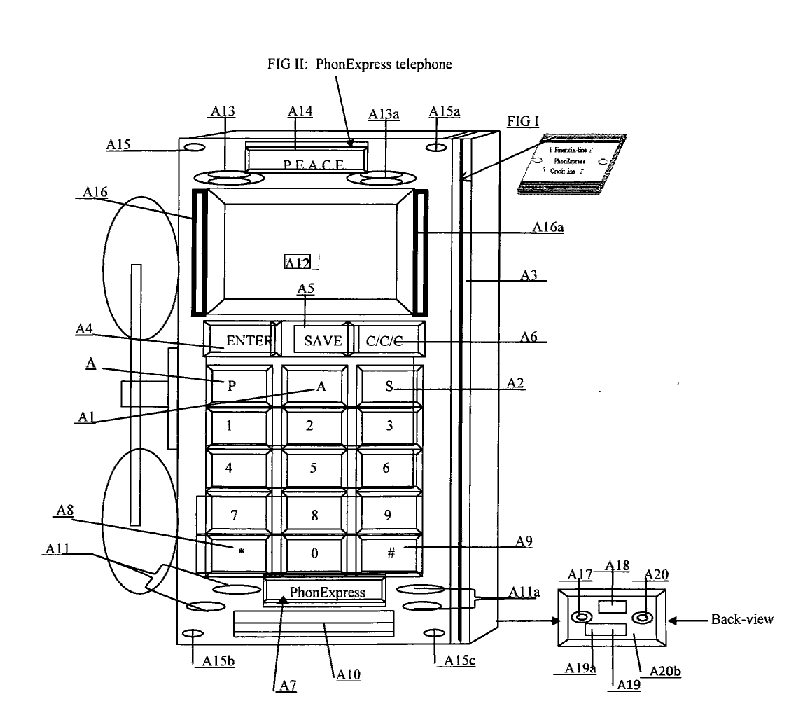

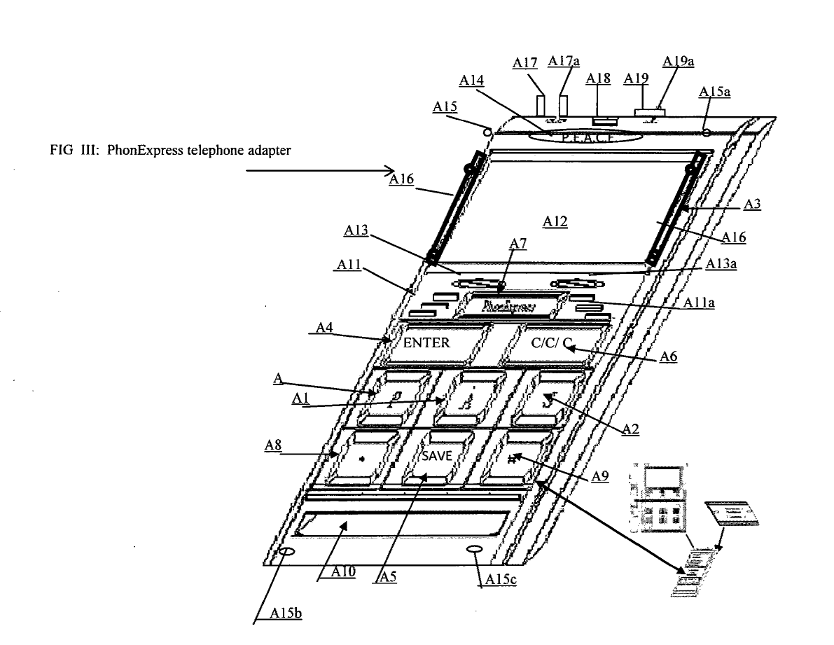

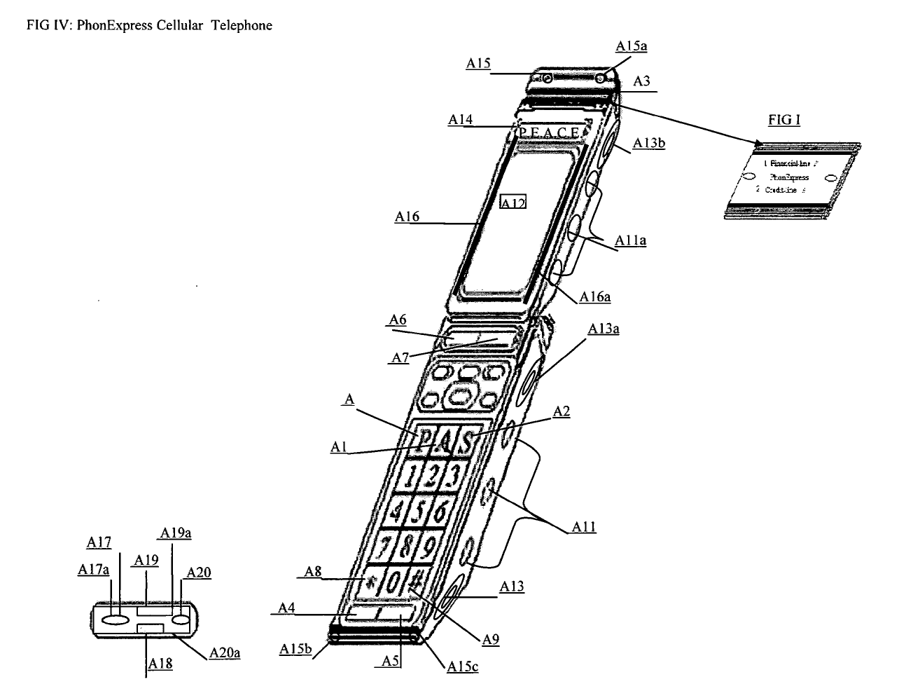

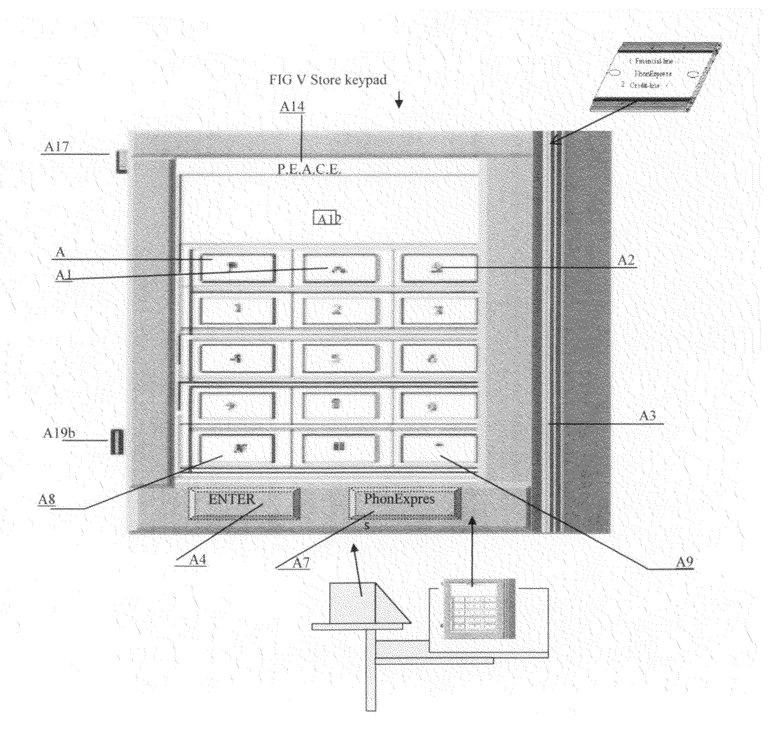

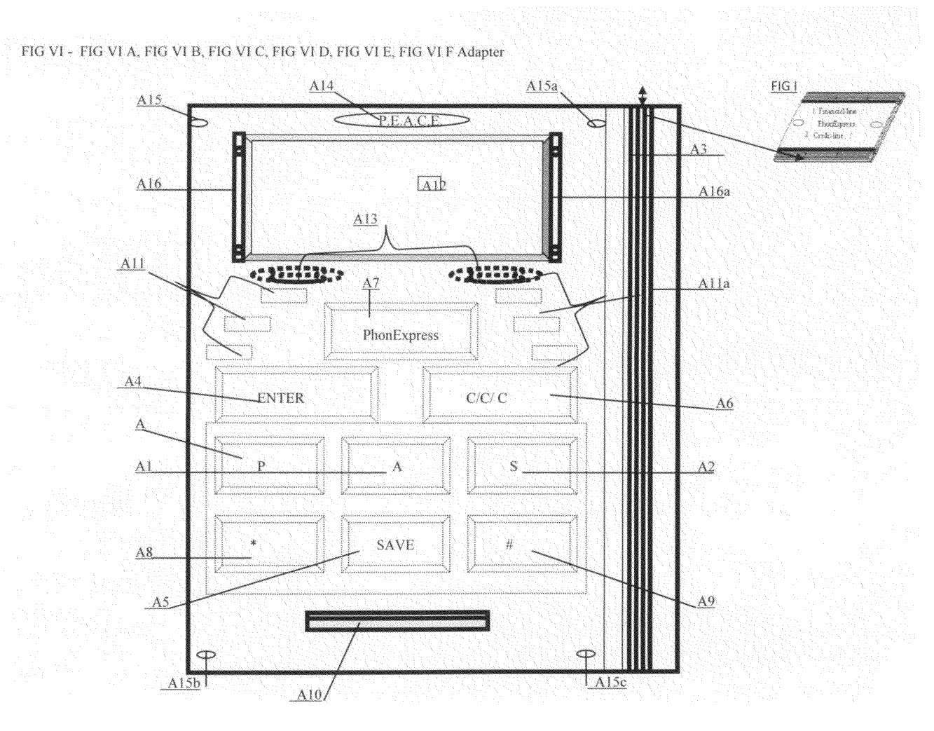

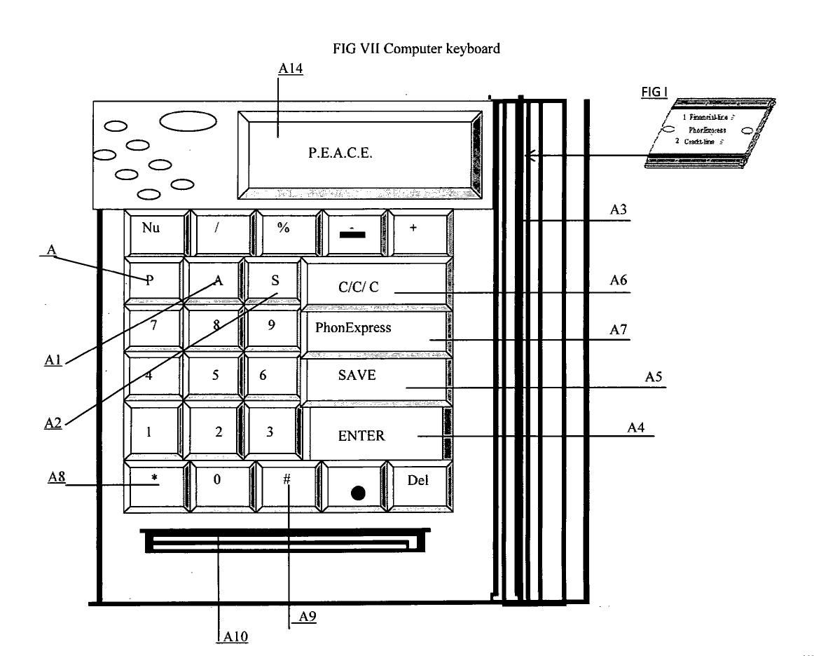

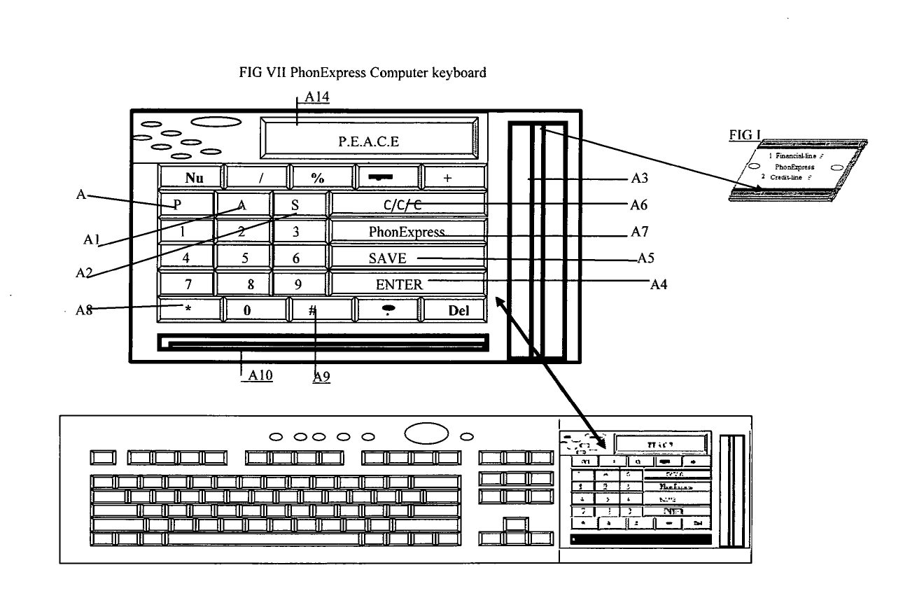

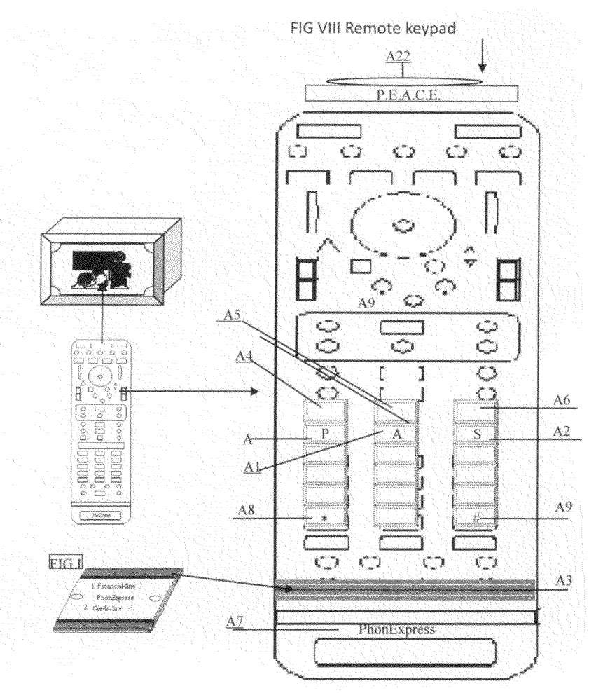

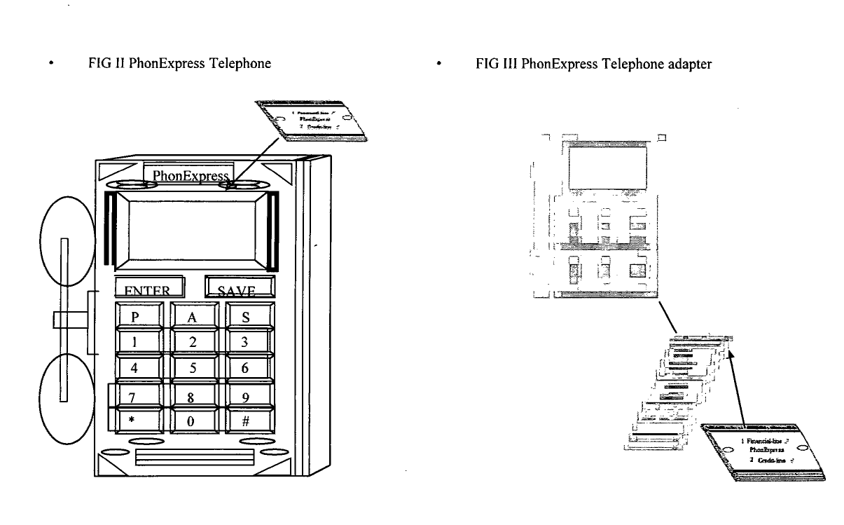

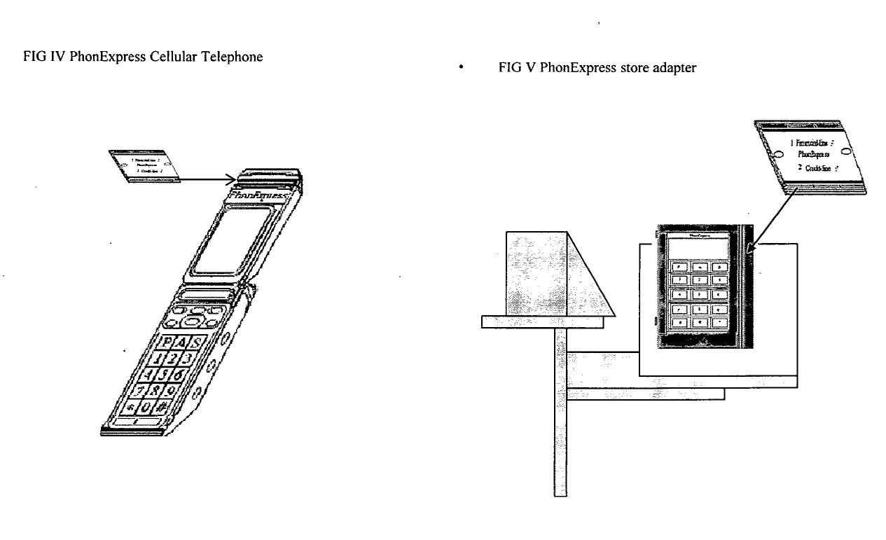

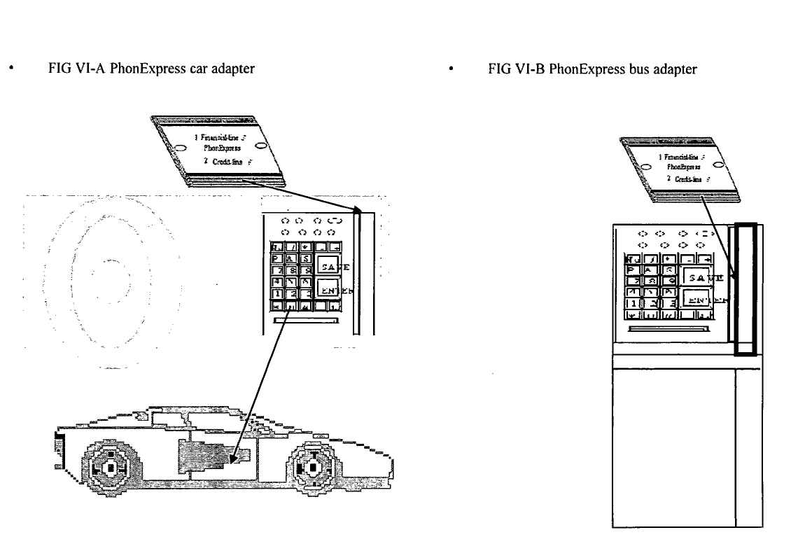

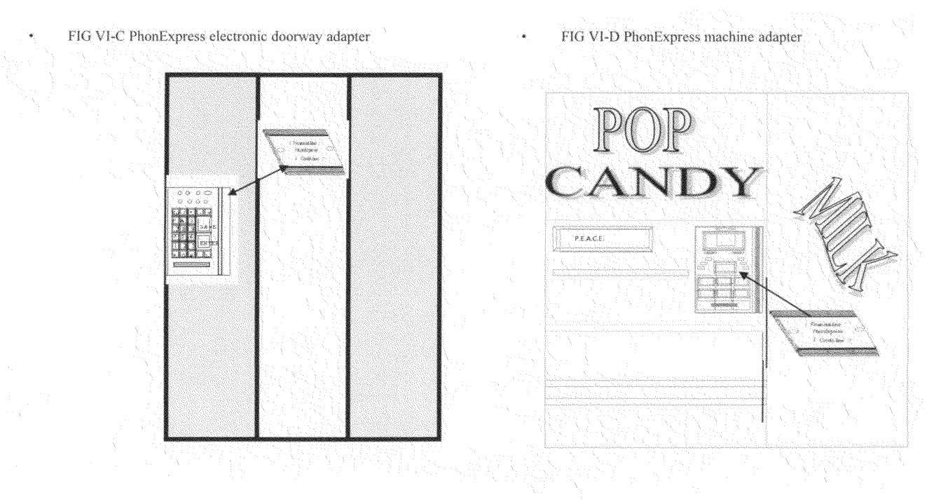

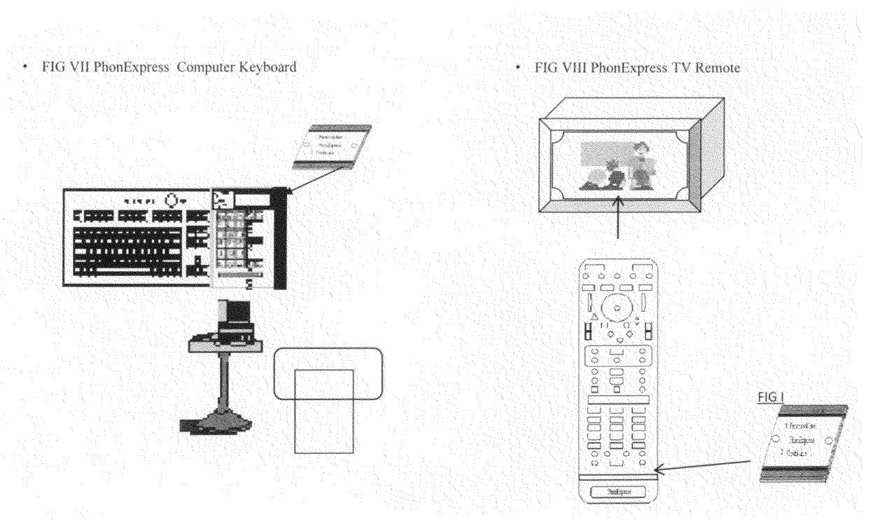

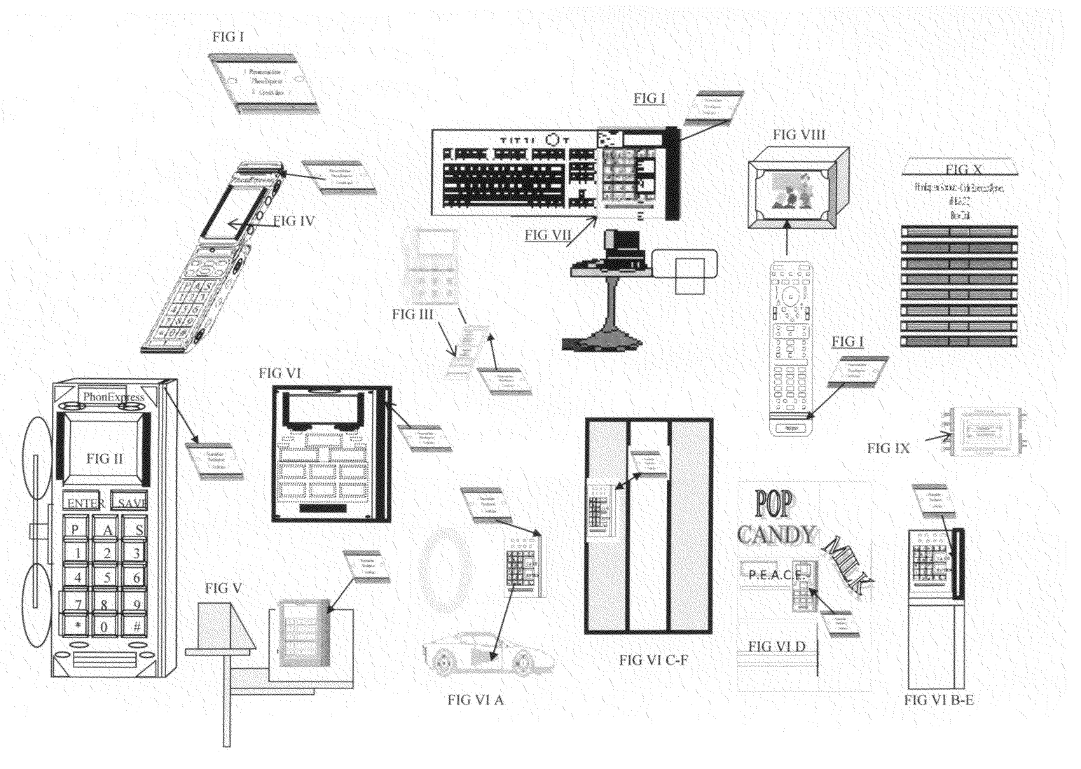

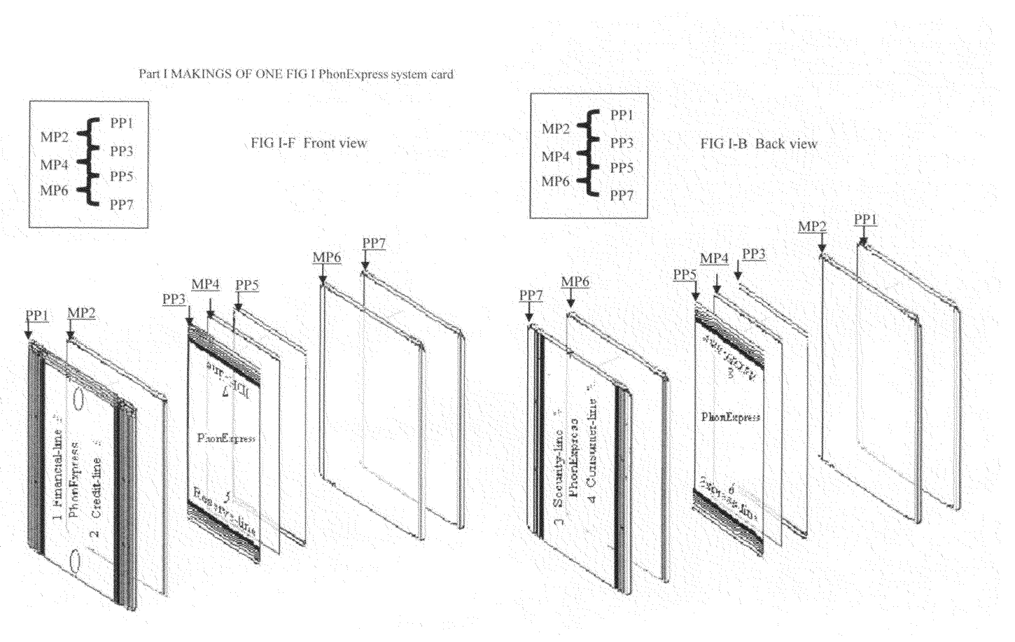

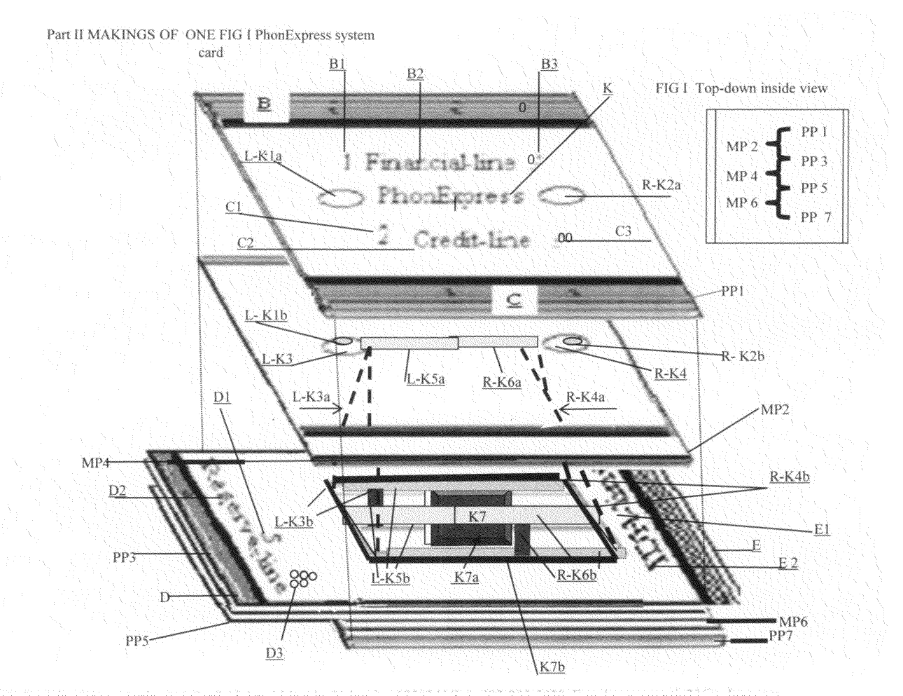

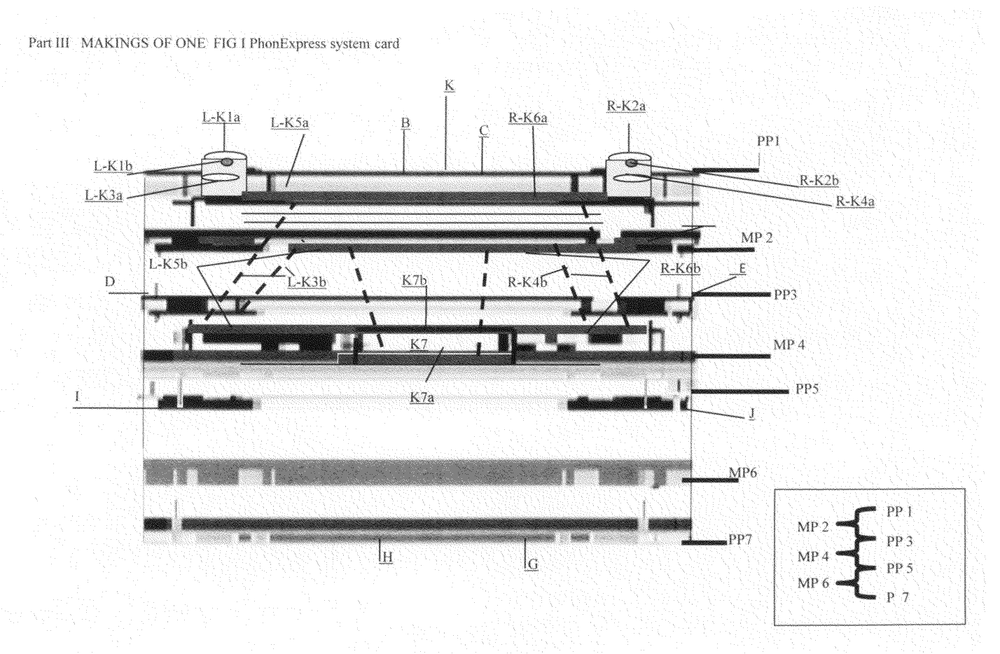

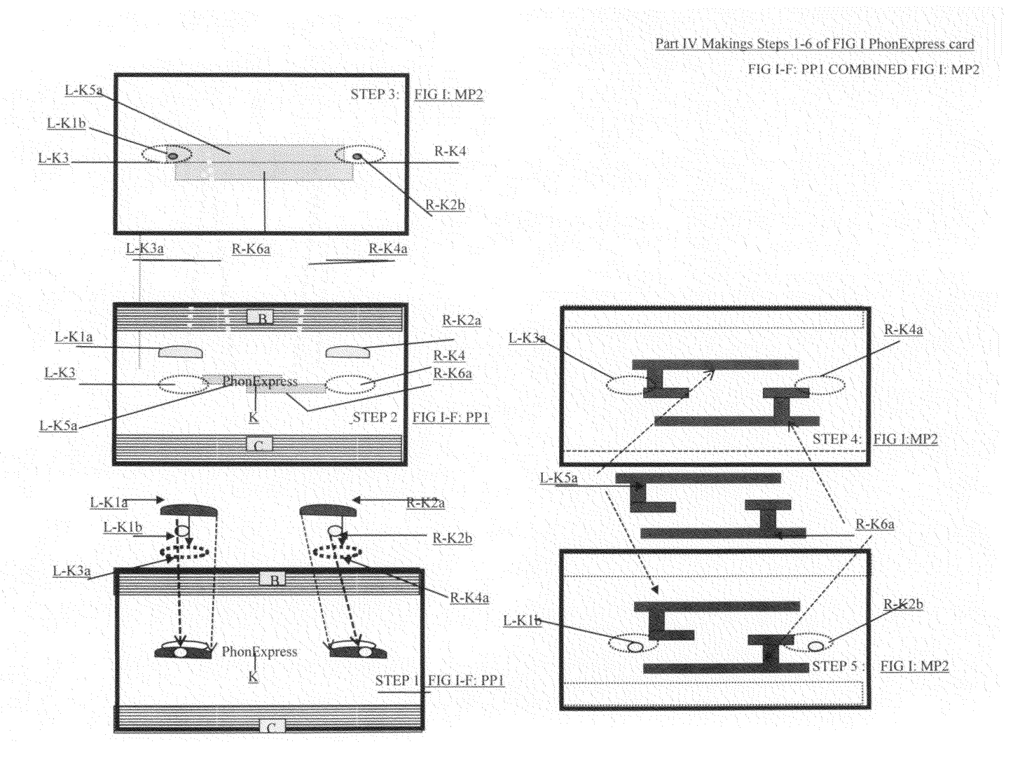

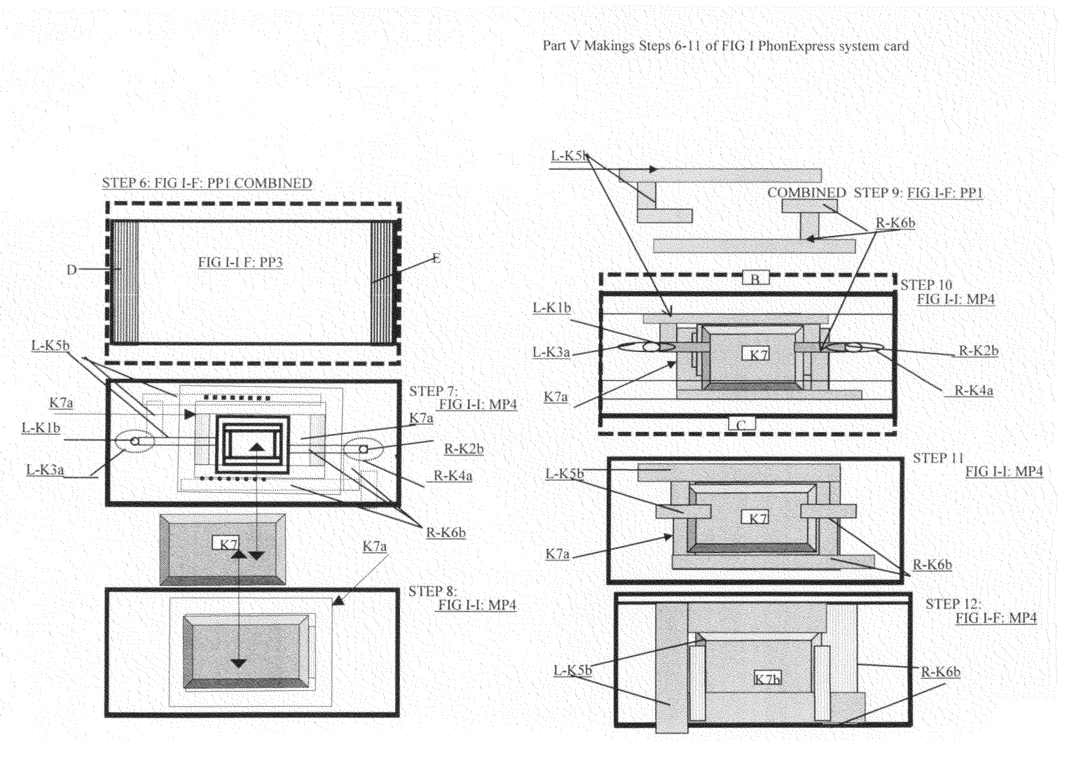

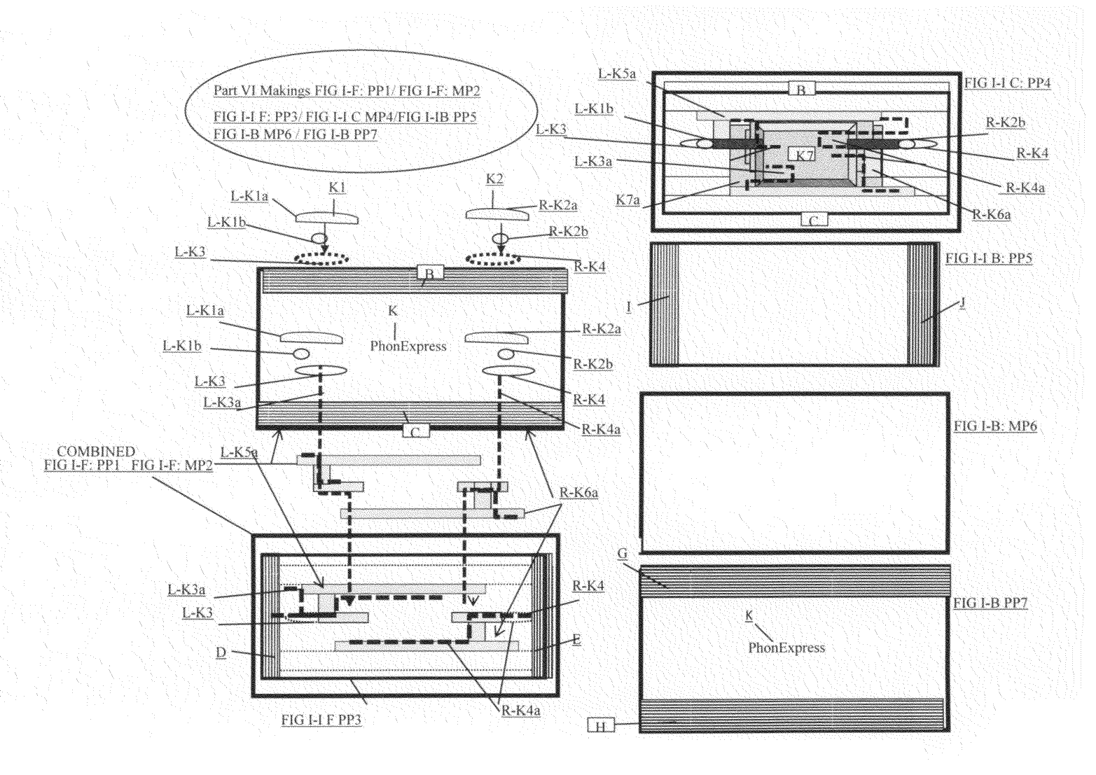

FIG. 1-Aa=FIG. I: PhonExpress card; Slide Portal [1] or [2] or FIG. I-I Slip-port [5] or [6] Or Usage of

FIG. 1-Ab: FIG. II: PhonExpress telephone keys

FIG. 2-A: FIG. II: PhonExpress telephone Transmission signals of data to satellite FIG. S: ‘Satellite’

FIG. 3-A: FIG. S ‘Satellite receives signals of data transmission, from FIG. II: PhonExpress telephone

FIG. 4-A: FIG. S ‘Satellite transmits signals of data to FIG. X: P.E.A.C.E. Base Unit

FIG. 5-A: FIG. X: P.E.A.C.E. Base Unit transmits signals of data to FIG. IX: 1 P.E.A.C.E. Converter (Place of billing account//Place of account funds) connected to business or company computerized data resource server

FIG. 6-A: FIG. IX: 1 P.E.A.C.E. Converter transmission Process of data into signals of Account-Codes (billing account//funds of either currency or credit accounts)

FIG. 7-A: FIG. IX: 1 P.E.A.C.E. Converter transmits data (that had been processed) into signals back to FIG. X: Base Unit

FIG. 8-A: FIG. X: Base Unit transmits signals of data back to FIG. S ‘Signal’

FIG. 9-A: transmission signals of data back to FIG. II: PhonExpress telephone

FIG. 10-A: ‘cardholder’ uses method of keys on FIG. II: PhonExpress telephone that is connected to FIG. P: Printer

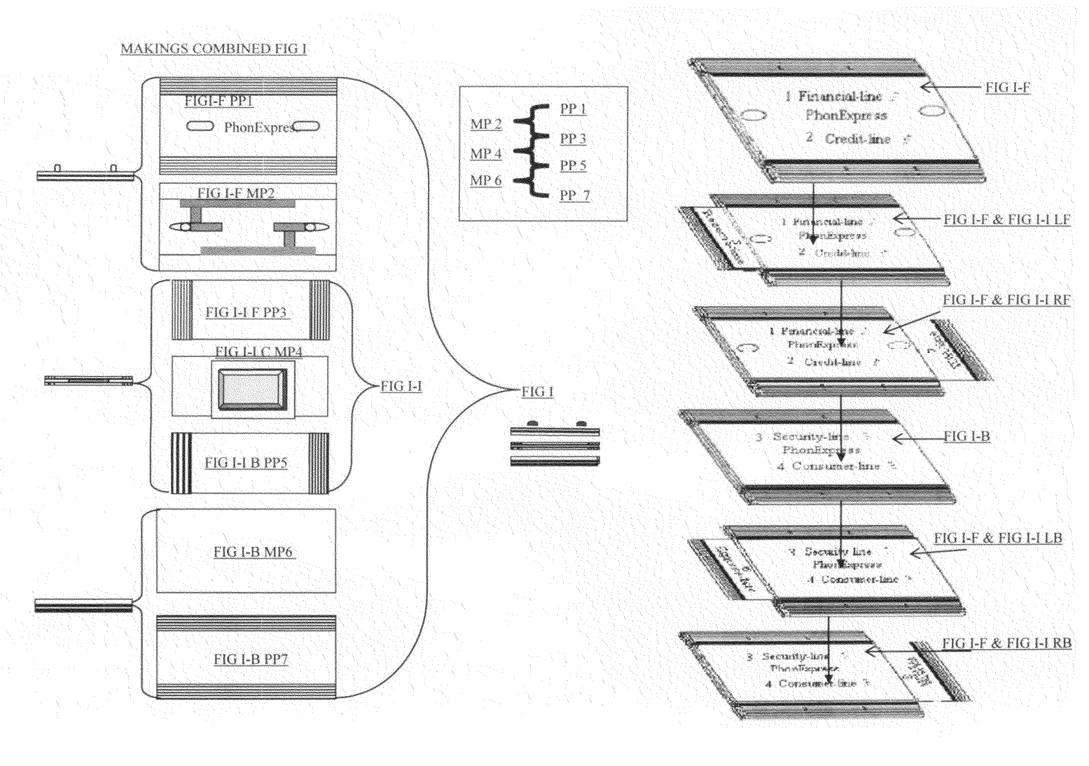

FIG. 11-A: FIG. II: PhonExpress telephone FIG. P: Printer TRANSMITS RECEIPT

P.E.A.C.E. Electronic Transmission PAGE 40-43

FIG. XI: B: OBTAINING OR SEND INFORMATIONAL DATA & PRINT-OUT DOCUMENTS, RECORDS, TRANSCRIPT

FIG. 1-Ba: FIG. I: PhonExpress card; Slide of Portal [3] Security-line Or Usage of

FIG. 1-Bb: FIG. II: PhonExpress telephone keys methods of usage operational PhonExpress key

FIG. 2-B: Transmission of signals of code data to satellite FIG. S: ‘Satellite

FIG. 3-B: FIG. S ‘Satellite receives signals of code data transmission

FIG. 4-B: signals of code data transmits to FIG. X: P.E.A.C.E. Base Unit

FIG. 5-B: transmission of code signals of informational data to FIG. IX: P.E.A.C.E. Converter

FIG. 6-B: FIG. IX: P.E.A.C.E. Converter that is connected to that place of business or company obtains code of signals retrieves and translates data, processes the informational data

FIG. 7-B: FIG. IX: P.E.A.C.E. Converter after process of transaction then transmits digital data into code signals back to FIG. X: P.E.A.C.E. Base Unit

FIG. 8-B: FIG. X: P.E.A.C.E. Base Unit sends Transmission of code data signals to FIG. S “Satellite”

FIG. 9-B: FIG. S “Satellite” transmits signals of the informational data code back to FIG. II: PhonExpress telephone

FIG. 10-B: transmitted into FIG. II PhonExpress telephone cardholder activates keys signals are translated printable document and is printed out by cardholders FIG. P: Printer

FIG. 11-B: FIG. II: PhonExpress telephone FIG. P: Printer TRANSMITS OUT P.E.A.C.E. RECEIPT

### OR FIG. XI: BA: DISTRIBUTED-OUT; ANY TYPE OF MAIL DOCUMENTS, RECORDS, AND TRANSCRIPTS

FIG. 7-BA: FIG. IX:2 P.E.A.C.E. Converter connection to computerized resource server of place business or companies sending out code signals translated informational data of anything that business or companies' wants to distribute out Mail such as medial of documents, records, transcripts, then transmits digital data into code signals transmitting back to FIG. X: P.E.A.C.E. Base Unit

FIG. 8-BA: FIG. X: P.E.A.C.E. Base Unit signals transmits of informational data or mail to FIG. S “Satellite”

FIG. 9-BA: FIG. S “Satellite” transmits signals of the informational data of any Mail back to FIG. II: PhonExpress telephone activates light indicates incoming transmits informational data that is transmitted from business or medial or companies code of documents, records, and transcripts

FIG. 10-BA: cardholder activates FIG. II PhonExpress telephone keys then the transmission of code of signals is translated into printable document records, transcripts and is printed out by cardholders FIG. P: Printer

FIG. 11-BA: FIG. II: PhonExpress telephone FIG. P: Printer TRANSMITS OUT P.E.A.C.E. RECEIPT

### P.E.A.C.E. Electronic Transmission PAGE 41-43

### SHOPPING AND PURCHASE FOR DELIVERY OR SHOPPING WITH IN-STORE CREDIT

FIG. XI: C

FIG. 1-Ca: FIG. I: PhonExpress card; Slide of Portal [4] Consumers-line or FIG. I-I In-store credit, enables cardholder to shop worldwide anytime Or Usage of:

FIG. 1-Cb: FIG. II: PhonExpress telephone keys methods of usage operational PhonExpress key

FIG. 2-C: Transmission signals of code data to FIG. S: satellite

FIG. 3-C FIG. S ‘Satellite receives signals of code data transmission,

FIG. 4-C signals of code data transmits to FIG. X: P.E.A.C.E. Base Unit

FIG. 5-C FIG. X: P.E.A.C.E. Base Unit analyzes and transmits code signals transmits to FIG. IX: 3 P.E.A.C.E. Converter ‘to obtain data of business or company or restaurant inventory data of merchandise codes and prices

FIG. 6-C: FIG. IX: 3 P.E.A.C.E. Converter retrieves and analyzes informational data of merchandise codes and prices from business or company or restaurants computerized inventory data and prices resources server then translates and obtains processing merchandise and transmits digital data into signals for transmitting back to FIG. X: P.E.A.C.E. Base Unit

FIG. 7-C: FIG. X: P.E.A.C.E. Base Unit analyzes and transmits code signals Transmission to FIG. S “Satellite”

FIG. 8-C: transmits informational data into signals (electronic communicating) to FIG. II PhonExpress telephone

FIG. 9-C: FIG. II PhonExpress telephone transmits back through satellite, (electronic communicating) FIG. X: P.E.A.C.E. Base Unit again (electronic communicating) to FIG. IX: 3 Converter that's connected to business or companies or restaurant computerized resource

FIG. 10-C: FIG. X: P.E.A.C.E. Base Unit analyzes and transmits code signals FIG. IX: 4 Converter AFTER DISPLAY OF FIG. II PhonExpress telephone LCD screen AMOUNT DUE FOR PURCHASE

FIG. 10-CA: then cardholder uses either usage of FIG. II: PhonExpress telephone keys methods then cardholder usage of either FIG. I: PhonExpress card Portal [1] Financial-line of currency or [3] Credit-line of credit this is for immediate purchase or payment to business or companies or restaurant FIG. II: PhonExpress telephone analyzes and transmits code signals FIG. S “Satellite” FIG. X: P.E.A.C.E. Base Unit

FIG. 11-CA: FIG. S “Satellite” transmits code signals to FIG. X: P.E.A.C.E. Base Unit

### P.E.A.C.E. Electronic Transmission CONTINUED PAGE 41-43

### SHOPPING AND PURCHASE FOR DELIVERY OR SHOPPING WITH IN-STORE CREDIT

FIG. XI: C

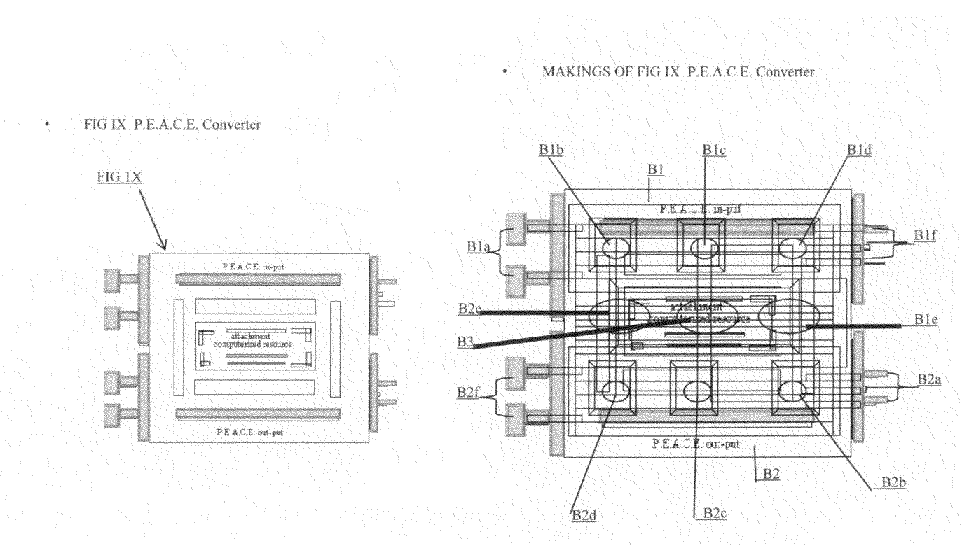

FIG. 12-CA: FIG. X: P.E.A.C.E. Base Unit transmits (electronic communicating simultaneously) to all three

FIG. 12-CAa: FIG. IX: 3 Converter that's connected to (Place of Shopping) business or companies or restaurant computerized resource server of inventory and price data

FIG. 12-CAb: FIG. IX: 4 Converter that's connected to (Place of Cardholder Account for transaction of funds) business or companies or restaurant computerized resource server of business or companies or restaurant accounts

FIG. 12-CAc: FIG. IX: 5 Converter that's connected to (Place that Cardholder is shopping at business and this is business or companies or restaurant Account for transaction of funds) computerized resource server of business or companies or restaurant accounts. Then account transaction funds are transferred to place of cardholders account to either place of business or companies or restaurant for purchase or payment (electronic communicating) back and forth with FIG. II: PhonExpress telephone

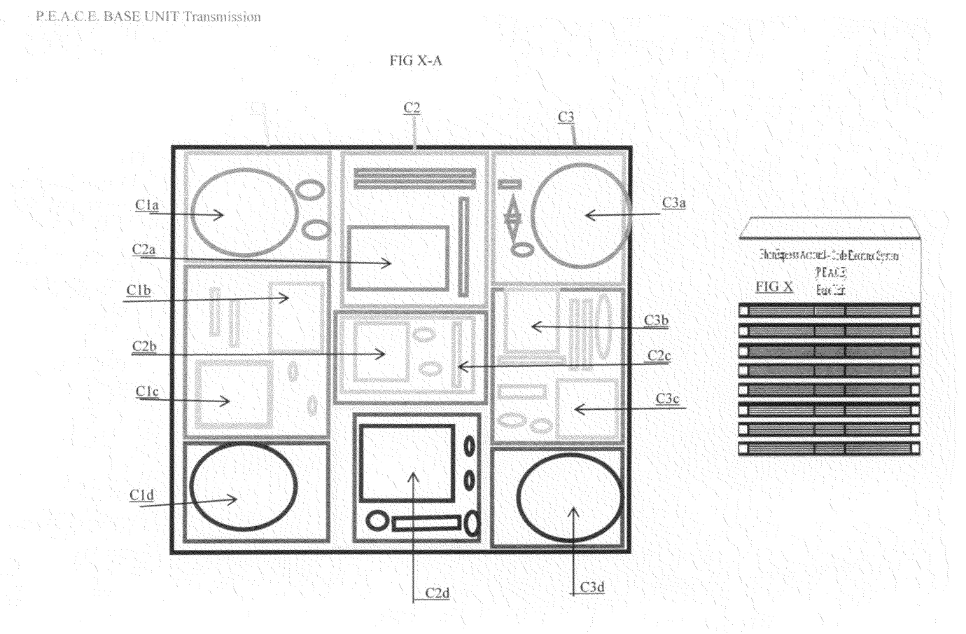

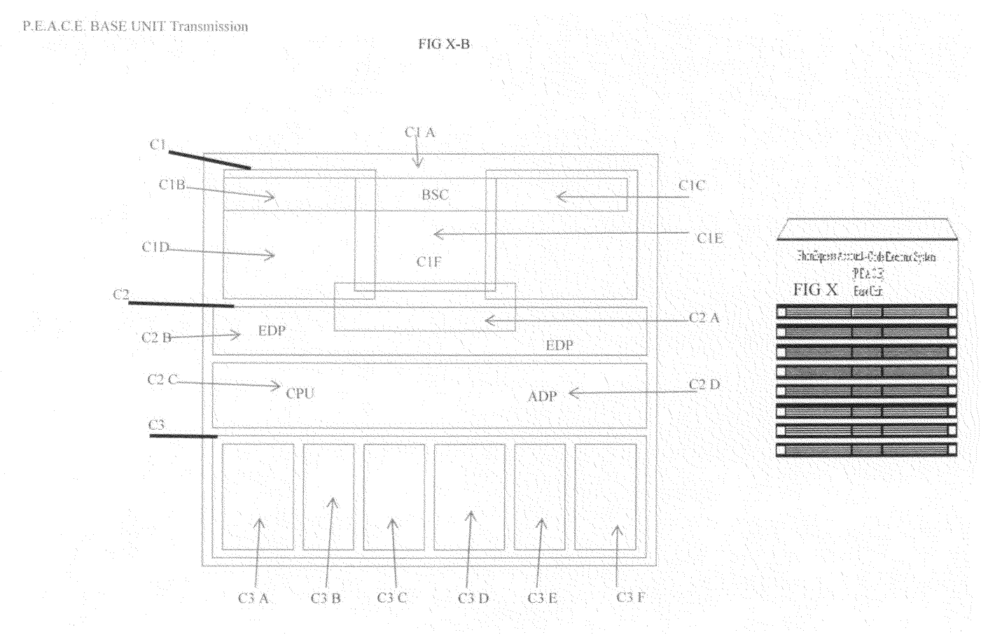

FIG. 13-CA: FIG. S “Satellite” transmits code signals to FIG. X: P.E.A.C.E. Base Unit

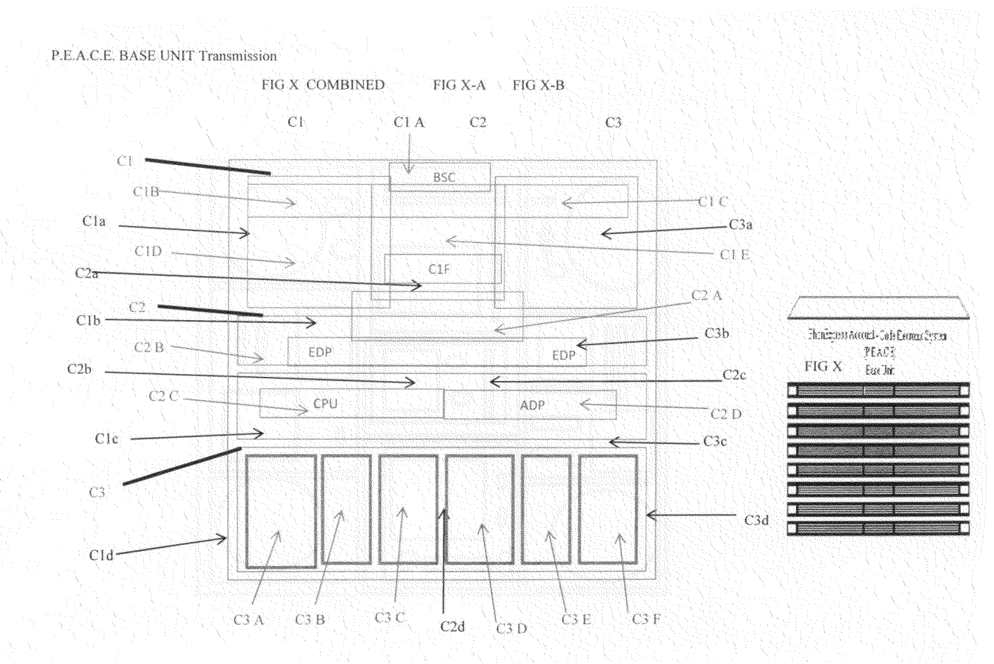

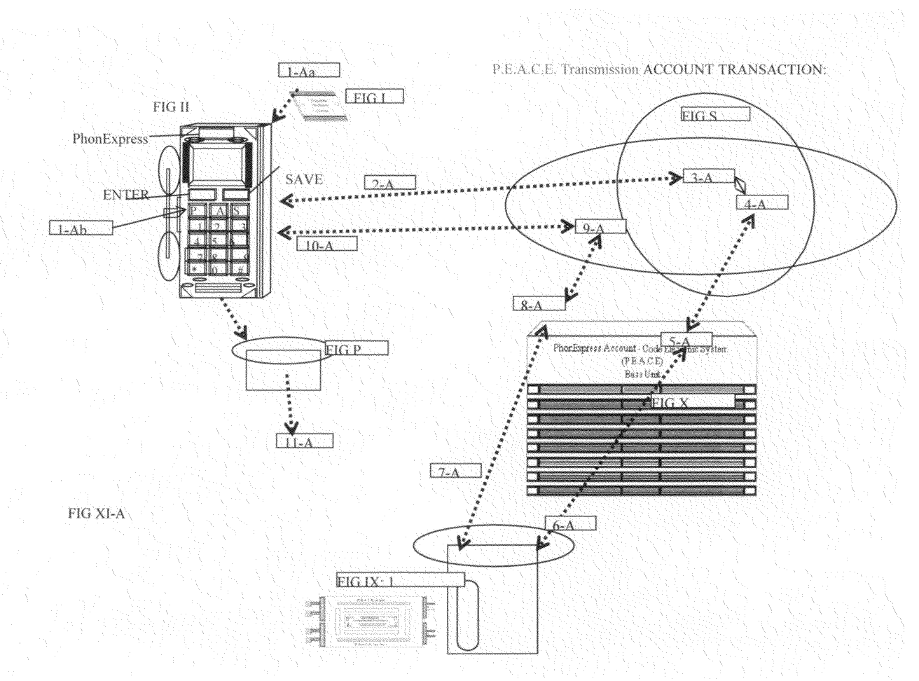

FIG. 14-CA: FIG. X: P.E.A.C.E. Base Unit transmits code signals to FIG. II: PhonExpress telephone

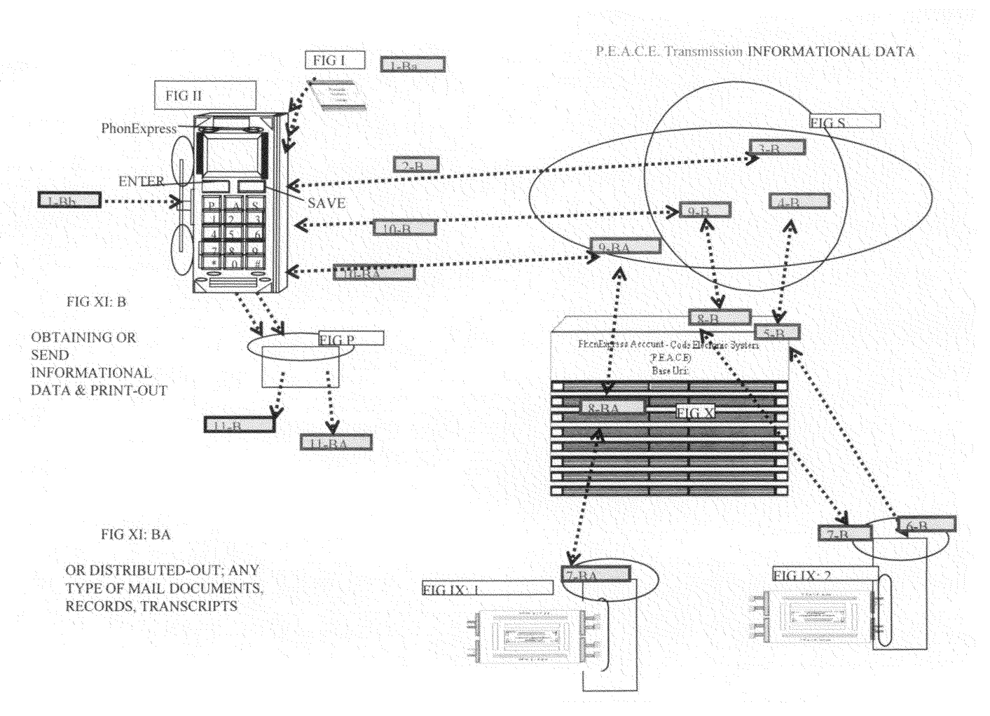

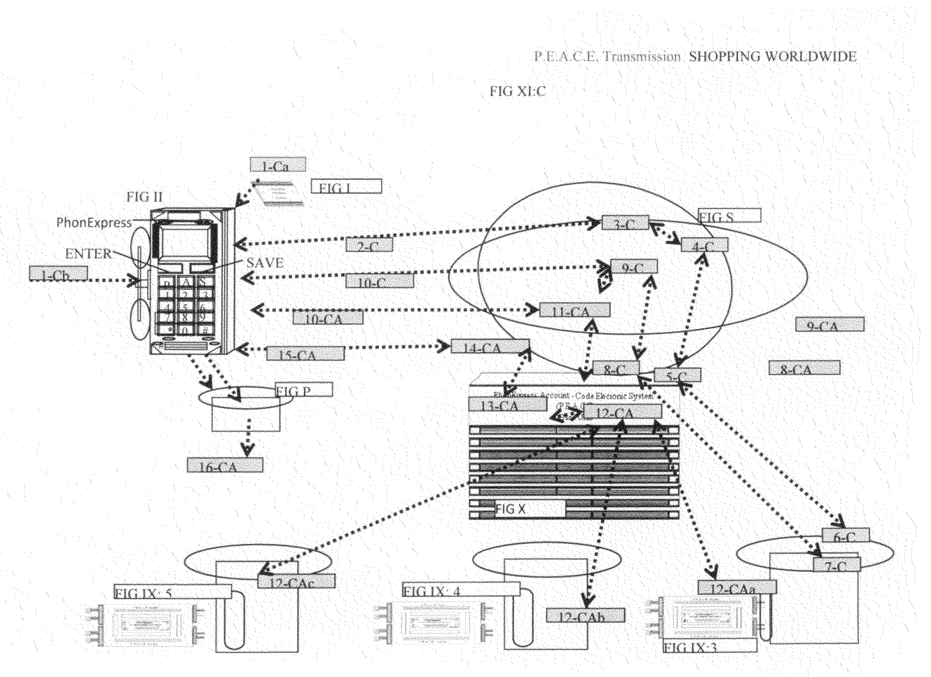

FIG. 15-CA: then cardholder enters address FIG. II: PhonExpress telephone keys for delivery of merchandise anywhere worldwide transmits code signals FIG. S “Satellite” transmits code signals FIG. X: P.E.A.C.E. Base Unit transmits code signals FIG. IX:3 Converter that's connected to (Place of Shopping) business or companies or restaurant computerized resource server of inventory and price data

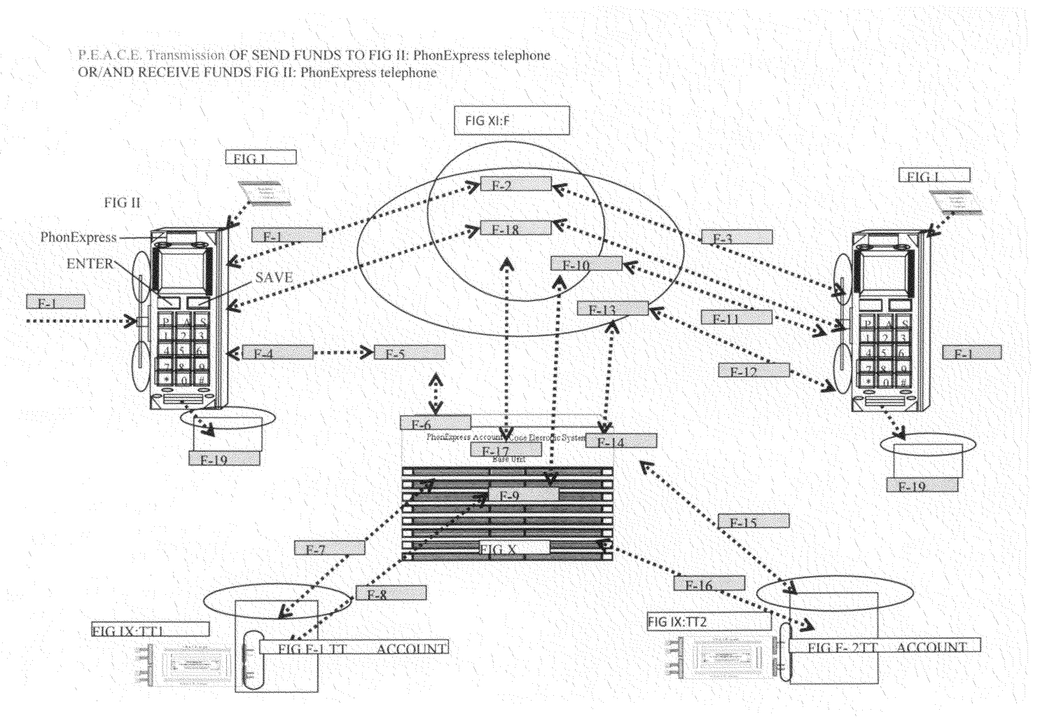

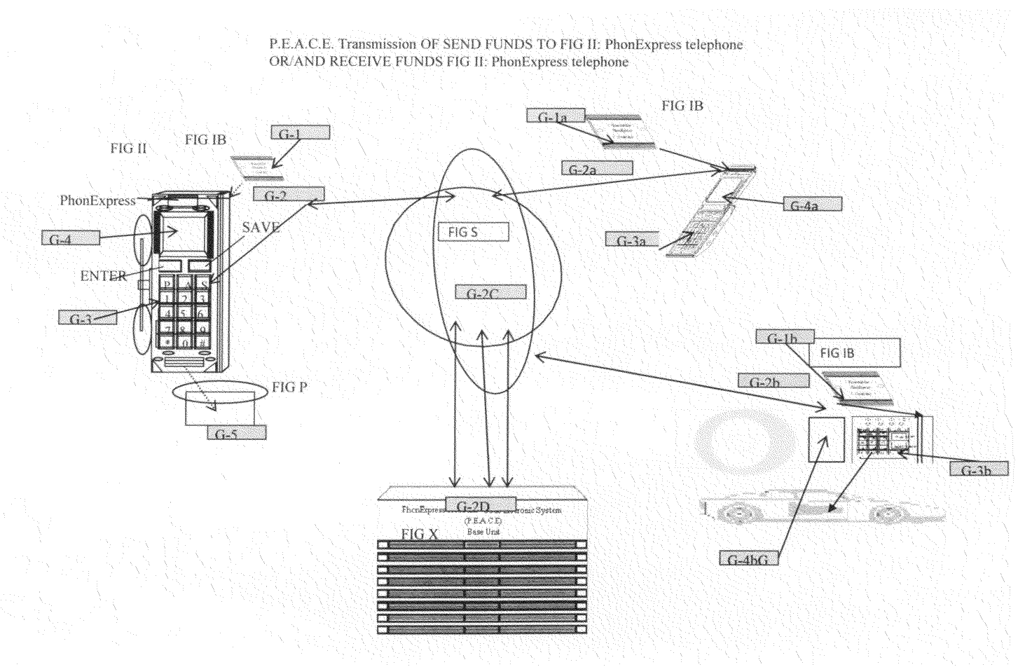

FIG. 16-C: FIG. II: PhonExpress telephone FIG. P: Printer TRANSMITS RECEIPT

### P.E.A.C.E. Electronic Transmission PAGE 42,43-43

SEND FUNDS TO FIG. II: PhonExpress telephone OR/AND RECEIVE FUNDS FIG. II: PhonExpress telephone

FIG. XI F:

FIG. 1-F: FIG. II: PhonExpress telephone enter other cardholder FIG. 2-F FIG. II: PhonExpress telephone number then usage of METHOD with FIG. 1-F: FIG. II: PhonExpress telephone keys or/and Slide FIG. I PhonExpress card Portal [1] Financial-line or [2] Credit-line or FIG. I-I Slip-port [5] Reserve-line or [6] Express-line

FIG. 2-F: Transmission signals of telephone number data to FIG. S: satellite

FIG. 3-F: FIG. S ‘Satellite receives transmission, Transmits signals to FIG. 2-F FIG. II: PhonExpress telephone

FIG. 4-F FIG. S ‘Satellite Transmits signals of data to FIG. X: P.E.A.C.E. Base Unit

FIG. 5-F FIG. X: P.E.A.C.E. Base Unit Transmits Signals of data transmits to FIG. IX: P.E.A.C.E. Converter (OF Place FIG. I-F cardholder indicated place for account funds)

FIG. 6-F transmits data of signals (that had been processed) back to FIG. X: P.E.A.C.E. Base Unit

FIG. 7-F FIG. X: P.E.A.C.E. Base Unit then funds is transferred electronic signals to other cardholder FIG. 2-F FIG. II: PhonExpress telephone number

FIG. 8-F: signals indicated the operations of Green lights indicate incoming funds for other cardholder FIG. 2-F FIG. II: PhonExpress telephone

FIG. 9-F: other cardholder FIG. 2-F of FIG. II: PhonExpress telephone indicated obtaining funds, proceeded on with process of activating FIG. 2-F of FIG. II: PhonExpress telephone its place of account for funds

FIG. 10-F: FIG. S ‘Satellite receives transmission, Transmits signals to FIG. 2-F FIG. II: PhonExpress telephone

FIG. 11-F: FIG. S ‘Satellite Transmits signals of data to FIG. X: P.E.A.C.E. Base Unit

FIG. 12-F: FIG. X: P.E.A.C.E. Base Unit Transmits Signals of data transmits to FIG. IX: P.E.A.C.E. Converter (OF Place FIG. 2-F cardholder indicated place for account funds)

FIG. 13-F: FIG. S ‘Satellite receives transmission, Transmits signals

FIG. 14-F: FIG. 1-F: cardholder of FIG. II: PhonExpress telephone account funds are transferred to FIG. 2-F cardholder of FIG. II: PhonExpress telephone

FIG. 14-F: BOTH FIG. 1-F: cardholder of FIG. II: PhonExpress telephone and FIG. 2-F cardholder of FIG. II: PhonExpress telephone is Distributed P.E.A.C.E. RECEIPT

### P.E.A.C.E. Electronic Transmission PAGE 40-43

### OBTAIN INFORMATIONAL DATA CHECK IDENTIFICATION & BACKGROUND

FIG. II-FIG. III-FIG. IV-FIG. VI ENTRYWAYS

FIG. G-1: FIG. G-1a: FIG. Glb: usage is by method of sliding either FIG. I: PhonExpress card Slip-port [7] IDH-Line or [8] MDH-line

FIG. G-2: FIG. G-2a: FIG. G-2b: transmission digital data FIG. C of FIG. S ‘Satellite’ then transmitted to FIG. D PEACE Base unit that processes and transmits back to FIG. S ‘Satellite’ which in turn transmits to the PEACE device that is being used then becomes—

FIG. G-3: FIG. G-3a: FIG. G-3b: accessible by cardholder entering security code, or may be over ride by security of Police, doctor, Government agency.

FIG. G-4: FIG. G-4a: FIG. G-4b: digital data is transcript upon the LCD screen on either FIG. II, FIG. III, FIG. IV FIG. VI of PEACE devices DISPLAYS FOR cardholder, doctor, and police, any to see identification or medical data of medication usage or background check

FIG. G-5: FIG. G-5a: FIG. G-5b: is also available for print out, if connection to a FIG. P: Printer

### DETAILED DESCRIPTION OF THE PREFERRED EMBODIMENT

P.E.A.C.E. is a one World system, establishes ONE PhonExpress system card for each person and all people to use. This cost very little to make and very easy to use. This enables a way for everyone Not to have to carry so many account cards, credit cards, discount cards, ID, Medical cards, phone-cards, insurance cards you name it there is some type of card for everything. Plus people wouldn't have to carry any money at all, unless they wanted too.

PhonExpress system card enables accessibility to all accounts-codes to be wrapped up into ONE PhonExpress system card. Enables People to operate account-code transactions themselves. Whether be to transfer account funds, credit accounts, pay a bill, purchase items, or obtain informational data of documents, records, homework, applications, plus have identification, their history and Medical conditions handy. This is for all People no matter whether be handicapped, disabled, deaf, blind or not. People can Shop anywhere, order products, fast food, anytime day or night Worldwide, pay for items immediately and have everything delivered to doorstep or anywhere at their conveyance for delivery.

This Invention enables All People to access to operations of account-code transactions themselves in the privacy of their residences, offices, in their car, on boats, trains, buses, schools, hospitals anywhere anytime day or night Worldwide.

With P.E.A.C.E. systems PhonExpress keys and slot-port built into devices enables easy usage for either digital transmission or non-digital signals too.

This is very economical, and enables more jobs of employment for every businesses and companies. Plus helps maintain fast services of paying immediately for the purchased merchandise or items, without No hassles of standing in line, or be waiting in a line of traffic. This will help cut down on fuel usage, rush hour traffic, car accidents, and crowds. Plus would help Police for Security checks at Airports, schools, Police departments, hospitals, having protection with ID with all records of that Person who is the cardholder, and PhonExpress system card Can NOT be duplicated. Accessible only by the cardholder's security code or by over-rides of authorities.

FIG. XX P.E.A.C.E.: PhonExpress Account-Code Electronic System used anywhere anytime day or night worldwide

PhonExpress: P.E.A.C.E. system electronic keys, slot-port, receipt port, attachments to printer built into telephone systems, cellular telephone systems, and store adapters, computerized keyboards, TV remotes and other various PhonExpress adapters.

FIG. XX-A: Account: electronic entryways to activate, access, account transactions with currency or credit funds wherever credit is established.

FIG. XX-C: Code: electronic entryways to FIG. IX: P.E.A.C.E. converter that is connected to computerized resource servers. Of businesses company's stores convenience stores medical plazas doctors' offices police departments. Enables electronically obtaining, sending and receiving of informational data, electronic shopping, purchasing, and paying for items and everything delivered.

Electronic: electronically transmitting digital signals of communications PhonExpress telephones simultaneously with P.E.A.C.E. base unit to computerized resource servers for accounts of currency or credit or direct lines with P.E.A.C.E. converter of codes for informational data, inventory and prices.

System: system works all together with ONLY ONE PhonExpress system card its concealed PhonExpress slip-card

FIG. IF: PhonExpress system card: establishes four account code portals, two front-side portals are entry's to FIG. X: P.E.A.C.E. base unit electronic terminals pertaining to funds of currency or credit transmitting to computerized resource servers for account transactions. Also two back-side portals are entry's to an electronic direct-line.

FIG. IX: P.E.A.C.E. converter connector of computerized resource servers for obtaining, translating of informational data, inventory of items and prices for electronic shopping

FIG. LK1/FIG. RK2: Two open/close keys: This also is established with two open/close keys located on the front of PhonExpress system card. By using either open/close key protracts out the concealed PhonExpress slip-card by using the same open/close key retract back into PhonExpress system card.

FIG. I-I: Slip-card: conceals four accounts inside of PhonExpress system card, protracting and retracting from the left-side two accounts pertaining to funds placed directly on account and an account of entry's to three options of computerized accounts. From the right-side two accounts pertaining to informational data of identification, background, medical history and medication of cardholder.

FIG. IX: P.E.A.C.E. converter: electronic transmitting device of digital signals for obtaining informational data, inventory of items and prices and translating data to PhonExpress telephone conversing simultaneously to FIG. X: P.E.A.C.E. base unit pay for purchased items of shopping with computerized resource server of accounts

FIG. X: P.E.A.C.E. base unit: is an electronic computerized machine of account-code systems, electronic accountant, transmitting digital data, relaying digital signals. Electronic operations for account transactions, sending funds, receiving funds and electronic operations of FIG. IX: P.E.A.C.E. converter connected to computerized resource server obtain data of informational data, inventory of items and prices of business or companies' computerized systems.

FIG. XP: P.E.A.C.E. System: FIG. I: PhonExpress system card [with or with-out concealed FIG. I-I: PhonExpress slip-card]

FIG. I: PhonExpress system card and its two open/close keys protracts and retracts out the concealed FIG. I-I: PhonExpress slip-card to either left or right, or can be adjusted top or bottom

FIG. XP: P.E.A.C.E. System: FIG. A3 Card Slot-port

Built into original telephones, cellular telephones, computerized keyboards, TV keypad and other various machine devices Card slot-port be used with PhonExpress system card or/and PhonExpress slip-card and PhonExpress operational keys and may still use any original Methods of type of account cards, debit cards, credit cards, etc.

FIG. XP: P.E.A.C.E. System: PhonExpress Additional keys Added to original telephone, cellular telephone, computerized keyboards, TV keypads and other various machine devices

FIG. XP: P.E.A.C.E. System extra connectors for attachments Added to original telephone, cellular telephone and other various machine devices, printers, computers and receipt distribution

FIG. XP: P.E.A.C.E. System: FIG. IX: P.E.A.C.E. Converter that connects to business and companies computerized resources relaying data of information such as accounts, inventory, records, documents etc.

FIG. XP: P.E.A.C.E. System: FIG. X: P.E.A.C.E. Base unit that converses informational data to and from or engages in direct line of electronic communications with P.E.A.C.E. converter and PhonExpress telephones, PhonExpress cellular telephones, PhonExpress computerized keyboards, PhonExpress TV remote keypads, and other PhonExpress devices

FIG. PE: PhonExpress: methods of Electronic shopping, immediate purchase of items, and delivery of everything, from groceries, medication, fast foods, etc. . . . retrieving informational data of records, documents etc. . . . plus activating, accessing, sending, and receiving funds

Method entry of FIG. XP-C P.E.A.C.E. Code: (1-digit country, 2-digits state, 3-digit area code, 4-digit building code, 5-digit zip-code) activates operations of FIG. IX: P.E.A.C.E. converter

Methods of FIG. I: PhonExpress system card FIG. I-P: Portals, and two open/close keys and (concealed) FIG. I-I SP: PhonExpress Slip-ports: Choice of arrangements of:

FIG. I-F: PhonExpress system card FIG. I-FP: Portals

FIG. I-FPa [1] Financial-line: for activating, accessing sending receiving, transferring account funds of currency
FIG. I-FPb [2] Credit-line: for activating, accessing sending receiving, transferring account funds of credit wherever credit is issued

FIG. I-B: PhonExpress system card: FIG. I-BP: Portals

FIG. I-BPa:[3] Security-line: for activating accessing sending receiving, transferring any type of informational data, documents, records, etc.
FIG. I-BPb [4] Consumers-line: for activating accessing items from business or companies informational data of inventory and prices along with immediate purchase of items with either account funds of currency or credit of sending directly to business or companies account systems. Along with delivery of purchased items

FIG. I-I SP: Slip-ports: Activation of accessing account options choice of Five or more or less can be used

FIG. I-I LPa: [5] Reserve-line: activating, accessing, funds from different various accounts of currency, maintaining a budget, employment, unemployment, DDF distribution of disability funds, EBT food stamps
FIG. I-I LPa: [6] Express-line: activating, accessing, funds from different various accounts of credit, in-store credit, prepaid PhonExpress minutes that accessible for minutes of usage for a PhonExpress call or account-code options
FIG. I-I RPa: [7] IDH-line activation, accessing read-out or print-out of cardholder's Identification and background history
FIG. I-I RPb: [8] MDH-line: activation, accessing read-out or print-out of cardholder's Medical problems and medication usage and medical history

Method of having everything all on One PhonExpress system card and it's concealed PhonExpress slip-card. Accessible only by cardholder's security code or over-ride by police departments, hospitals. Enables cardholder usage anytime anywhere day or night worldwide. Method of Information of each P.E.A.C.E. System's PhonExpress operational keys and keypad method of usage which was sent and has already been documented.

PhonExpress: FIG. XP: P.E.A.C.E. system electronic keys, FIG. A: [P] PhonExpress key: FIG. A:1 [A] Account-Code key: FIG. A2: [S] System key: FIG. A3: Slot-port: FIG. A4: ENTER key: FIG. A5: SAVE key: FIG. A6: C/C/C key: FIG. A7: PhonExpress placement key: any corrections needed answer by usage of these keys FIG. A8: [*] Star key “YES”: and FIG. A9: [#] Pound key “NO”: and FIG. A10: Receipt port: built into FIG. II-FIG. VI PhonExpress various adapters. Attachments built into for FIG. A17: plug-in out-lets FIG. A17a: Car charger FIG. A18: Printers: FIG. A19: computers: FIG. A19a: Flash-drives: FIG. A19b: cash-register: FIG. A20: USB drive: FIG. A21: flat-board cord: divider computer FIG. II: PhonExpress telephone systems: FIG. III: PhonExpress telephone adapters: and FIG. IV: PhonExpress cellular telephone: PhonExpress FIG. A22: Digital eye: built into FIG. VIII: PhonExpress TV remote: for digital transmission.

ACCOUNT: Electronic FIG. I-P Portals are entryways to activate, access, and account transactions with currency or credit funds wherever credit is established. Anywhere anytime day or night worldwide

CODE: Electronic Portals of entryways to FIG. IX: P.E.A.C.E. converter that is connected to computerized resource servers. Of businesses company's stores convenience stores medical plazas doctors' offices police departments. Enables electronically obtaining, sending and receiving of informational data, electronic shopping, purchasing, and paying for items and everything delivered. Anywhere anytime day or night worldwide

ELECTRONIC: Transmitting of communications through digital signals to FIG. II: PhonExpress telephones or/and other

FIG. III-FIG. VIII: PhonExpress devices. A 22 Digital eye transmits digital signals through TV digital serves. Simultaneously conversing with FIG. X: P.E.A.C.E. base unit to computerized resource servers for accounts of currency, credit or in-store credit and direct lines with FIG. IX: P.E.A.C.E. converter of codes for informational data, inventory and prices.

SYSTEM: All these systems combined and working together electronically with digital computerized transmission P.E.A.C.E. system's PhonExpress and usage of One FIG. I: PhonExpress system card its concealed FIG. I-I: PhonExpress slip-card Portals and its Slip-ports are usable anywhere anytime day or night worldwide

FIG. I: PhonExpress system card: Four Portals out-side and with usage of Two open/close keys accesses Four Slip-ports inside concealed This altogether establishes Eight; All Accounts and Codes is accessible into ONE FIG. I PhonExpress system card.

FOUR PORTALS: OF FIG. I PhonExpress system card; IS: Two Account-Code Portals on Front-side These Two portals pertain to funds of currency or credit transmitting to computerized resource servers for account transactions and Two Code-Account Portals. On the back-side are Two portals entryways to electronic direct-lines of FIG. IX: P.E.A.C.E. converter connector of computerized resource servers for obtaining, translating of informational data, inventory of items and prices for electronic shopping.

FOUR SLIP-PORTS: OF FIG. I: IS OF CONCEALED FIG. I-I S PhonExpress Slip-ports; IS: Two on the Left-side are Account-Code and the Two on the Right-side is Code-Account these are concealed on the inside of FIG. I: PhonExpress system card, accessible by usage of the Two Open/Close keys that are on the Front-side.

TWO OPEN/CLOSE KEYS OF FIG. I: PhonExpress system card: IS: Two open/close keys: Left-side FIG. I-F: LK1: open/close key: Right-side FIG. I-F: RK2: open/close key is established located on Front-Side of FIG. I: PhonExpress system card. Activation of either of these keys is by pressing once on either open/close key. This releases FIG. I-I: PhonExpress slip-card Protracts out from one side Two of the concealed FIG. I-IS: Slip-ports. Then by repressing same one used of open/close keys, retracts the same Two Slip-ports back in the same side of FIG. I: PhonExpress system card.

FIG. I-I S: Slip-card. IS: Four Slip-ports concealed inside FIG. I: PhonExpress system card: Each Slip-port is electronic entryways that enables access to Five computerized accounts of FIG. X: P.E.A.C.E. Base unit. FIG. I-I: Slip-card: conceals Four Slip-ports Two Account-Code and Two Code-Account hidden inside of FIG. I: PhonExpress system card. By usage of the left-side FIG. I-F: LK1: open/close key, Protracts and then retracts Two Account-Code from the Left-side; these Two Account-Code Slip-ports establishes entryways to Five computerized accounts options pertaining to funds placed directly into computerized accounts. And By usage of right-side FIG. I-F RK2: open/close keys, Protracts and retracts from Right-side is Two Code-Account Slip-ports that establishes entryways to Five computerized accounts pertaining Informational data of Identification, Background, Medical History and Cardholder Medication.

FIG. IX: P.E.A.C.E.CONVERTER: electronic transmitting device of digital signals for obtaining Informational data, inventory of items and prices and translating data to PhonExpress devices conversing simultaneously to FIG. X: P.E.A.C.E. base unit pay for purchased items of shopping with computerized resource server of account-code and code-account-systems

FIG. X: b: P.E.A.C.E BASE UNIT: is an electronic computerized machine of combinations using accounts-codes-letters-numbers systems, electronic accountant, transforming, transmitting digital data, conversing, relaying of digital signals. Electronic digital operations for account transactions, sending funds, receiving funds and electronic operations of obtaining, transferring, conversing data and transforming into digital signals FIG. IX: P.E.A.C.E. converter connected to computerized resource server that obtains data of informational data, inventory of items and prices of business or companies' computerized systems.

P.E.A.C.E. systems: FIG. I: PhonExpress system card/FIG. I-I PhonExpress Slip-port

FIG. I: PhonExpress system card Establishes Four main account-code Portals, which each enables electronic entry to operations of digital account-code terminals in FIG. X: P.E.A.C.E. system's base unit
a. Color-coded: easier to distinguish differences in Portals and Slip-ports
b. Each Account-Code Portal and Slip-port is Numbered and engraved numerals of Braille write
c. Two open/close keys, one key is on left and one key is on right of Side 1
d. Concealed inside is FIG. I-I: PhonExpress slip-card
e. FIG. I-I: PhonExpress slip-card Establishes Four main account-code Slip-ports, which each enables entry to Five digital computerized accounts in FIG. X: P.E.A.C.E. System's base unit
f. FIG. I: PhonExpress system card establishes Two Account-Code and Two Code-Account Portals on out-side and Two Account-Code Two Code-Account Slip-ports on the inside of the concealed FIG. I-I: PhonExpress slip-card.
g. FIG. I: PhonExpress system card establishes TWO OPEN/CLOSE KEYS by choice of usage is by pressing on one of the two-open/close keys. Enables FIG. I: PhonExpress system card to Protract-out the concealed FIG. I-I: PhonExpress slip-card to either left-side or right-side of FIG. I: PhonExpress system card.

DESCRIPTION OF COLOR CODED FIG. I: PhonExpress system card conceals FIG. I-I: PhonExpress slip-card

FIG. I: PhonExpress system card: FOUR ACCOUNT-CODE FIG. I-FP PORTALS

FIG. I-F: SIDE 1 TWO ACCOUNT-CODE FIG. I-FP: PORTALS account transactions of currency & credit
a) FIG. I-FP-a: PORTAL [1] Financial-line: color-coded in Green
b) FIG. I-FP-b: PORTAL [2] Credit-line: color-coded in Brown

FIG. I-B: SIDE 2 TWO CODE-ACCOUNT FIG. I-BP: PORTALS code transactions of informational data, digital shopping
c) FIG. I-BP-a: PORTAL [3] Security-line: color-coded in Blue
d) FIG. I-BP-b: PORTAL [4] Consumers-line: color-coded in Black

FIG. I: PhonExpress system card SIDE 1: TWO OPEN/CLOSE KEYS
e) FIG. I-FL: LK1 LEFT OPEN/CLOSE KEY
f) FIG. I-FR: RK2 RIGHT OPEN/CLOSE KEY

FIG. I-C: PhonExpress system card CONCEALED FIG. I-I: PhonExpress slip-card FOUR ACCOUNT-CODE SLIP-PORTS

FIG. I-IL: LEFT TWO ACCOUNT-CODE SLIP-PORTS Expands out from Left side:
g) FIG. I-I LSP-a: SIDE 1: Slip-ports D [5] Reserve line: Color-coded-Gray
h) FIG. I-I LSP-b: SIDE 2: Slip-ports I [6] Express-line: Color-coded-yellow

FIG. I-IR: RIGHT TWO CODE-ACCOUNT SLIP-PORTS Expands out from Right side:
i) FIG. I-I RSP-a: SIDE 1: Slip-ports E [7] IDH-line: Color-coded-Tan
j) FIG. I-I RSP-b: SIDE 2: Slip-ports J [8] MDH-line: Color-coded Red

FIG. I: PhonExpress system card/FIG. I-I PhonExpress Slip-port FIG. I: PhonExpress system card

FIG. I-F: FRONT-SIDE TWO ACCOUNT-CODE PORTALS

a) FIG. I-FPa: SIDE 1: PORTAL B [1] Financial-line: entry to any account transactions of currency
b) FIG. I-FPb: SIDE 1: PORTAL C [2] Credit-line: entry to any credit account transactions (credit established)

FIG. I-B: BACKSIDE TWO CODE-ACCOUNT PORTALS

a) FIG. I-BPa: SIDE 2: PORTAL G [3] Security-line: entry to obtain any informational data, records, documents
b) FIG. I-BPb: SIDE 2: PORTAL H [4] Consumers-line: entry for any electronic shopping

FIG. I-F: SIDE 1: TWO OPEN/CLOSE KEYS OF FIG. I: PhonExpress system card

### a) FIG. I-F: LK1, LEFT-SIDE

### b) FIG. I-F: RK2RIGHT-SIDE

FIG. I-I: PhonExpress slip-card OF FIG. I: PhonExpress system card

FIG. I-IL: LEFT-SIDE TWO ACCOUNT-CODE SLIP-PORTS

a) FIG. I-I LSPa: SIDE 1: SLIP-PORT FIG. D [5] Reserve-line: entry to Five account options of currency
b) FIG. I-I LSPb: SIDE 2: SLIP-PORT FIG. I [6] Express-line: entry to Five credit account options

FIG. I-IR: RIGHT-SIDE TWO ACCOUNT-CODE SLIP-PORTS

k) FIG. I-I RSPa: SIDE 1: SLIP-PORT FIG. E [7] IDH-line: entry to Five Options to accessibility of Identification
l) FIG. I-I RSPb: SIDE 2: SLIP-PORT FIG. J [8] MDH-line: entry to Five Options accessibility of Medical

FIG. I: PhonExpress system card: FIG. I-I: PhonExpress Slip-card: concealed SLIP-PORTS Five digital computerized accounts

FIG. I-IL: LEFT-SIDE TWO ACCOUNT-CODE SLIP-PORTS

FIG. I-I LSP-a: PhonExpress Slip-card: SIDE 1: FIG. D [5] Reserve-line: SLIP-PORT entry Options; Five digital computerized Account-codes

1) Conserve-line: maintain budget

2) Employ-line: employment funds

3) Unemploy-line: unemployment funds

4) EBT-line: food stamps funds

5) DDF-line: disability distribution funds

FIG. I-I LSP-b: PhonExpress Slip-card: SIDE 2: FIG. I [6] Express-line: SLIP-PORT entry Options; Five digital computerized Account-codes

1) Express-fuel: pay-at-the-pumps, credit established with businesses

2) Express-store: enables for in-store credit at any company or business

3) Express-call: currency or credit prepaid PhonExpress usage for minutes

4) Express-ride: cardholder's funds for busses or taxi's

5) Express-disc: enables usage for discounts at any business or companies establishments

FIG. I-IR: RIGHT-SIDE TWO ACCOUNT-CODE SLIP-PORTS

FIG. I-I RSPa: PhonExpress Slip-card: SIDE 1: FIG. E [7] IDH-line: SLIP-PORT entry Options; Five digital computerized Code-accounts.

1) ID-line: cardholder's Name, DOB, Driver's license, Social Security number

2) ED-line: cardholder's educational history

3) Chan-line: enables cardholder for entry to change data on account

4) Employ-line: cardholder's employment history

5) BG-line: cardholder's background history

FIG. I-I RSPb: PhonExpress Slip-card: SIDE 2: FIG. J [8] MDH-line: SLIP-PORT entry Options; Five digital computerized Code-accounts

1) Medic-line: cardholder's present medical problems

2) Med-line: cardholder's usage of present medications

3) Chan-line: enables cardholder, doctors entry to change data on account

4) Access-line: enables digital transmission for ICD-pace maker, pacemakers

5) History-line: cardholder's medical history, childhood records

P.E.A.C.E. systems: FIG. I-F: PhonExpress system card FRONT-SIDE 1 ACCOUNT-CODE FORMULA METHOD OF USAGE PORTALS

FIG. I-FPa: PhonExpress system card SIDE 1: FIG. B: [1] Financial-line: PORTAL is an engraved in strip-line code of numbers terminal 01 and cardholder Social Security Number [01- - -/- -/- - - -] for transmitting electronic code of numbers digital signals through A3 Slot-port on any PhonExpress devices transmitting code of numbers for activation to electronic digital account-code Portal terminal of accounts. Intern FIG. X: P.E.A.C.E. base unit engages into terminal 01 operation obtaining all accounts of currency under that code of numbers of that cardholder. Intern PhonExpress enables entry of an account number of choice. This in turn enables cardholder to proceed on with methods to activate and access their-own account transactions pertaining to funds of currency anywhere Worldwide.

FIG. I-FPb: PhonExpress system card SIDE 1: FIG. C: [2] Credit-line: PORTAL is an engraved in strip-line code of numbers terminal 02 and cardholder Social Security Number [02- - -/- -/- - - -] for transmitting electronic code of numbers digital signals through A3 Slot-port on any PhonExpress devices transmitting code of numbers for activation to electronic digital Portal terminal of credit accounts. Intern FIG. X: P.E.A.C.E. base unit engages into terminal 02 operations obtaining all credit accounts wherever credit is established under that code of numbers of that cardholder. Intern PhonExpress enables entry of a credit account number of choice. Which intern enables cardholder to proceed on with methods to activate and access their-own credit account transactions pertaining to funds of credit wherever credit is established anywhere Worldwide

FIG. I-B: PhonExpress system card BACK-SIDE 2 CODE-ACCOUNT PORTALS

FIG. I-BPa: PhonExpress system card SIDE 2: FIG. G: [3] Security-line: PORTAL is an engraved in strip-line code of numbers terminal 03 and cardholder Social Security Number and P.E.A.C.E. code for converter Number [03- - -/- -/- - - - P.E.A.C.E.] for transmitting electronic code of numbers, and Digital signals through A3 Slot-port on any PhonExpress devices transmitting code of numbers for activation to electronic digital account-code Portal terminal of Codes. Which intern FIG. X: P.E.A.C.E. base unit engages into operations. Which intern PhonExpress devices enables for entry of 15 digits code numbers pertaining of 1-digit country, 2-digit state, 3-digit area code, 4-digital building code, 5-digit zip code [-/- -/- - -/- - - -/- - - - -] of any FIG. IX: P.E.A.C.E. converter transmits digital signals to open a direct line for any FIG. IX: P.E.A.C.E. informational data processing program. Cardholder proceeds on with methods obtaining informational data.

FIG. I-BPb: PhonExpress system card SIDE 2: FIG. H [4] Consumers-line:

PORTAL is an engraved in strip-line code of numbers terminal 04 and cardholder Social Security Number and P.E.A.C.E. code for converter Number [04- - -/- -/- - - - P.E.A.C.E.] for transmitting electronic code of numbers, and Digital signals through A3 Slot-port on any PhonExpress devices transmitting code of numbers for activation to electronic digital account-code Portal terminal of Codes. Which intern FIG. X: P.E.A.C.E. Base unit engages into operations. Which intern PhonExpress devices enables for entry of 15 digits code numbers pertaining of 1-digit country, 2-digit state, 3-digit area code, 4-digital building code, 5-digit zip code [-/- -/- - -/- - - -/- - - - -] of any FIG. IX: P.E.A.C.E. converter transmits digital signals to open a direct line for any FIG. IX: P.E.A.C.E. informational data processing program. Cardholder proceeds on with shopping methods

FIG. I-IC: PhonExpress slip-card ACCOUNT-CODE FIG. I-I SPL SLIP-PORTS

### FIG. I-IL SC Slip-card TWO ACCOUNT-CODE—FIG. I-I SPR SLIP-PORTS

FIG. I-I LSPa: PhonExpress Slip-card: FIG. D: [5] Reserve-line: SIDE 1: Slip-port enables cardholder entry to five digital computerized Account-code options. This enables different resources of funds currency that's automatically distributed into these digital computerized Account-codes. This in turn is very easy for cardholder to have their funds immediately and at their fingertips having access to any digital computerized account funds, by only cardholder security code. This enables no need for the use to carry any cash funds. Location is on Sidel of left-side on FIG. I-I SC: Slip-card which protracts-out and retracts back-in concealed inside of FIG. I: PhonExpress system card.

FIG. I-I LSPb: PhonExpress Slip-card: FIG. I: [6] Express-line SIDE 2: Slip-port: enables cardholder entry to five digital computerized Account-code options. This enables for the cardholder more usage with credit, in-store credit, and pre-paid PhonExpress minutes for calls or account-code transactions, to receive any business or companies discount prices. Location is on Side 2 of left-side on FIG. I-I SC: PhonExpress slip-card which protracts-out and retracts back-in concealed inside of FIG. I: PhonExpress system card.

FIG. I-IR SC Slip-card TWO CODE-ACCOUNT FIG. I-I SPR SLIP-PORTS

FIG. I-I SRa: PhonExpress Slip-card: FIG. E: [7] IDH-line: SIDE 1: Slip-port: establishes entry of options to Five digital computerized Code-accounts. This enables cardholder entry to Five digital computerized Code-accounts options to Identification, educational data, employment and background informational data. This enables cardholder to carry everything and is handy whenever needed for employment, police, paramedics, doctors or hospitals to access on emergency basis. This is accessible only by cardholder Security code. Which intern PhonExpress enables police or hospitals Override of Security code Located on the right-side, of Sidel, of FIG. I-I SC: Slip-card, which protracts and retracts from inside of FIG. I: PhonExpress system card.

FIG. I-I SRb: PhonExpress Slip-card: FIG. J: [8] MDH-line: SIDE 2: Slip-port: entry of options to Five digital computerized Code-accounts. Enables cardholder to carry any present Medical problems, list of medication usage, transmits digital signals revert into informational data of pacemaker or ICD-pacemaker anytime, anywhere. This enables cardholder to carry childhood medical records and any past medical history. This is easier for police, paramedics, doctors, or hospital to access for emergency purposes. Location is on the right-side, of Side 2, of FIG. I-I SC: Slip-card, which protracts and retracts from inside of FIG. I: PhonExpress system card.

P.E.A.C.E. System's ONE CARD FIG. I-C: PhonExpress system card/ FIG. I-I SPL: SLIP-PORTS LEFT-SIDE: FIVE OPTIONS—SEE METHOD OF OPEN/CLOSE KEYS

FIG. I-I LSP-a: PhonExpress Slip-card: SIDE 1: FIG. D: [5] Reserve-line: Slip-port enables cardholder entry to Five digital computerized account-code options. This enables different resources for usage of funds, any currency automatically distributed into these digital computerized accounts. This in turn is very easy for cardholder to have their funds immediately and at their fingertips having access to any digital computerized account funds, by only cardholder security code. This enables no need for the use to carry any cash funds. Location is on Sidel of left-side on FIG. I-I SC: Slip-card which protracts-out and retracts back-in concealed inside of FIG. I: PhonExpress system card.
1) Option [1] Conserve-line: cardholder enters amount of funds in digital computerized account maintain a budget.
2) Option [2] Employ-line: distribution of employment funds cardholder access in a digital computerized account.
3) Option [3] Unemploy-line: distribution of unemployment funds cardholder access in digital computerized account
4) Option [4] EBT-line: distribution of food stamp credits cardholder access in digital computerized account
5) Option [5] DDF-line: funds in a computerized digital account Disability Distribution Funds. This enables cardholder to carry a specific amount of funds of currency or credit, to use funds directly from computerized digital accounts.
   P.E.A.C.E. System's ONE CARD FIG. I-C: PhonExpress system card/FIG. I-I SPL: SLIP-PORTS LEFT-SIDE: FIVE OPTIONS—SEE METHOD OF OPEN/CLOSE KEYS

FIG. I-ILSP-b PhonExpress Slip-card: SIDE 2: FIG. I: [6] Express-line: Slip-port enables cardholder entry to Five digital computerized Account-code options. This enables cardholder more usage with credit, in-store credit, and pre-paid PhonExpress minutes for calls or account-code transactions, to receive any business or companies discount prices. Location is on Side 2 of left-side on FIG. I-I SC: Slip-card protracts-out and retracts back-in, concealed in FIG. I PhonExpress system card.
1) Option [1] Express-fuel: activates access to digital computerized credit account for funds to pay-for fuel at the pumps convenient stores.
2) Option [2] Express-store: enables for businesses, stores, companies to distribute funds of in-store credit in digital computerized account, enables cardholder easier access for in-store credit account transactions at the business, stores, companies established in-store credit with.
3) Option [3] Express-call: activates either funds of currency or credit for prepaid minute's funds for minutes of PhonExpress usage, of PhonExpress call, or Account-Code transactions send, receive funds with any PhonExpress devices, enables cardholder access of choice in minutes used from computerized digital account
4) Option [4] Express-ride: activates funds that are distributed for bus rides, taxicab rides into digital computerized account that enables cardholder easier access, handy for bus-rides or taxi.
5) Option [5] Express-disc: activates discounts from any business or companies' digital computerized account resource server for cardholder. Which PhonExpress electronically engages operations obtaining the discounts and automatically removes that business or company's discount percentage from total amount due for cardholder
   P.E.A.C.E. System's ONE CARD—FIG. I: PhonExpress system card/FIG. I-IR: SLIP-PORTS RIGHT-SIDE: FIVE OPTIONS—SEE METHOD OF OPEN/CLOSE KEYS

FIG. I-I RSP-a: PhonExpress Slip-card: SIDE 2: Slip-port FIG. E: [7] IDH-line: establishes entry of options to Five digital computerized Code-accounts. This establishes for the cardholder entry-way to Five digital computerized account options to Identification, educational data, employment and background informational data, and enables cardholder to carry everything, whenever is needed for employment, police, paramedics, doctors or hospitals to access on emergency basis. This is accessible only by the cardholder Security code. The PhonExpress enables police or hospitals Override of Security code Location is on the right-side, of Sidel, of FIG. I-IR: PhonExpress slip-card, which protracts and retracts from inside of FIG. I: PhonExpress system card.

1) Option [1] ID-line: enables cardholder to carry informational data of Name, DOB, Drivers license, Social Security.
2) Option [2] ED-line: enables cardholder to carry informational data of educational history.
3) Option [3] Chan-line: enables for cardholder to change any data of choice on [7] IDH-line computerized accounts.
4) Option [4] Employ-line: enables cardholder to carry informational data of Employment history.
5) Option [5] BG-line: enables cardholder to carry informational data of background and record history.

FIG. I-I RSP-b: PhonExpress Slip-card: SIDE 2: FIG. J: [8] MDH-line: Slip-port entry of options to Five digital computerized Code-accounts. Enables cardholder to carry any present Medical problems, list of medication usage, transmits digital signals revert into informational data of pacemaker or ICD-pacemaker anytime, anywhere. This enables the cardholder to carry childhood medical records and any past medical history. This is easier for police, paramedics, doctors, or hospital to access for emergency purposes. Location is on the right-side, of Side 2, of port FIG. I-IR: PhonExpress Slip-card, which protracts and retracts from inside of FIG. I: PhonExpress system card.

1) Option [1] Medic-line: enables cardholder to carry/access informational data of any present medical problems.
2) Option [2] Med-line: enables cardholder to carry/access informational data of any usage of present medication.
3) Option [3] Chan-line: enables for change to data on any of the FIG. J: [8] MDH-line: digital computerized accounts.
4) Option [4] Access-line: enables cardholder usage for electronic digital transmission of Pacemaker or ICD-pacemaker anytime over PhonExpress devices and enables easy printouts for cardholder, paramedics, doctors or hospitals.
Option [5] History-line: enables cardholder to carry/access informational data of any past medical history, childhood records, enables easy access only by security code and printouts for cardholder, paramedics, doctors or hospitals anytime

### DESCRIPTION: METHOD OF USAGE P.E.A.C.E. INDEX

### Phonexpress Account-Code System Card

| FIG I-F: PhonExpress system card | | Front-side of card |
|---|---|---|
| FIG I-F Pa: B Financial-line: | [1] | Portal to accounts of currency |
| FIG I-F Pb: C Credit-line: | [2] | Portal to accounts of credit |
| FIG I-B PhonExpress system card | | Backside of card |
| FIG I-B Pa: G Security-line: | [3] | Portals to codes of informational data |
| FIG I-B Pb: H Consumers-line: | [4] | Portals to codes for electronic shopping |
| FIG I-I SC L: PhonExpress Slip-card | | Protracts-out and retracts-in the Left-side |
| FIG I-I SP La: D Reserve-line: | [5] | Slip-ports to Five computerized account options currency |
| FIG I-I SP Lb: I Express-line: | [6] | Slip-ports to Five computerized account options credit |
| FIG I-I SC R PhonExpress Slip-card | | Protracts-out and retracts-in the Right-side |
| FIG I-I SP Ra: E IDH-line: | [7] | Slip-ports to Five computerized account options Identification |
| | | data |
| FIG I-I SP Rb: J MDH-line: | [8] | Slip-ports to Five computerized account options Medical data |

FIG. I: PhonExpress system card & FIG. I-I SC: Slip-card
FIG. II: PhonExpress system telephone, FIG. II-A: PhonExpress desk telephone
FIG. III: PhonExpress telephone adapter
FIG. IV: PhonExpress system cellular telephone
FIG. V: PhonExpress system store adapter
FIG. VI: A-E: PhonExpress system adapters
FIG. VII: PhonExpress system computerized keyboard
FIG. VIII: PhonExpress system TV remote

### Transmission

FIG. IX: PhonExpress system Converter
FIG. X: PhonExpress system base unit

### FIG. X-A: FIG. X-B: FIG. XI C: Transmission

### DESCRIPTION: METHOD OF USAGE P.E.A.C.E. System KEYS

In the drawings, closely related figures have the same number but different alphabetic suffixes.

ELECTRONIC METHOD OF PROCESS VIEWED IN DRAWINGS:

FIG. II: PhonExpress telephone, FIG. III: PhonExpress telephone adapter, FIG. IV: PhonExpress cellular telephone,

FIG. V: PhonExpress store adapter FIG. VI-A: -FIG. VI-E: VARIOUS PhonExpress adapters, FIG. VII PhonExpress computerized keyboard, FIG. VIII: PhonExpress TV remote.

OPERATIONAL METHOD OF FIG. A: [P] PhonExpress key: located above the number 1 key, at the top, left side, of PhonExpress letter [A] key. See in Drawings FIG. II-FIG. VIII: Which intern activates changes of operations from the usage of the original devices such as telephones original cellular telephones, original computer keyboard, and original TV remote into P.E.A.C.E. system's PhonExpress account-code and code-account system operational usage. PhonExpress operations intern simultaneously activates choice for entry to electronic modes of account-code options.

METHOD OF USAGE: FIG. A: [P] PhonExpress key: by pressing on the letter [P] key and press Enter key on any of the PhonExpress device keypad keyboard or remote keypad used. PhonExpress FIG. A12: A12a: A12b: LCD screens displays choice of options indicated by their numbers

### OPTION [1] PEACE-LINE:

### OPTION [2] TRAN-LINE:

### OPTION [3] DIRECT-LINE:

METHOD OF USAGE: OF ANY OPTIONS IS: by pressing on number key indicating choice of option and then press enter key on PhonExpress keypad keyboard or remote keypad used.
METHOD OF OPTION [1] PEACE-LINE: Activates electronic entry for choice of either Options [1] Portal: or Option [2] Slot-ports: indicated by their numbers. Account-Code or Code-Account Portals or Slip-ports operational access to any of the Five computerized account options.
METHOD OF USAGE: OPTION [1] PEACE-LINE: By pressing number [1] key and enter key on PhonExpress device keypad, keyboard or remote keypad used.
PhonExpress LCD FIG. A12: A12a: or A12b: screen displays options to choose from

### OPTION [1] FIG. I-P: Portals:

### OPTION [2] FIG. I-I SP: Slip-ports:

METHOD OF OPTION [1] Portals: activates choice of Portal transmittal entry to FIG. X: P.E.A.C.E. base unit: its electronic account-code or code account terminals. For usage any account-code transactions of any type of funds or code-account transactions of any type of informational codes from business or companies inventory or codes of informational data such as documents, records, est.

METHOD OF USAGE OPTION [1] Portals: by pressing number [1] key and enter key on PhonExpress device keypad, keyboard or remote keypad using.
PhonExpress FIG. A12; A12a; or A12b; LCD screen displays Options for entry to Portals indicated by their numbers:

### OPTION [1] Portal FIG. I-F Pa: B: Financial-line:

### OPTION [2] Portal FIG. I-F Pb: C: Credit-line:

### OPTION [3] Portal FIG. I-B Pa: G: Security-line:

### OPTION [4] Portal FIG. I-B Pb: H: Consumers-line:

METHOD OF USAGE: OPTION [1] Portal FIG. I-F Pa: B: [1] Financial-line: by pressing number [1] key and enter key on PhonExpress device keypad, keyboard or remote keypad used. For Account-transactions of currency

METHOD OF USAGE: OPTION [2] Portal FIG. I-F Pb: C: [2] Credit-line: by pressing number [2] key and enter key on PhonExpress device keypad, keyboard or remote keypad used. For Credit Account-transactions wherever Credit is established.

METHOD OF USAGE: OPTION [3] Portal FIG. I-B Pa: G: [3] Security-line: by pressing number [3] key and enter key on PhonExpress device keypad, keyboard or remote keypad used. For obtaining any Informational data of documents, records etc.

METHOD OF USAGE: OPTION [4] Portal FIG. I-B Pb: H: [4] Consumers-line: by pressing number [4] key and enter key on PhonExpress device keypad, keyboard or remote keypad used. For electronic digital Shopping anywhere day or night Worldwide.

METHOD OF OPTION: [2] FIG. I-I SP: Slip-ports: Activates entryway of choice to access either one of the Slip-ports indicated by their numbers. Each choice of Account-Code or Code-Account Slip-ports activates entryway to choice of five computerized digital account options.
METHOD OF USAGE OPTION [2] Slip-ports: by pressing number [2] key and then enter key on PhonExpress device keypad, keyboard or remote keypad used.
PhonExpress LCD FIG. A12; A12a; or A12b; screen displays options to choose from

### OPTION [5] FIG. I-I -SP La: FIG. D: Reserve-line:

### OPTION [6] FIG. I-I -SP Lb: FIG. I: Express-line:

### OPTION [7] FIG. I-I -SP Ra: FIG. E: IDH-line:

### OPTION [8] FIG. I-I -SP Rb: FIG. J: MDH-line:

METHOD OF USAGE: Slip-port FIG. I-I SP: La: OPTION [5] FIG. D: Reserve-line: by pressing number [5] key and enter key on PhonExpress device keypad, keyboard or remote keypad used. For usage of Computerized digital accounts for funds of currency or in-store credit or credit issued.

METHOD OF USAGE: FIG. I-I SP: Lb: Slip-port FIG. I-I -SP Lb: OPTION [6] FIG. I: Express-line: by pressing number [6] key and enter key on PhonExpress device keypad, keyboard or remote keypad used. For usage of Computerized digital accounts for funds of currency or in-store credit or PhonExpress minutes

METHOD OF USAGE: FIG. I-I SP: La: Slip-port FIG. I-I -SP Ra: OPTION [7] FIG. E: IDH-line by pressing number [7] key and enter key on PhonExpress device keypad, keyboard or remote keypad used. For any display of Cardholder's Identification, history background checks.

METHOD OF USAGE: FIG. I-I SP: Lb: Slip-port FIG. I-I -SP Rb: OPTION [8] FIG. J: MDH-line by pressing number [8] key and enter key on PhonExpress device keypad, keyboard or remote keypad used. For any display of Cardholder's Medical problems, Medication usage and Medical records SEE METHODS OF FIG. I-I SP: SLIP-PORTS FIVE DIGITAL ACCOUNT-CODE OPTIONS

METHOD OF OPTION [2] TRAN-LINE: activates the ability to transfer account code transactions to another place, Transfer-line activates electronic entry for choice of options for either Options [1] Account or Option [2] Code indicated by their numbers
METHOD OF USAGE OPTION [2] TRAN-LINE: By pressing number [2] and then press enter key on PhonExpress keypad keyboard or remote keypad used.
PhonExpress LCD FIG. A12: A12a: or A12b: screen displays options to choose from

### OPTION [1] Account: OPTION [2] Code:

METHOD OPTION [1] Account: activates entry for an account number to make payment or send funds to another account. Enables for account transactions with either currency or credit.
METHOD OF USAGE OPTION [1] Account by pressing number [1] and enter key on PhonExpress device keypad, keyboard or remote keypad used.
PhonExpress LCD FIG. A12: A12a: or A12b: screen displays [Enter Account number]
METHOD OF USAGE by pressing number keys indicating Account number and enter key on PhonExpress keypad, keyboard or remote keypad used.
PhonExpress LCD FIG. A12: A12a: or A12b: screen displays

### [Any Corrections] PROCEED ON METHODS OF ANSWER KEYS

METHOD OPTION [2] Code: activates entry for a code number to obtain informational data from or send informational data to another place. Enables code transaction of informational data
METHOD OF USAGE OPTION [2] Code: by pressing number [2] and enter key on PhonExpress device keypad, keyboard or remote keypad used.
PhonExpress LCD FIG. A12: A12a: or A12b: screen displays [Enter Code number]
METHOD OF USAGE by pressing number and letter keys indicating of a Code number and then enter key on PhonExpress keypad, keyboard or remote keypad used. Enables process of obtaining informational data of document, records, any informational data
PhonExpress LCD FIG. A12: A12a: or A12b: screen displays

### [Any Corrections] PROCEED ON METHODS OF ANSWER KEYS

METHOD OF USAGE OPTION [3] DIRECT-LINE: by pressing number [3] key and enter key on PhonExpress keypad, keyboard or remote keypad used. Choice of electronic modes of options indicated by their numbers

PhonExpress LCD FIG. A12: A12a: or A12b: screen displays options to choose from

OPTION [1] Call-dial: OPTION [2] PhonExpress:

OPTION [1] Call-dial: activates entry of ‘P.E.A.C.E. code 15-digits’ [1]-digit country [2]-digit state [3]-digit area code [4]-digit building code [5]-digit zip code: which enables for transmitting with a direct-line to any FIG. IX: P.E.A.C.E. converter: that is connected to business or companies computerized resource server. Enabling for electronic digital shopping, proceeds on with account-code transactions

METHOD OF USAGE OPTION [1] Call-dial: by pressing number or letters on the keys indicating country, state, area, building, and zip code after entry of the {15} digits then press enter key on PhonExpress keypad keyboard or remote keypad used.

OPTION [2] PhonExpress: activates entry of {10}-digits ‘PhonExpress telephone number’ to be entered in, which enables caller to proceed on with account-code transactions to send funds or informational data directly to another FIG. II: PhonExpress telephone or FIG. III: PhonExpress cellular telephone

METHOD OF USAGE OPTION [2] PhonExpress: by press in a {10} digit ‘PhonExpress telephone number' of choice and then press enter key on PhonExpress keypad keyboard or remote keypad used. Which intern transmits digital connection to another FIG. II: PhonExpress telephone or FIG. III: PhonExpress cellular telephone

### METHOD OF FIG. A1: [A] Account-Code key:

OPERATIONAL KEY FIG. A1: [A] Account-Code key:

FIG. II-FIG. VIII indicated by numbers FIG. A1: [A] Account-Code key: located above the number [2] key, in between PhonExpress letter FIG. A: [P] key and FIG. A2: [S] key. Which PhonExpress operations intern simultaneously activates choice for entry to electronic modes of account-code options.

METHOD OF USAGE by pressing letter [A] key and enter key on PhonExpress keypad, keyboard or remote keypad used. Activates electronic options entry of choices. For either Options [1] Amount: or Option [2] Tran-line: or Option [3] Direct-line:
PhonExpress LCD FIG. A12: A12a: or A12b: screen displays options to choose from

### OPTION [1] AMOUNT:

### OPTION [2] TRAN-LINE:

### OPTION [3] DIRECT-LINE:

METHOD OF USAGE: by pressing number keys indicating choice of option and then press enter key on PhonExpress keypad keyboard or remote keypad used.

METHOD OF OPTION [1] AMOUNT: Activates changes of usage with original number keys into PhonExpress electronic operations accountant numbers for entry of dollar/cent amounts for account-code transactions of either funds currency or credit. Of either PhonExpress keypad PhonExpress keyboard or PhonExpress Remote-pad changes account-code keypad into accountant keypad

METHOD OF USAGE OPTION [1] AMOUNT: by pressing number [1] key and Enter key on PhonExpress keypad PhonExpress keyboard, or PhonExpress Remote-pad.
PhonExpress LCD FIG. A12: A12a: or A12b: screen displays

### [Enter Amount]

METHOD OF USAGE by pressing number keys indicating of dollar and cents for either currency or credit and then press enter key on PhonExpress keypad PhonExpress keyboard, or PhonExpress Remote-pad used.
PhonExpress LCD FIG. A12: A12a: or A12b: screen displays

### [Any Corrections] PROCEED ON METHODS OF ANSWER KEYS

METHOD OF OPTION [2] TRAN-LINE: activates the ability to transfer account code transactions to another place, Transfer-line activates electronic entry for choice of options for either Options [1] Account: or Option [2] Code: indicated by their numbers
METHOD OF USAGE OPTION [2] TRAN-LINE: By pressing number [2] and then press enter key on PhonExpress keypad keyboard or remote keypad used.
PhonExpress LCD FIG. A12: A12a: or A12b: screen displays options to choose from

### OPTION [1] Account:

### OPTION [2] Code:

METHOD OPTION [1] Account: activates entry for an account number to make payment or send funds to another account. Enables for account transactions with either currency or credit.
METHOD OF USAGE: OPTION [1] Account: by pressing number [1] and enter key on PhonExpress device keypad, keyboard or remote keypad used.
PhonExpress LCD FIG. A12: A12a: or A12b: screen displays
[Enter Account number]
METHOD OF USAGE: by pressing number keys indicating Account number and enter key on PhonExpress keypad, keyboard or remote keypad used.
PhonExpress LCD FIG. A12: A12a: or A12b: screen displays

### [Any Corrections] PROCEED ON METHODS OF ANSWER KEYS

METHOD OF USAGE: OPTION [2] Code: activates entry for a code number to obtain informational data from or send informational data to another place. Enables code transaction of informational data
METHOD OF USAGE OPTION [2] Code: by pressing number [2] and enter key on PhonExpress device keypad, keyboard or remote keypad used.
PhonExpress LCD FIG. A12: A12a: or A12b: screen displays
[Enter Code number]
METHOD OF USAGE: by pressing number and letter keys indicating of ‘Code number’ and then enter key on PhonExpress keypad, keyboard or remote keypad used. Enables process of obtaining informational data of document, records, any informational data
PhonExpress LCD FIG. A12: A12a: or A12b: screen displays

### [Any Corrections] PROCEED ON METHODS OF ANSWER KEYS

METHOD OF USAGE: OPTION [3] DIRECT-LINE: activates the ability for direct-line to either FIG. IX: P.E.A.C.E. Converter: or another FIG. II-FIG. III: PhonExpress telephones, cellular telephones. Enables process of choice for account-code transactions of transferring or sending funds or informational data to another place indicated by entry of numbers and letters of choice. Enables choices of electronic modes of options indicated by their numbers
METHOD OF USAGE: OPTION [3] DIRECT-LINE: by pressing number [3] key and enter key on PhonExpress keypad, keyboard or remote keypad used.
PhonExpress LCD FIG. A12: A12a: or A12b: screen displays options to choose from

### OPTION [1] Call-dial: OPTION [2] PhonExpress:

METHOD OF USAGE: OPTION [1] Call-dial: activates entry of ‘P.E.A.C.E. Code’ 15-digits' [1-digit country, 2-digit state, 3-digit area code, 4-digit building code, 5-digit zip code] which enables for transmitting with a direct-line to any FIG. IX P.E.A.C.E. Converter that is connected to business or companies computerized resource server. Enabling for electronic digital shopping, proceeds on with account-code transactions
METHOD OF USAGE: OPTION [1] Call-dial: by pressing number [1] key and enter key on PhonExpress keypad, keyboard or remote keypad used.
PhonExpress LCD FIG. A12: A12a: or A12b: screen displays
[Enter 15-digits] P.E.A.C.E. Code
METHOD OF USAGE: by pressing number keys indicating ‘15-digits of P.E.A.C.E. Code’ and enter key on PhonExpress keypad, keyboard or remote keypad used.
METHOD OF USAGE: OPTION [2] PhonExpress: activates entry of ‘10-digit’ “PhonExpress telephone number” to be entered in, which enables caller to proceed on with account-code transactions to send funds or informational data directly to another FIG. II: PhonExpress telephone, or FIG. III: PhonExpress cellular telephone, and FIG. II-A PhonExpress telephone adapters
METHOD OF USAGE: OPTION [2] PhonExpress: by pressing number [2] key and enter key on PhonExpress keypad, keyboard or remote keypad used.
PhonExpress LCD FIG. A12: A12a: or A12b: screen displays [Enter 10-digits] PhonExpress telephone number
METHOD OF USAGE: by pressing number keys indicating another PhonExpress telephone number and enter key on PhonExpress keypad, keyboard or remote keypad used.

### AFTER ENTRY OF EITHER DIGITS

PhonExpress LCD FIG. A12: A12a: or A12b: screen displays

### [Any Corrections] PROCEED ON METHODS OF ANSWER KEYS

METHOD OF USAGE: OPERATIONAL KEY FIG. A2: [S] System key: activates process of finishing account-code transactions, either send, transfer funds or informational data to receive, deliver, or printout located above the number [3] key, at the top, right side of PhonExpress letter FIG. A1: [A] key: Intern PhonExpress operations simultaneously activates choice for entry to electronic modes of account-code options to finish the process of account-code transactions.
METHOD OF USAGE: FIG. A2: [S] System key: by pressing letter [S] key and then enter key on PhonExpress keypad, keyboard or remote keypad used.

FIG. II-FIG. VIII Activates electronic entry for choice of options, indicated by their numbers for either Options [1] PEACE-line: or Option [2] Tran-line: or Option [3] Direct-line: or [4] Ship-line:

PhonExpress LCD FIG. A12: A12a: or A12b: screen displays Options to choose from

### OPTION [1] PEACE-LINE:

### OPTION [2] TRAN-LINE:

### OPTION [3] PASS-LINE:

### OPTION [4] SHIP-LINE:

METHOD OF CHOOSING OPTION [1] PEACE-LINE: Activates electronic entry for choice of either Account-Code or Code-Account Portals or Slip-ports for accessing of Each Five computerized account options. Enables for account-code transaction of funds or code-account transfer informational data into another account of choice. Currency with currency or Credit with credit: process of transferring informational data into other computerized accounts. For either Options [1] Portals: or Option [2] Slot-ports: indicated by their numbers
METHOD OF USAGE: OPTION [1] PEACE-LINE: By pressing number [1] key and enter key on PhonExpress device keypad, keyboard or remote keypad used.
PhonExpress LCD FIG. A12: A12a: or A12b: screen displays options to choose from

### OPTION [1] Portals:

### OPTION [2] Slip-ports:

METHOD OF OPTION [1] Portals: EACH choice Portal or Slip-port activates transmittal entry to FIG. X: P.E.A.C.E. base unit electronic account-code terminals of choice. For usage any account-code transactions of funds or informational data
METHOD OF USAGE OPTION [1] Portals: by pressing number [1] key and enter key on PhonExpress device keypad, keyboard or remote keypad using.
PhonExpress FIG. A12: A12a: or A12b: LCD screen displays Options for entry to Portals indicated by their numbers:

### OPTION [1] FIG. B: Financial-line:

### OPTION [2] FIG. C: Credit-line:

### OPTION [3] FIG. G: Security-line:

### OPTION [4] FIG. H: Consumers-line:

METHOD OF USAGE: Portal FIG. B: [1] Financial-line: by pressing number [1] key and enter key on PhonExpress device keypad, keyboard or remote keypad used. For Account-transactions of currency
METHOD OF USAGE: Portal FIG. C: [2] Credit-line: by pressing number [2] key and enter key on PhonExpress device keypad, keyboard or remote keypad used. For Credit Account-transactions wherever Credit is established.
METHOD OF USAGE: Portal FIG. G: [3] Security-line: by pressing number [3] key and enter key on PhonExpress device keypad, keyboard or remote keypad used. For Code-transactions obtaining any Informational data of documents, records etc
METHOD OF USAGE: Portal FIG. H: [4] Consumers-line: by pressing number [4] key and enter key on PhonExpress device keypad, keyboard or remote keypad used. For Code-transactions electronic digital Shopping anywhere day or night Worldwide.
METHOD OF USAGE: OPTION [2] Slip-ports: Activates entryway of choice to access either one of the Slip-ports indicated by their numbers. Each choice of Account-Code Slip-ports activates entryway to choice of five computerized digital account options.
METHOD OF USAGE: OPTION [2] Slip-ports: by pressing number [2] key and then enter key on PhonExpress device keypad, keyboard or remote keypad used.
PhonExpress LCD FIG. A12: A12a: or A12b: screen displays options to choose from

### OPTION [5] FIG. D: Reserve-line:

### OPTION [6] FIG. I: Express-line:

### OPTION [7] FIG. E: IDH-line:

### OPTION [8] FIG. J: MDH-line:

METHOD OF USAGE: Slip-port FIG. I-I SP La: OPTION [5] FIG. D: Reserve-line: by pressing number [5] key and enter key on PhonExpress device keypad, keyboard or remote keypad used. For usage of computerized digital accounts for funds of currency or in-store credit or credit issued.
METHOD OF USAGE Slip-port FIG. I-I SP La: OPTION [6] FIG. D: Express-line: by pressing number [6] key and enter key on PhonExpress device keypad, keyboard or remote keypad used. For usage of computerized digital accounts for funds of currency or in-store credit or PhonExpress minutes
METHOD OF USAGE Slip-port FIG. I-I SP Ra: OPTION [7] FIG. E: IDH-line: by pressing number [7] key and enter key on PhonExpress device keypad, keyboard or remote keypad used. For any display of Cardholder's Identification, history background checks.
METHOD OF USAGE Slip-port FIG. I-I SP Rb: OPTION [8] FIG. J: MDH-line: by pressing number [8] key and enter key on PhonExpress device keypad, keyboard or remote keypad used. For any display of Cardholder's Medical problems, Medication usage and Medical records

### SEE METHODS OF FIG. I-I SP: SLIP-PORTS FIVE DIGITAL ACCOUNT-CODE OPTIONS

METHOD OF USAGE: OPTION [2] TRAN-LINE: Activates the ability to transfer any funds into another account enables for bill paying. Or ability to transfer document of informational data. Transfer-line activates electronic entry for choice of options for either Option [1] Account: or Option [2] Code: indicated by their numbers
METHOD OF USAGE: by pressing number [2] and enter key on PhonExpress keypad, keyboard or remote keypad used.
PhonExpress LCD FIG. A12: A12a: or A12b: screen displays options to choose from

### OPTION [1] Account:

### OPTION [2] Code:

METHOD OF USAGE: IS AFTER ENTRY OF EITHER PORTAL FIG. I-FPa: FIG. B: [1] Financial-line: or FIG. I-FPb: FIG. C: [2] Credit-line: Enables Transfer of either funds of currency or credit for account transactions
METHOD OF USAGE OPTION [1] Account: activates entry for choice of an Account number, for payment on any billing account entered in.

### OR

### METHOD OF USAGE: IS AFTER ENTRY OF EITHER PORTAL [3] Security-line:

METHOD OF USAGE: OPTION [2] Code: activates entry for choice of a Code numbers, for obtaining choice any informational data, with usage of numbers and letters entered in indicating any informational data of any documents, records enables code transaction.
METHOD OF USAGE: by pressing numbers or/and letter indicating Code numbers indicating informational data and then press enter key on PhonExpress keypad, keyboard or remote keypad used.
PhonExpress LCD FIG. A12: A12a: or A12b: screen displays automatically

### [Processing]

Intern PhonExpress distributes out receipt of code transaction process is completed.

UNLESS PhonExpress might indicate in-order to obtain some informational data is only by entry of security code or if cost. PhonExpress enables entry of security code or to proceed on with methods of either Portal for funds of currency or credit. Enables the Transfer of informational data of number enter in indicating code of document, transmits informational data to another PhonExpress device.

### IF ‘SECURITY CODE’ NEEDED

PhonExpress LCD FIG. A12: A12a: or A12b: screen displays
[Enter Security code]
METHOD OF USAGE by pressing ‘number keys’ indicating of an ‘Security code number’ and then press enter key on PhonExpress keypad, keyboard or remote keypad used.

### Or IF COST

PhonExpress LCD FIG. A12: A12a: or A12b: screen displays
[Amount of cost] PROCEED ON WITH METHOD OF USAGE ACCOUNT PORTALS

### OR METHOD OF USAGE IS AFTER ENTRY OF EITHER PORTAL FIG. I-BPb: FIG. H: [4] Consumers-line:

METHOD OF USAGE OPTION [2] Code: activates entry for choice of a Code numbers, for electronic digital shopping. PhonExpress indicates choice of number indicting departments, then numbers indicating products and prices, then indicates total amount which then proceed with methods of account transactions

### SEE METHODS OF SHOPPING

METHOD OF USAGE: OPTION [3] PASS-LINE: enables usage to either send funds or informational data or receive incoming funds or informational data. Activates a choice of electronic modes of options indicated by their numbers Option [1] Send: or Option [2] Receive:
METHOD OF USAGE: by pressing number [3] key and press enter key on PhonExpress keypad, keyboard or remote keypad used.
PhonExpress LCD FIG. A12: A12a: or A12b: screen displays options to choose from

### OPTION [1] Send:

### OPTION [2] Receive:

METHOD OF USAGE: OPTION [1] Send: activates the process of sending the obtained account-code transactions of informational data, or funds of currency or credit will be sent to the account-code entered thereof.
METHOD OF USAGE: OPTION [1] Send: by pressing number [1] key and enter key on PhonExpress keypad, keyboard or remote keypad used.
PhonExpress LCD FIG. A12: A12a: or A12b: screen displays

### [Processing]

Intern PhonExpress distributes out receipt of code transaction process is completed.

### OR

METHOD OF USAGE: OPTION [2] Receive: activate the process of receiving any incoming informational data or funds of currency or credit of account-code transactions
METHOD OF USAGE: OPTION [2] Receive: by pressing number [2] key and enter key on PhonExpress keypad, keyboard or remote keypad used.
PhonExpress LCD FIG. A12: A12a: or A12b: screen displays

### [Processing]

Intern PhonExpress distributes out receipt of code transaction process is completed.
METHOD OF USAGE: OPTION [4] SHIP-LINE: activates ability to either deliver to address entered in or enables for a print-out from printer that's connected. Enables displaying choices of electronic modes of options indicated by their numbers Option [1] Delivery: or Option [2] Print-out:
METHOD OF USAGE: OPTION [4] SHIP-LINE: by pressing number [4] key and enter key on PhonExpress keypad, keyboard or remote keypad used.
PhonExpress LCD A12, A12a or A12b screen displays options to choose from

### OPTION [1] Delivery:

### OPTION [2] Print-out:

METHOD OF USAGE: OPTION [1] Delivery: activates the process of finishing account-code transactions to any address enter in. sending funds of either currency or credit, or any informational data. Transmitting to another address that is entered in or/and to address for delivery of product or informational data, plus to send any funds to direct line of FIG. IX: P.E.A.C.E. converter connected to any business or companies computerized resource server. That enables delivery.
METHOD OF USAGE: OPTION [1] Delivery: by pressing number [1] key and enter key on PhonExpress keypad, keyboard or remote keypad used.
PhonExpress LCD FIG. A12: A12a: or A12b: screen displays
[Enter address]
METHOD OF USAGE: by pressing ‘numbers’ or/and ‘letters’ on the keys and then press enter on PhonExpress keypad, keyboard or remote keypad used.
PhonExpress LCD FIG. A12: A12a: or A12b: screen displays

### [Any Corrections] SEE METHOD OF ANSWER KEYS

### AFTER ANSWER

PhonExpress LCD FIG. A12: A12a: or A12b: screen displays

### [Processing]

Intern PhonExpress distributes out receipt of code transaction process is completed.

### OR

METHOD OF USAGE: OPTION [2] Print-out: account-code transactions of digital informational data received from any printer that is attached to the PhonExpress device in use. By entry engages printer into operations of printing informational data, documents, records, entry from any P.E.A.C.E. code entry of address for delivery from any entry of code numbers of product or informational data or funds of currency
METHOD OF USAGE: OPTION [2] Print-out: by pressing number [2] key and enter key on PhonExpress keypad, keyboard or remote keypad used.
PhonExpress LCD FIG. A12: A12a: or A12b: screen displays

### [Processing]

Intern PhonExpress distributes out receipt of code transaction process is completed.
Then distributes out a Print-out from printer attached.

### METHOD OF ACTIVATION FIG. A3: SLOT-PORT: VIEWED IN DRAWINGS:

### SPECIFICATION OF DESCRIPTION DRAWINGS AND FIGURES

### P.E.A.C.E. KEYS ELECTRONIC METHOD OF PROCESS

FIG. II-FIG. VIII ACTIVATION OF FIG. A3: SLOT-PORT: used for operations to obtain electronic digital transmission of FIG. I-F/FIG. I-B PhonExpress system card account-code Portals or/and FIG. I-I-L/FIG. I-I-R PhonExpress slip-card Slip-port numbers-letters. That engages entry to terminals into relaying digital transmission. METHOD OF USAGE FIG. A3: SLOT-PORT: by sliding of either one of the Four main account-code Portals on FIG. I PhonExpress system card or /and usage of FIG. I PhonExpress system card open/close keys extends usage of either one of the Four concealed Slip-ports of FIG. I-I PhonExpress slip-card. FIG. I One Portal or FIG. I-I One Slip-port through either of PhonExpress device FIG. A3: Slot-port, located in drawings FIG. II-FIG. VIII.

### SEE IN DRAWINGS FIG. II-FIG. VIII FOR LOCATION OF [A3] SLOT-PORT:

FIG. II: PhonExpress telephones: FIG. A3: Slot-port: is located on right side of number keypad exceeds to top to bottom of PhonExpress telephone. PhonExpress desk telephones
FIG. III: PhonExpress telephone adapters: FIG. A3: Slot-port: is located on right side of number keypad exceeds up and down top to bottom of PhonExpress telephone adapters.
FIG. III: PhonExpress telephone adapters: for original telephone, PhonExpress system card slot-port is located on the right side of adapter.
FIG. IV: PhonExpress cellular telephone: FIG. A3: Slot-port: is located at top, above display screen, exceeds from left to right. On (original) PhonExpress cellular telephone,
Except for (a Flip) PhonExpress cellular telephone slot-port is located on inside, at top, above display screen, exceeds from left to right.
FIG. V: PhonExpress Store adapter: FIG. A3: Slot-port: is located on right side of number keypad exceeds up and down top to bottom
FIG. VI: A-F PhonExpress various adapters: FIG. A3: Slot-port: is located on right side of number keypad exceeds up and down top to bottom
FIG. VII: PhonExpress computerized keyboard: FIG. A3: Slot-port: is located on right-side of the keyboard, exceeding up and down.
FIG. VIII PhonExpress TV remote: PhonExpress system card slot-port located toward front-end of remote.
FIG. VI: A-F PhonExpress various adapters for electronic entryways of schools, collages, government offices, airports, police departments, stores, convenient stores, pharmacies, at the pumps, in pop/food machines, public buses, taxi cabs, transportation. Location of the PhonExpress system card slot-port is on the right side of PhonExpress adapters.

### 1. METHOD OF P.E.A.C.E. KEYS:

METHOD OF USAGE: FIG. A4: ENTER: key is by pressing on key that reads ‘ENTER’ AFTER EACH ENTRY of numbers' or/and ‘letters’ for account-code or code-account transactions. Numbers and Letters for activation of operations: currency, credit, obtaining data of informational documents, and inventory for electronic shipping, immediate purchase, and delivery, that transmits into digital signals for entry account-code and/or code-account transactions

METHOD OF USAGE: FIG. A5: SAVE: key is by pressing on key that reads ‘SAVE’ only used for choice in middle of a process of shopping or paying for items and receive an important call press FIG. A5: ‘SAVE’ key, which enables for account-code and/or code-account transaction to stop. Everything for—Min. or from changing areas for shopping activates operations of obtaining and freezing any account-code transactions puts everything on hold and saves data for up to seven minutes if not return to account-code transaction then deletes transaction

METHOD OF USAGE: FIG. A6: C/C/C key: by pressing on the key that reads THREE—Cs: ‘C/C/C’ and enter key on PhonExpress device keypad, keyboard or remote keypad used. Activates choice of electronic modes of options PhonExpress LCD FIG. A12: A12a: or A12b: screen displays options to choose from
OPTION [1] Cancel: Cancel any account-code or/and code-account transaction
OPTION [2] Copy: Copy's any account-code or/and code-account transactions then Options for repeating ‘1 daily’ ‘2 weekly’ ‘3 biweekly’ ‘4 monthly’
OPTION [3] Change: Change any account-code transactions to another place to shop
METHOD OF USAGE: FIG. A7: PhonExpress key: enables quick usage of [6] Express-line: electronic computerized account Option [3] Express-minutes: for usage of PhonExpress calls or minutes on any account-code transactions

### FIG. A8: FIG. A9: ANY CORRECTIONS

METHOD OF USAGE: FIG. A8: STAR KEY: “YES” if answer “Yes” by pressing key FIG. A8: [*] Star key: then enter key. Answered “YES” PhonExpress continues,
METHOD OF USAGE: FIG. A9: POUND KEY: “NO” if answer “No” by pressing key FIG. A9: [#] Pound key: choice of either refusal of item, or Finish obtaining items. Answered “NO” PhonExpress either removes item or engages into total amount
METHOD OF USAGE: FIG. A10: RECEIPT DISTRIBUTION: is distributed out from the bottom of either PhonExpress telephone, PhonExpress telephone adapter. For receipts with PhonExpress cellular telephone, PhonExpress computerized keyboard is by printer attached. Or by P.E.A.C.E. monthly statements PhonExpress Various Adapters and PhonExpress TV remote has to be by P.E.A.C.E. monthly statements.

### METHOD OF: DESCRIPTION OF LIGHTS:

Flash white on the PhonExpress telephone when call comes in
Flash green when funds are coming in, Very helpful for hearing impaired, deaf
Enables people to know when able to receive funds that is sent
METHOD OF USAGE: FIG. A11: ‘LIGHTS’ CHANGES COLORS FIG. A11b: ‘WHITE—incoming PhonExpress call’, FIG. A11c: ‘BLUE—incoming informational data’, and FIG. A11d: ‘GREEN—incoming funds’
METHOD OF USAGE: FIG. A11a: ‘LIGHTS’ CHANGES COLORS FIG. A11b: ‘WHITE—incoming PhonExpress call’, FIG. A11c: ‘BLUE—incoming informational data’, and FIG. A11d: ‘GREEN—incoming funds’
METHOD OF USAGE: FIG. A12: LCD SCREEN, FIG. A12: COMPUTER SCREEN, FIG. A12: TV SCREEN: displays choices of P.E.A.C.E. System's PhonExpress electronic computerized operational modes of options, displaying departments, products and prices.
METHOD OF USAGE: FIG. A13:—FIG. A13a: ‘SPEAKERS’ FOR REPEATED BELL-TONES: repeated ‘2-ring’ tones ‘incoming PhonExpress call’, repeated ‘5-ring’ tones ‘incoming informational data’ and repeated ‘7-ring’ tones ‘incoming funds’: Each ‘ring-tone’ has its ‘own significant ring’ of tone
FIG. A14: P.E.A.C.E. EMBLEM represents PhonExpress Account-Code Electronics
METHOD OF USAGE: FIG. A15: FIG. A15a: FIG. A15b: and FIG. A15c: ‘VIBRATION’ DEVICES: ‘Vibrates different speeds’ of vibrations ‘soft’, ‘medium’ and ‘hard’ For PhonExpress ‘Vibrations soft for incoming calls’, ‘Vibrates medium for incoming funds’ of currency or credit or/and ‘Vibrates hard for incoming informational data’

METHOD OF USAGE: FIG. A16: FIG. A16a: ‘VOICE SYNCHRONIZER’ COMMUNICATION DEVICE: obtains ‘voices and translates sounds’ of voice communication into digital signals of data, enables digital transmission

### P.E.A.C.E.SHOPPING PART PS-I

### METHOD OF SHOPPING DIRECTLY TO BUSINESS OR COMPANY INVENTORY

P.E.A.C.E. system's usage of FIG. II—PhonExpress telephones FIG. III PhonExpress telephone adapters FIG. IV PhonExpress cellular telephones FIG. VII PhonExpress computerized keyboard, FIG. VIII PhonExpress TV remote keypad. Usage of one FIG. I PhonExpress system card enables electronic shopping anytime day or night anywhere worldwide directly through direct-line services of FIG. IX P.E.A.C.E. system converter that connected to business or companies computerized resource servers. That is activated through usage of FIG. X P.E.A.C.E. system base unit.

Shopping at any business or company “without leaving” residence or office without speaking to anyone or computerized voice. Immediately paying for products and then after have merchandise delivered to any address entered. FIG. IX P.E.A.C.E. system converter (Electronic Point of Sale System) communicates electronically by digital signals to computerized Network which transmits digital signals of Inventory and Price sales, input from remote terminals located on computerized resource server of business or company and computerized register. Retrieving data of codes for identification of merchandise with updated Inventory, Sales of merchandise.

### ELECTRONICALLY SHOPPING DIRECTLY TO BUSINESS OR COMPANY INVENTORY

(Direct electronic shopping through business or company's data of inventory of merchandize and prices)

METHOD OF USAGE P.E.A.C.E. shopping is electronic purchasing of merchandise by usage of retrieving data codes, and codes of prices.

METHOD: By activating entry of PhonExpress [P] PhonExpress key by pressing on letter [P] key and then enter key on either PhonExpress keypad, PhonExpress keyboard or PhonExpress remote keypad used.
PhonExpress A12, A12a or A12b displays on Screen used, a choice of Options.

### Option [1] PEACE-line

### Option [2] TRAN-line

### Option [3] DIRECT-line

CHOICE OF METHOD: OPTION 3. DIRECT-LINE: activates the ability for direct-line to either FIG. IX PEACE converter or anther FIG. II-FIG. VI PhonExpress—telephones. Enables process of choice for account-code transactions of transferring or sending funds or informational data to another place indicated by entry of numbers and letters of choice. Enables choices of electronic modes of options indicated by their numbers

### METHOD OF USAGE P.E.A.C.E. SHOPPING: OPTION 3: DIRECT-LINE: PART PS-II

By pressing number [3] key and enter key on PhonExpress keypad, keyboard or remote keypad used.
PhonExpress LCD FIG. A12: A12a: or A12b: screen displays options to choose from

### OPTION [1] Call-dial:

### OPTION [2] PhonExpress:

METHOD: OPTION 1: Call-dial: activates entry of the “Five Step” PEACE code: ‘15-digits’ {[1]-digit country, [2]-digit state, [3]-digit area code, [4]-digit building code, [5]-digit zip code} enables for transmitting with a direct-line to any FIG. IX: P.E.A.C.E. converter that is connected to business or companies computerized resource server. Enabling for electronic digital shopping, proceeds on with account-code transactions
METHOD OPTION 1: Call-dial: operates through: FIG. II: PhonExpress telephone FIG. III: PhonExpress telephone adapter FIG. IV: PhonExpress cellular telephone FIG. VII: PhonExpress computerized keyboard or FIG. VIII: PhonExpress remote keypad
METHOD OF USAGE OPTION [1] Call-dial: by pressing number [1] key and enter key on PhonExpress keypad, keyboard or remote keypad used.
PhonExpress LCD A12, A12a or A12b screen displays
[Enter 15-digits] P.E.A.C.E. Code
METHOD OF USAGE OPTION [1] Call-dial by pressing number keys indicating ‘15-digits’ of ‘PEACE code’ and enter key on PhonExpress keypad, keyboard or remote keypad used.
METHOD OF PROCESS USAGE OF: OPTION [1] Call-dial: By entering-in ‘15-digit—PEACE code’. Activates through FIG. X: P.E.A.C.E. Base Unit operations of direct-line of electronically transmits digital signal of codes through FIG. IX: P.E.A.C.E. Converter that is connected to Business or Company's resource data of (Inventory and Prices) server. Engages into operations: Recognizing, Translating codes, relaying informational Code data directly back to either of ‘FIG. II-FIG. VIII’ PhonExpress device being used. FIG. A12: A12a: or A12b: LCD screen used. Enables choices of items directly through FIG. IX: P.E.A.C.E. System's Converter connected to business or company's computerized (Data of Inventory and Prices) resource server. Simultaneous engages into transmitting digital signals through ‘FIG. II-FIG. IV’ PhonExpress device used. Through Electronic operations of entry Portal terminals of FIG. X: P.E.A.C.E. system Base Unit for usage of account transactions processing for immediate payment to from business or company's account resource server (for purchased items) through the ‘FIG. II-FIG. IV’ PhonExpress device used.

### METHOD OF USAGE P.E.A.C.E. SHOPPING: PART PS-III

METHOD OF PAYING FOR PURCHASED ITEMS (shopper) electronically pays for items of shopping)

METHOD OF USAGE: is by sliding FIG. I-F PhonExpress system card either Portal A [1] Financial-line: or B [2] Credit-line: through same PhonExpress device [A3] Slot-port used. Activates operations of FIG. X P.E.A.C.E. system Base Unit for entry of main account-code terminal. electronically engages into operations for (shopper) entry of route number, and enter key then account number (of either currency or credit) and enter key, then entry of security code number (of account number that pertains to route number) and enter key on PhonExpress telephone keypad. This activates that account that is entered thereof.

FIG. II-FIG. VIII PhonExpress device indicated by numbers activating using key A1: [A] Account-Code key: located above the number [2] key, in between PhonExpress letter [P] key and [S] key on PhonExpress keypad, keyboard or remote keypad used.

PROCEED ON OPERATIONAL KEY A1 [A] Account-Code key. That enables caller (shopper) to enter ‘Options of Choices.’ Then caller (shopper) enters number [1] amount key. PhonExpress system operations of “Interchanging account-code keypad system” into “Accountant keypad system” with usage of ENIAC electronic calculator. That enables (shopper) to enter ‘Dollar and Cent’ amounts. By pressing on the numbers “Entering the number of amount” “Using number keys” and then press on “enter key” that's on PhonExpress telephone keypad. Intern PhonExpress operations simultaneously activates that amount of choice entered to electronic modes of account-code options.

METHOD OF USAGE by pressing letter [A] key and enter key on PhonExpress keypad, keyboard or remote keypad used. Activates electronic options entry of choices. For either Options [1] Amount: or Option [2] Tran-line: or Option [3] Direct-line:
PhonExpress LCD A12, A12a or A12b screen displays options to choose from

### OPTION [1] AMOUNT:

### OPTION [2] TRAN-LINE:

### OPTION [3] DIRECT-LINE:

METHOD OF USAGE: by pressing number keys “‘indicating choice’ of option” and then press ‘Enter key’ on PhonExpress keypad keyboard or remote keypad used.
METHOD OF PROCESS OPTION 1: AMOUNT Activates changes of usage with original number keys into PhonExpress electronic operations accountant numbers for entry of dollar/cent amounts for account-code transactions of either funds currency or credit. Of either PhonExpress keypad PhonExpress keyboard or PhonExpress Remote-pad changes account-code keypad into accountant keypad

### METHOD OF USAGE P.E.A.C.E. SHOPPING: PART PS-IV

METHOD OF USAGE OPTION 1: AMOUNT by pressing number 1 key and Enter key on PhonExpress keypad PhonExpress keyboard, or PhonExpress Remote-pad.
PhonExpress LCD A12, A12a or A12b screen displays

### [Enter Amount]

METHOD OF AMOUNT ENTRY by pressing number keys indicating of dollar and cents for either currency or credit and then press enter key on PhonExpress keypad PhonExpress keyboard, or PhonExpress Remote-pad used.
PhonExpress LCD A12, A12a or A12b screen displays

### [Any Corrections]

### PROCESS FOR ANY CORRECTION PROCEED ON METHODS OF ANSWER KEYS

METHOD OF ANSWERS answering by pressing on either then press enter key on either PhonExpress keypad, keyboard, remote pad/using.
A8 “YES” if answer “YES” press A8 [*] Star key and then enter key.
A9 “NO” if answer “NO” press A9 [#] Pound key and then enter key.
IF ANSWER YES: enables to reenter amount of dollar and cents by pressing number keys indicating of dollar and cents for either currency or credit and then press enter key on PhonExpress keypad PhonExpress keyboard, or PhonExpress Remote-pad used.
IF ANSWER NO: Enables the Process of account transaction of transfer funds to one account to another.

FIG. X P.E.A.C.E. system base unit accesses amount of funds electronically transfers funds from account numbered entered in (by usage of FIG. I PhonExpress system card) into FIG. IX P.E.A.C.E. converter which electronically simultaneously communicates and electronically transfers funds to business or company's computerized account resource server. (At place of shopping). Along with FIG. IX P.E.A.C.E. converter engages with business or company's computerized data of inventory engages into operations for set up delivery of paid merchandise.

Payment is made by activation of PhonExpress electronic keys through FIG. X P.E.A.C.E. system base unit which electronically transfers funds to place of FIG. IX P.E.A.C.E. converter operations which is connected to business or company's computerized resource server of inventory and prices. And simultaneously corresponds the transfer of funds electronically with business or company's account resource server

### METHOD OF USAGE P.E.A.C.E. SHOPPING: PART PS-V

### PROCESS OF METHOD DELIVERY FOR PURCHASED ITEMS

### PROCEED ON OPERATIONAL KEY A2 [S] System key

### METHOD OF OPERATIONAL KEY A2: [S] System key:

KEY A2: [S] System key activates process of finishing account-code transactions, either send, transfer funds or informational data to receive, deliver, or printout located above the number 3 key, at the top, right side of PhonExpress letter [A] key. Intern PhonExpress operations simultaneously activates choice for entry to electronic modes of account-code options to finish the process of account-code transactions.

(Shopper) ACTIVATION A2 [S] system key, which PhonExpress device used changes operational modes and through electronic modes of options.
METHOD OF USAGE by pressing letter S key and then enter key on PhonExpress keypad, keyboard or remote keypad used.

FIG. II-FIG. VIII Activates electronic entry for choice of options, indicated by their numbers for either Options 1 PEACE-line or Option 2 Tran-line or Option 3 Direct-line or [4] Ship-line

PhonExpress LCD A12, A12a or A12b screen displays options to choose from

### OPTION 1 PEACE-LINE

### OPTION 2 TRAN-LINE

### OPTION 3 PASS-LINE

### OPTION 4 SHIP-LINE

METHOD OF USAGE: OPTIONS by pressing on number key indicating choice of option and then press enter key on PhonExpress keypad keyboard or remote keypad used.
PROCEED ON WITH METHOD OF OPTION 4: SHIP-LINE=activates ability to either deliver to address entered in or enables for a print-out from printer that's connected. Enables displaying choices of electronic modes of options indicated by their numbers Option 1 Delivery or Option 2 Print-out

### METHOD OF USAGE P.E.A.C.E. SHOPPING: PART PS-VI

METHOD OF USAGE OPTION 4: SHIP-LINE: by pressing number 4 key and enter key on PhonExpress keypad, keyboard or remote keypad used.
PhonExpress LCD A12, A12a or A12b screen displays options to choose from

### OPTION 1 Delivery

### OPTION 2 Print-out

METHOD OF OPTION 1 Delivery—activates the process of finishing account-code transactions to any address enter in. sending funds of either currency or credit, or any informational data. Transmitting to another address that is entered in or/and to address for delivery of product or informational data, plus to send any funds to direct line of FIG. IX: P.E.A.C.E. converter connected to any business or companies computerized resource server. This enables delivery.
METHOD OF USAGE: OPTION 1: Delivery: by pressing number [1] key and enter key on PhonExpress keypad, keyboard or remote keypad used.
PhonExpress LCD FIG. A12: A12a: or A12b: screen displays
[Enter address]
METHOD OF USAGE by pressing number or/and letter keys and then press enter on PhonExpress keypad, keyboard or remote keypad used.
PhonExpress LCD FIG. A12: A12a: or A12b: screen displays

### [Any Corrections]

### PROCESS FOR ANY CORRECTION

### PROCEED ON METHODS OF ANSWER KEYS

### METHOD OF USAGE P.E.A.C.E. SHOPPING: PART PS-VII

METHOD OF ANSWERS answering by pressing on either then press enter key on either PhonExpress keypad, keyboard, remote pad/using.
A8 “YES” if answer “YES” press A8 [*] Star key and then enter key.
A9 “NO” if answer “NO” press A9 [#] Pound key and then enter key.
IF ANSWER YES: Enables ability to reenter address
IF ANSWER NO: then no change is needed then process continues

### AFTER ANSWER

PhonExpress LCD A12, A12a or A12b screen displays
[Processing] for delivery to address entered in.
Intern PhonExpress distributes out receipt of account-code transactions processing is completed.
PhonExpress Transmits digital signals to FIG. IX: P.E.A.C.E. converter electronically engages and transmits digital signals of address entered. Which FIG. IX: P.E.A.C.E. converter relays digital signals to computerized resource server of place of business or company. Intern FIG. IX: P.E.A.C.E. converter engages in place of business or company's computer automatically obtains address, engages into operations with account transactions of payment, obtains merchandise and engages in delivery. Which then FIG. IX: P.E.A.C.E. system converter transmits signals simultaneously to FIG. X: P.E.A.C.E. system base unit and transmits digital signals to PhonExpress device used. Which receipts are distributed out simultaneously to both account resource systems and either business or company's inventory resource system and PhonExpress device distributes receipt and delivery time.

### METHOD OF USAGE P.E.A.C.E. SHOPPING: PART PS-VIII

### METHOD OF USAGE: FIG. IX: P.E.A.C.E CONVERTER

FIG. IX P.E.A.C.E. CODE FOR CONVERTER=15-digits is 1-digit for Country, 2-digits for State, 3-digits for Area code, 4 digit of building code number and 5-digits for zip code number. Which electronically transmits directly and activates FIG. IX P.E.A.C.E. converter, which is connected to business or company's computerized data resource server (inventory of merchandise and prices)

FIG. IX P.E.A.C.E. system Converter is an electronic digital transmission of information of data. Of which FIG. IX P.E.A.C.E. system Converter is electronically connected with computerized resource server of business or companies' computer data banks of inventory data records. Engages into operations of electronic communications with business or companies computer's inventory of the item/items numbers and codes, of the merchandise that is in stock and the pricing of the item/items.

FIG. IX P.E.A.C.E. system Converter usage of electronically retrieving item/items of data and recognizing by usage of binary codes, of (UPC numbers, product numbers and codes) electronically translating of item/items name/names from business or companies computer inventory. Which establishes what the item is, and prices of items. Which FIG. IX P.E.A.C.E. system Converter electronically retrieves and analyzes information data of item/items translates data of item/items into digital signals transmitting electronically back to PhonExpress telephones.

FIG. II-FIG. VIII PhonExpress devices used translates digital data, then displays name and price of item/items. Which caller then decides with the data information of item/items, then caller chooses which item/items to purchase. With usage of FIG. II-FIG. VIII PhonExpress device used A12, A12a or A12b LCD screen display of options and by pressing on number on keypad for the item caller wants to purchase.

Which then PhonExpress device used A12, A12a or A12b LCD screen displays amount of item/items purchased, enabling caller to purchase or decline item/items.

Then with operations of P.E.A.C.E. systems, FIG. I PhonExpress system card and usage of P.E.A.C.E. system's Portals of either B [1] Financial-line for account with currency or C [2] Credit-line for account with credit wherever credit is established. And usage of PhonExpress keys A1 [A] Account-Code key of option of [1] amount. Caller entering thereof.

### METHOD OF USAGE P.E.A.C.E. SHOPPING: PART PS-IX

FIG. II-FIG. VIII PhonExpress device used enables caller to engage with electronic digital communications simultaneously with FIG. X P.E.A.C.E. system base unit for operations of an account transaction with caller's account. Which FIG. X P.E.A.C.E. system's base unit electronically engages with account system of computerized server, of which caller entered in, with usage of FIG. II-FIG. VIII PhonExpress device accountant keypad keyboard or remote keypad used.

P.E.A.C.E. system's FIG. I PhonExpress system card enables caller to engage usage of activation, accessibility of the account entered in thereof. (By sliding of either Portal B [1] Financial-line or [2] C Credit-line with either currency or credit wherever credit is established. Or by usage of removal of direct funds off of FIG. I-1 PhonExpress slip-card Slip-port [5] Reserve-line's Five electronic computerized options of digital accounts

Which FIG. X P.E.A.C.E. system's base unit engages into operations of processing account, and transmitting digital signals of account information to both of either one used FIG. II-FIG. VIII PhonExpress device used and place of Electronic Shopping with FIG. IX P.E.A.C.E. system's connector and business or companies computer. Which then FIG. IX P.E.A.C.E. system connector is simultaneously communicating with the business or companies account record system.

Which intern FIG. X P.E.A.C.E. system base unit transfers amount of funds out of account and enters amount into computers resource server of account system. Which items are paid for immediately. Then caller then engages into electronic digital communications of business or companies computerized resource server for delivery of item/items to residence or any address caller enters in on either of PhonExpress device keypad keyboard or remote keypad used. Then intern FIG. IX P.E.A.C.E system's converter connector transmits communication simultaneously to both FIG. X P.E.A.C.E. systems base unit and FIG. II-FIG. VIII PhonExpress device used. Which intern FIG. II-FIG. VIII PhonExpress device used distributes out receipt P.E.A.C.E. date, time, number and name of each of item/items purchased, amount paid, account used, building code number of the place of business or company, delivery time. For PhonExpress devices that do not come equipped with receipt dispenser then PEACE Corporation sends out monthly statements by mail.

### METHOD OF USAGE P.E.A.C.E. SHOPPING: PART PS-X

### METHOD OF SHOPPING PROCESS WITH USAGE P.E.A.C.E CONVERTER

Process of usage P.E.A.C.E system's shopping method: P.E.A.C.E. systems Converter of electronic digital signals of transmission of information data. Of which P.E.A.C.E. system's Connector is electronically connected with computerized resource server of business or companies' computer data banks of inventory and prices. Then engages operations into electronic communications with business or companies computer's inventory of the item/items numbers and codes, of the merchandise that is in stock and the pricing of the item/items.

P.E.A.C.E. system's Connector usage of electronically retrieving item/items of data and recognizing by usage of binary codes, of (UPC numbers, product numbers and codes) electronically translating of item/items name/names from business or companies computer inventory. Which establishes what the item is, and prices of items. Which P.E.A.C.E. system's Connector electronically retrieves and analyzes information data of item/items, translates data of item/items into digital signals transmitting electronically back to PhonExpress telephones.

PhonExpress telephone translates digital data, then displays name and price of item/items. Which caller then decides with the data information of item/items, then caller chooses which item/items to purchase. With usage of PhonExpress telephone LCD screen display of options and by pressing on number as indicated for item on PhonExpress telephone keypad for the item caller wants to purchase. Which PhonExpress telephone LCD screen displays amount of item/items purchased, enabling caller to purchase or decline item/items. With usage of PhonExpress system card usage of electronic entry of either Portal, [1] Financial-line for account with currency or [2] Credit-line for account with credit wherever credit is established. To engage into electronic operations of P.E.A.C.E. system base unit for operations of account transactions.

### METHOD OF USAGE P.E.A.C.E. SHOPPING: PART PS-XI

### METHOD OF SHOPPING PROCESS WITH USAGE P.E.A.C.E CONVERTER

Then usage of PhonExpress telephone operations with PhonExpress keys [A] account-code key and electronic option [1] amount. Entry of amount of dollar and cents of either currency or credit amount and enter key by usage of PhonExpress telephone accountant keypad. Which PhonExpress telephone engages electronic digital signals of communications simultaneously with P.E.A.C.E. system base unit for operations of an account transaction of caller's account. With activation, accessibility of the account entered processing account, and transmitting digital signals of account information to both PhonExpress telephone and place of shopping with P.E.A.C.E. systems connector and business or companies' computer.

Which P.E.A.C.E. systems connector is simultaneously communicating with business or companies computerized resource of account system. P.E.A.C.E. system base unit transfers amount of funds out of caller's account and enters the amount into computers resource server of account system. Which then the item/items are paid for immediately. Then activates [S] System key, and electronic mode of option 6 delivery PhonExpress telephone engages into electronic digital communications with P.E.A.C.E. converter of business or companies computerized resource server for delivery of item/items to residence or any address entered in on PhonExpress telephone keypad. Then intern P.E.A.C.E systems connector transmits communication simultaneously to both P.E.A.C.E. system's base unit and PhonExpress telephone which distributes out receipt P.E.A.C.E. date, time, number and name of each of item/items purchased, amount paid, account used, building code number of the place of business or company, delivery time.

### EXAMPLES OF METHOD OF USAGE P.E.A.C.E. SHOPPING: PART PS-XII

### 1. METHOD OF P.E.A.C.E. SHOPPING OPERATIONS

### SHOPPING FOR GROCERIES WITH CALL-DIAL

ACTIVATION OF [P] PhonExpress key

METHOD OF USAGE: Caller Activates [P] PhonExpress key, by pressing on letter P key and enter key on PhonExpress telephone letter-number keypad.

Which PhonExpress telephone transmits digital signals through fiber-optic cable through via satellite system to P.E.A.C.E. system base unit, which engages into operations of electronic communications back and forth with PhonExpress telephone and wide area networks, to local area networks.

PhonExpress telephone LCD screen displays electronic modes of options:

### [1] Portals

### [2] Account

### [3] Code

### [4] Call-dial

STEP 1: Caller enters [4] Call-dial by pressing number 4 key and presses enter key on PhonExpress telephone keypad. PhonExpress telephone electronically changes calling modes, instead of enabling caller to place a telephone call to another telephone, PhonExpress telephone electronically enables caller for entry of code number of Call-dial to open a line of transmission directly to P.E.A.C.E. converter to a place of business or company resource server

PhonExpress telephone LCD screen displays
[Enter code number] (Of 4 Call-dial, a 12-digit number).

STEP 2: by pressing a 12-digit number (3 digits of area code and 5 digits of zip code and 4 digits of building code) with usage of number keys and press enter key on PhonExpress account-code keypad. P.E.A.C.E. base unit electronically recognizes Code number and Locates place of P.E.A.C.E. converter, which is electronically connected to business or companies computerized resource server.

### EXAMPLES PART PS-CD-I

METHOD OF USAGE P.E.A.C.E. SHOPPING: GROCERIES WITH CALL-DIAL SECTION S-CD ‘SHOPPING CALL-DIAL’

PhonExpress telephone electronic transmission of digital signals through fiber-optic cable through via satellite system directly to P.E.A.C.E. system base unit. Intern P.E.A.C.E. systems base unit recognizes code and engages into operations. (Of electronic mode of option 4 Call-dial). Which intern P.E.A.C.E. system base unit identifies transmission of digital signals and engages with wide area network, to local area network to open an electronic channel of communication directly to P.E.A.C.E. systems Converter connected to place of business or companies computerized resource server that carried the 12 digit number.

Then PhonExpress telephone simultaneously communicates electronically with a direct line to P.E.A.C.E. systems Converter. P.E.A.C.E. systems Converter is electronically connected to business or company computerized resource server transmitting digital signals of informational data of inventory of merchandise and prices.

### 2. METHOD OF USAGE P.E.A.C.E. SHOPPING: GROCERIES WITH CALL-DIAL PART PS XIV AFTER ENTRY OF CALL-DIAL

Simultaneously after caller activation of 4 Call-dial. PhonExpress telephone changes electronic operational modes to LCD screen displaying options for caller to choose from

[1] Account number: electronically engages in bill list of accounts
[2] Code number: electronically engages in retrieving informational data of code entered
[3] Shopping: electronically engages in a list of inventory and pricing
[4] PhonExpress: electronically engages with another PhonExpress telephone of ‘10 digits’ entered in. Caller chooses either number indicated of choice
EXAMPLE: caller wants to shop for groceries at that place of business or company, (place of 12 digits)

STEP 3: activating option number [3] Shopping, by pressing number [3] key and press enter key on PhonExpress telephone keypad. With PhonExpress electronic usage of mode option 4 Call-dial, activates electronic digital signals of communication through P.E.A.C.E. system converter to engage into operations, obtaining a list of different departments and translating codes of merchandise items and prices usage of business or companies computerized resource server's (Data of inventory and prices different departments of products for sale). Simultaneously communicating electronic transmission of digital signals back to PhonExpress telephone LCD screen displays electronic modes of options (List of different departments at place of business)

1. Grocery department
2. Bakery department
3. Personal department
4. Pharmacy department
5. Hardware department
6. Pet department
7. Clothing department
8. Bedding department
9. Household department
10. Fishing department
11. Vehicle department
12. Jewelry department
13. Office equipment department
(Electronic modes of options with numbers indicating departments of choice to shop at) with that place of business or company resource server of inventory and prices. Caller wants to purchase groceries, by pressing number 1 key (indicates Grocery department) and press enter key on PhonExpress telephone keypad (enables electronic shopping for Groceries).

### 3. METHOD OF USAGE P.E.A.C.E. SHOPPING: GROCERIES WITH CALL-DIAL PART SP XV

Through PhonExpress telephone electronically transmits signal through fiber-optic cable to via satellite to WAN, to LAN to P.E.A.C.E system converter. Which intern simultaneously communicating electronically connected with business or company's computerized resource server. This enables electronic entry into that department. Caller wants to purchase groceries at place of business,

STEP 4: by pressing on number 1 key on PhonExpress telephone enables to transmit signal through fiber-optic cable, through via satellite system to P.E.A.C.E. system which already has communication with computerized resource server data. Identifies and Recognizes department, which enables caller to enter into options of that department. To purchase a food item/items.

PhonExpress telephone LCD screen displays (list of items and codes that are down each isle section

### 1. Dairy

### 2. Meats

### 3. Produce

4. Can goods
(Caller (shopper) wants to purchase milk) by entry of number 1 Dairy, by pressing number 1 key and enter key on PhonExpress keypad. PEACE converter electronically engages operations of inventory with that department obtaining data (a list of dairy products with options for purchasing, with usage of numbers as indicated) transmitting digital signals back to PhonExpress telephone LCD screen displays options (list of dairy items)
   1. Choc. Milk

### 2. White Milk

### 3. Juice

### 4. Eggs

### 5. Butter

### 6. Cheese

### 7. Yogurt

8. Ice cream
(Example: Caller (shopper) wants Choc. Milk) by pressing number 1 key and enter key on PhonExpress telephone keypad. P.E.A.C.E. converter communicates with business or company's resource server. Electronically obtaining a list of Choc. Milk sizes and electronic transmits digital signals of options to choose from to PhonExpress telephone
   4. METHOD OF USAGE P.E.A.C.E. SHOPPING: GROCERIES WITH CALL-DIAL PART SP XVI PhonExpress telephone LCD screen displays electronic displays options
   1. pint
   2. quart
   3. ½ gal
   4. gal

Caller (shopper) wants a gallon, choose by numbers indicating different sizes (Entry of number 4 gal). By pressing number 4 key and enter key on PhonExpress telephone keypad. PhonExpress telephone electronically transmits signal through via satellite system to P.E.A.C.E.-system converter. Which intern electronically communicates to computerized resource at store (place of business)

Then P.E.A.C.E.-system converter electronically analyzes and processes item. Retrieves 12 digit (bar-code) number, name of product and 4 digit price of item, from the business computerized resource server.
Transmits signals to PhonExpress telephone, which intern PhonExpress telephone LCD Screen displays
[Name of item]=1 gal milk
[Price of item]=$2.98
[Purchase item]=(question for caller (shopper) if wants item to purchase or not)
Caller answers Yes or No, by pressing on pound [#] key for “Yes” or Star [*] key for “No”
If caller enters [#] pound key “Yes”
Then P.E.A.C.E system converter processes data, obtains data of item, and engages into operations for item/items to be purchased.
If caller enters [*] star key “No” then P.E.A.C.E. system converter operations electronically drops that item and does not process item to purchased.
PhonExpress telephone LCD Screen displays option

### [Continue]

Caller answers by either Yes or No, by pressing on pound [#] key for “Yes” or Star [*] key for “No”
If caller answers [#] pound key “Yes” P.E.A.C.E system converter enable person to continue to shop for more dairy products.
5. METHOD OF USAGE P.E.A.C.E. SHOPPING: GROCERIES WITH CALL-DIAL PART PS XVII PhonExpress telephone LCD screen displays options
1. Choc. Milk

### 2. White Milk

### 3. Juice

### 4. Eggs

### 5. Butter

### 6. Cheese

### 7. Yogurt

8. Ice cream
Example: Caller (shopper) wants eggs, (usage of numbers indicating items) by pressing number 4 key and presses enter key on PhonExpress telephone keypad. PEACE converter electronically converses with business or company's resource server and obtains a list of sizes of eggs and electronically transmits back to PhonExpress telephone LCD screen displays options (with numbers to choose for indicating option of sizes)
1. 4 count
2. 6 count
3. 12 count
4. 18 count
5. 24 count
Example: Caller wants a dozen, which is 12 count, by pressing number 3 key and press enter key on PhonExpress telephone P.E.A.C.E. system converter engages into operations electronically communicating with business or company's computerized resource server analyzing item retrieving code and price of item chosen. Transmits electronically back to PhonExpress telephone LCD screen which electronically displays
[Name of item]
[Price of item]
[Purchase item]
Caller answers Yes or No, by pressing on pound [#] key for “Yes” or Star [*] key for “No”
If caller enters [#] pound key “Yes” then P.E.A.C.E. system converter obtains and processes that item/items engages for purchase
If caller enters [*] star key “No” P.E.A.C.E. converter engages into operations drops purchase PhonExpress telephone LCD Screen displays
[Continue] Caller answers by either by pressing pound [#] key for “Yes” or Star [*] key for “No”
If caller answers [*] star key “No” which P.E.A.C.E system converter would enable another option to enter with grocery's on PhonExpress telephone.
6. METHOD OF USAGE P.E.A.C.E. SHOPPING: GROCERIES WITH CALL-DIAL PART SP XVIII PhonExpress telephone LCD screen displays other choices of options for groceries

### 1. Dairy

### 2. Meats

### 3. Produce

4. Can goods
Caller (shopper) wants to purchase chicken, entry by number indicated, by pressing number 6 on PhonExpress keypad enable to obtain meats
PhonExpress telephone LCD screen displays

### 1. Chicken

### 2. Hamburger

3. Pork chops

### 4. Steaks

### 5. Fish

### 6. Veal

7. Roast beef
8. Hot dogs

### 9. Lunchmeats

### 10. Bacon

### 11. Ham

### 12. Turkey

Example: Person wants chicken, by pressing number 1 on PhonExpress keypad, enables to obtain chicken
7. METHOD OF USAGE P.E.A.C.E. SHOPPING: GROCERIES WITH CALL-DIAL PART PS XIX PEACE converter translates digital signals and obtains list of what kind options with numbers PhonExpress telephone LCD screen displays a list of options
1. Chick. legs
2. Chick. wings
3. Chick. thighs
4. Chick. breast
5. whole chicken
6. Chick. nuggets
7. Chick. patties

Person wants chicken nuggets, by pressing number 6 key and enter key on PhonExpress telephone keypad, PhonExpress telephone transmits digital data directly to P.E.A.C.E. converter which electronically converses with operations communicating with business or company's resource computer server of store inventory and prices of food products (place of business).

P.E.A.C.E. system converter -analyzing item retrieves code and price of item. PhonExpress telephone LCD Screen displays

[Name of item]
[Price of item]
[Purchase item]
Caller answers Yes or No, by pressing on pound [#] key for “Yes” or Star [*] key for “No”
If caller enters [#] pound key “Yes” then PEACE-system base unit obtains item engages processing for purchase
If caller enters [*] star key “No” then P.E.A.C.E. system converter operations electronically drops purchase PhonExpress telephone LCD Screen displays

### [Continue]

Caller answers by either Yes or No, by pressing on pound [#] key for “Yes” or Star [*] key for “No”
If caller answers [*] star key “No” caller (consumer) is finished shopping
PhonExpress telephone LCD screen displays
[Purchased amount]
8. METHOD OF USAGE P.E.A.C.E. SHOPPING: GROCERIES WITH CALL-DIAL PART SP XX Sliding PhonExpress systematic card: Activation of either Portals
[1] Financial-line (account with currency)
[2] Credit-line (where credit account is established)

PhonExpress telephone electronically transmits signals through fiber-optic cable through via satellite system to P.E.A.C.E. system base unit, which engages into operations of communication with WAN, then to LAN, to a computerized account server

PhonExpress telephone LCD screen displays
[Enter route number] PEACE system base unit identifies engages computerized account resource server.
PhonExpress telephone LCD screen displays
[Enter account number] either enter account number (of main account Portal which was entered thereof) with currency or credit, by pressing on PhonExpress telephone keypad (account number keypad)
PhonExpress telephone LCD screen displays
[Enter security code] enter security code number, (of account number of main account Portal entered thereof) by pressing on PhonExpress telephone number-code keypad.

Activate [A] Account-code key by pressing on letter A, on PhonExpress telephone keypad. PhonExpress telephone transmits signal through fiber-optic cable to via satellite system to P.E.A.C.E-system base unit, which engages operations for different options to enter thereof.

Intern PhonExpress telephone LCD screen displays

### [1] Amount

### [2] Account

### [3] Code

### [4] Dial-call

Caller (shopper-account holder) Purchaser enters [1] amount to pay for items purchased, by pressing on number 1 key on PhonExpress keypad. PhonExpress telephone transmits signal through fiber-optic cable through via satellite system to P.E.A.C.E-system base unit, which electronically changes operations to engage into accountant system, simultaneously PhonExpress telephone keypad changes keypad, into accountant keypad enables person to enter dollar/cent amounts by using accountant number keypad.
PhonExpress telephone LCD screen displays
[Enter amount]
Caller (shopper-account holder) enters in dollar/cent amount, by pressing on PhonExpress telephone accountant keypad, (amount for items purchased)

Which P.E.A.C.E-system base unit engages operations of processing funds out of the account number entered in, then electronically transfers the funds to an account at that store (place of business).

### 9. METHOD OF USAGE P.E.A.C.E. SHOPPING: GROCERIES WITH CALL-DIAL PART PS XXI

Caller (shopper) activates [S] System key

### [1] Portal

### [2] Account

### [3] Code

### [4] Send

### [5] Receive

### [6] Delivery

### [7] Print-out

Caller wants grocery's delivered; caller enters number 6 on PhonExpress telephone keypad. Which electronically transmits signal through fiber-optic cable through via satellite system to P.E.A.C.E-system base unit which engages operations of communications with computerized resource server at that (store) place of business (analyzing and processing preparations for delivery of items from that (store) place of business)

PhonExpress telephone LCD screen displays
[Enter address]
Caller enters address to where groceries are to be delivered by pressing numbers and letter on PhonExpress telephone number/letter keypad. This transmits signals through fiber-optic cable through via satellite
System to P.E.A.C.E.-Connector, which electronically communicates with computerized resource server the message of address to that (store) place of business.

### 9. METHOD OF USAGE P.E.A.C.E. SHOPPING: GROCERIES WITH CALL-DIAL PART PS XXII

P.E.A.C.E. system connector engages operations of retrieving and transmitting digital signals to PhonExpress telephone and computerized resource system of electronically obtaining bar-code of data with item/items purchased from businesses inventory, and retrieving data of item prices, analyzing and processing delivery. And distributing receipts to both computerized resource server and PhonExpress telephone distributes grocery receipt.

PhonExpress telephone distributes

### Example of Receipt

### P.E.A.C.E.

### Date

### Time

### Grocery Department

# Of items

### Item/number

### Item/number

### Item/number

### Amount

Account number
Building code number
Delivery time
Date, time, Grocery department number and name of each of item/items purchased, amount paid, account used, building code number of the place shopped at.

### METHOD OF INFORMATIONAL DATA

### USAGE: TRANSFERRING OR RETRIEVING PART I

(Cardholder wants to transfer informational data of document to another place)
METHOD OF PROCESS CHOICE OF STEP 1 ACTIVATION OF ENTRY FIG. I PORTAL G [3] Security-line, METHOD OF USAGE Portal G [3] Security-line by sliding FIG. I PhonExpress system card through FIG. II-FIG. VII PhonExpress device A3 Slot-port used. PhonExpress device automatically changes the electronic operations of method to the telephone keypad, computerized keyboard or remote keypad. PhonExpress electronically changes usage of the original dialing system of number keypad, into PhonExpress account-code electronic number keypad or keyboard or remote keypad. PhonExpress telephone electronically displays on LCD screen [enter code number].

Then cardholder enters 15 digits of P.E.A.C.E. code by pressing numbers of 1-digit for Country, 2-digits for State, 3-digits for Area code numbers, 4-digits for a building code numbers, and a 5-digits zip code and press enter key on PhonExpress device used of account-code keypad, keyboard or remote keypad. PhonExpress electronically activates lines of direct digital communication to the place of FIG. IX P.E.A.C.E. system converter that is electronically connected to a business or company's computerized resource server.

15-digits of P.E.A.C.E. code is one digit for Country, two digits for State, three digit area code and four digit building code and five digit zip code.

### OR CHOICE STEP 2 METHOD ENTRY OF ACTIVATION OPERATIONAL KEY

OPERATION A [P] PhonExpress key, and electronic option of [1] Portal, and entry of terminal [3] Security-line, then enters P.E.A.C.E. code)

STEP 2 Activation of [P] PhonExpress key, by pressing on letter P key and then press enter key on PhonExpress telephone keypad. PhonExpress telephone LCD screen displays electronic modes of options. (For caller to choose from) [1] Portals [2] Account [3] Code [4] Call-dial [5] Express-accounts

Cardholder activates electronic mode of option [3] Code, by pressing number 3 and press enter key on PhonExpress telephone account-code keypad.

PhonExpress telephone LCD screen displays [enters code number] code number of document or record which intern P.E.A.C.E. system converter engages and retrieves informational data.

PhonExpress telephone LCD screen displays if cost [$ amount] [0 amount]
IF NO CHARGE FOR INFORMATIONAL DATA) Proceed on with Method of Retrieving data) choosing either to transfer document elsewhere or receive a printout

### IF CHARGED FOR INFORMATIONAL DATA

(If charged for the informational data of document) PhonExpress telephone LCD screen displays electronic mode of option [accept] then cardholder decides to accept or not, by pressing either answer key of [#] Pound key for “Yes” or [*] Star key for “No’ CALLER ACCEPTS CHARGE
Cardholder slides PhonExpress system card through PhonExpress telephone slot-port of either Portals [1] Financial-line: to pay (with currency) or [2] Credit-line: (to pay with credit)

Cardholder uses the same account Portal (currency with currency)

### METHOD OF USAGE: TRANSFERRING OR RETRIEVING INFORMATIONAL DATA PART II

PhonExpress telephone changes electronic modes of keypad and electronically displays on LCD screen [enter route number] Cardholder enters route number, by pressing on number keys of that route number and then enter key on PhonExpress telephone keypad. PhonExpress telephone LCD screen displays [enter account number] intern cardholder enters account number, which pertains to that route number entered in thereof. By pressing keys of account number and enter key on PhonExpress telephone keypad. PhonExpress telephone LCD screen displays [enter security code] which intern caller enters security code number by pressing on the numbers of PhonExpress telephone keypad entering in that security code number of that account number of which pertains to that route number. By entry of these electronic modes with usage of the account-code number keypad on PhonExpress telephone. (Which P.E.A.C.E. system base unit electronically engages operations of that account and electronically locates, activates, enables account accessible, for caller to proceed on an amount of funds to be removed out of that account).

### PAYING FOR CHARGED INFORMATIONAL DATA

Activation of [A] account-code key, by pressing on letter A and enter key on PhonExpress telephone keypad. PhonExpress telephone electronically changes operations. PhonExpress telephone LCD screen displays electronic modes of options. By choosing electronic mode [1] amount, which intern allows entry of the amount of dollars/cents (by usage of accountant keypad) and then presses enter key on PhonExpress telephone keypad.

(Informational data paid for, by amount entered is electronically removed out of account entered and electronically transmitted to the account of informational data account resource server)
TRANSFER OF (CHARGED) INFORMATIONAL DATA (Transfer charged informational data to another place)

Activation of Portal [3] Security line by sliding PhonExpress system card through PhonExpress telephone slot-port. PhonExpress telephone electronically displays [enter code number] then by pressing on numbers of the code number and then press enter key on PhonExpress telephone account-code keypad. PhonExpress enables entry of 12 digital code of numbers, three-digit area code, four digit building code, five digit P.E.A.C.E. number.

Activation of [S] System key, entry is by pressing on letter S key and presses on enter key on PhonExpress telephone keypad that electronically changes operations. PhonExpress telephone displays electronic modes of options on LCD screen. By choosing electronic mode [4] Send key (which then P.E.A.C.E. system base unit electronically transfers paid documents to the other place enter thereof).

PRINTOUT OF (CHARGED) INFORMATIONAL DATA (Print-out of the charged informational data)

Activation [S] System key, by pressing the letter S and press enter key on PhonExpress telephone keypad. PhonExpress telephone electronically displays modes of options on LCD screen. Caller chooses to enter electronic mode of [7] print out, by pressing number 7 and then the enter key on PhonExpress telephone keypad. (Which P.E.A.C.E. system base unit electronically transmits digital signals of paid document, informational data to PhonExpress telephone) which intern caller retrieves a printout a copy of document or record. (Caller must have printer connected)

### METHOD OF USAGE: TRANSFERRING OR RETRIEVING INFORMATIONAL DATA PART III

TRANSFER INFORMATIONAL DATA (OF NO CHARGE) by choosing to either transfer document elsewhere or receive a printout (with out a charge proceeds on) (If caller wants to transfer informational data to another place.

### TRANSFER INFORMATIONAL DATA

Activation of [A] Account-Code key, by pressing the letter A on PhonExpress telephone keypad. PhonExpress telephone electronically changes operations, then PhonExpress telephone displays options on LCD screen.

By choosing electronic mode of [4] Dial-call, by pressing number 4 and enter key on PhonExpress telephone keypad. PhonExpress telephone displays electronic entry of [enter code number] by pressing on numbers of the 12 digit code on PhonExpress telephone keypad. Enables caller to enter another [12 digit code number of 3 digit area code +4 digit building code +5 digit P.E.A.C.E. number] which electronically transmits digital signals directly to P.E.A.C.E. converter of the place to electronically transfer document or record to.

PRINT-OUT OF INFORMATIONAL DATA (NO CHARGE)

Activation of [S] System key, by pressing letter S and enter key on PhonExpress telephone keypad. PhonExpress telephone electronically displays modes of options on LCD screen. By choosing electronic mode [7] print out, is by pressing number 7 and enter key on PhonExpress telephone keypad. Enables to retrieve a copy of document or record. (Must have printer connected to PhonExpress telephone)

### METHOD OF ELECTRONIC TRANSMITTING AND RETRIEVING INFORMATIONAL DATA AND OF SHOPPING WITH USAGE P.E.A.C.E. system's Converter:

USAGE OF SHOPPING: FOR P.E.A.C.E. systems: Converter connector:
With usage of Caller using P.E.A.C.E. system's shopping method:

P.E.A.C.E. system's Converter connected for electronic digital transmission of information of data. Of which P.E.A.C.E. system's Converter is electronically connected with computerized resource server of business or companies' computerized resources data banks of inventory data records. Then engages operations into electronic digital communications with business or companies computer's codes for records, documents, any informational data or engages into operations of inventory data of item/items numbers and codes of merchandise that is in stock and the pricing of the item/items.

With P.E.A.C.E. system's Converter electronic usage of transmitting digital signals and retrieving documents of informational data or with shopping the data of item/items and prices. P.E.A.C.E. system Converter recognizing data by usage of binary codes, of (codes of document numbers, records, any informational data) or (UPC numbers, product numbers and codes) Electronically translating of either documents, or records of informational data or with shopping the item/items name/names from business or companies computer inventory. Which recognizes and establishes what the item is, and prices of items are. Which P.E.A.C.E. system's Converter electronically retrieves and analyzes information data of document, or records of any informational data or with shopping the item/items and prices translating data of any informational data or shopping product item/items into digital signals transmitting electronically back to PhonExpress telephones. Which choice of printout of informational data (see method of informational data) or choice of purchasing item/items of merchandise and prices (see method of shopping)

### KEYS OPERATIONS OF TRANSFERRING FUNDS

### METHOD OF ACCOUNT-TRANSACTION

### CURRENCY

### STEP 1 METHOD OF FIG. II-FIG. VIII: A [P] PhonExpress key

OPERATIONAL KEY A—[P] PhonExpress key: located above the number 1 key, at the top, left side, of PhonExpress letter [A] key. See in Drawings FIG. II-FIG. VIII. Which intern activates changes of operations from the usage of the original devices such as telephones original cellular telephones, original computer keyboard, and original TV remote into P.E.A.C.E. system's PhonExpress account-code system operational usage. Which PhonExpress operations intern simultaneously activates choice for entry to electronic modes of account-code options.

METHOD OF USAGE: A—[P] PhonExpress key: by pressing on the letter P key and press Enter key on any of the PhonExpress device keypad keyboard or remote keypad used.
PhonExpress A12, A12a, A12b LCD screens displays choice of options indicated by their numbers

### OPTION 1: PEACE-LINE:

### OPTION 2: TRAN-LINE

### OPTION 3: DIRECT-LINE

METHOD OF USAGE: OPTIONS by pressing on number key indicating choice of option and then press enter key on PhonExpress keypad keyboard or remote keypad used.
METHOD OF OPTION 1: PEACE-LINE Activates electronic entry for choice of either Account-Code Portals or Account-Code Slip-ports for accessing of Each Five computerized account options. Enables for account-code transaction of funds or transfer informational data into another account of choice. Currency with currency or Credit with credit: process of transferring informational data into other computerized accounts. For either Options 1 Portals or Option 2 Slot-ports indicated by their numbers
METHOD OF USAGE: OPTION 1: PEACE-LINE By pressing number 1 key and enter key on PhonExpress device keypad, keyboard or remote keypad used.
PhonExpress LCD A12, A12a or A12b screen displays options to choose from

### OPTION 1: Portals

### OPTION 2: Slip-ports

METHOD OF OPTION 1: Portals: EACH choice Portal activates entry to PEACE base unit electronic account-code terminals of choice. For usage any account-code transactions of funds or informational data
METHOD OF USAGE OPTION 1: Portals: by pressing number 1 key and enter key on PhonExpress device keypad, keyboard or remote keypad using.
PhonExpress A12, A12a, or A12b LCD screen displays Options for entry to Portals indicated by their numbers:

### OPTION [1] Financial-line: CURRENCY ACCOUNT-TRANSACTION

### OPTION [2] Credit-line:

### OPTION [3] Security-line:

### OPTION [4] Consumers-line

CHOICE OF METHOD PORTAL B [1] Financial-line: by pressing number 1 key and enter key on PhonExpress device keypad, keyboard or remote keypad used. For Account-transactions of currency
PhonExpress device used electronically changes electronic operations and displays on A12, A12a or A12b LCD screen

[Enter Route Number]

METHOD: ENTRY OF ROUTE NUMBER: by pressing on numbers of that route number and enter key on PhonExpress device account-code keypad, keyboard or remote keypad used.
PhonExpress device A12 A12a or A12b LCD Screen displays

### [Any Corrections] SEE METHOD OF CHOICE OF TWO ANSWER KEYS

PhonExpress device used changes electronic operations and displays on A12, A12a or A12b LCD screen

[Enter Account Number]

METHOD: ENTRY OF ACCOUNT NUMBER: By entering in an account number that pertains to that route number is by pressing on number keys of that account number and press enter key on PhonExpress device account-code keypad, keyboard or remote keypad used.
PhonExpress device A12 A12a or A12b LCD Screen displays

### [Any Corrections] SEE METHOD OF CHOICE OF TWO ANSWER KEYS

PhonExpress device used changes electronic operation and displays on A12, A12a or A12b LCD screen

[Enter Security Code]

PhonExpress device A12 A12a or A12b LCD Screen displays

### [Any Corrections] SEE METHOD OF CHOICE OF TWO ANSWER KEYS

METHOD: ENTRY OF SECURITY CODE NUMBER: by entering security code number of that account number pertaining to that route number is by pressing on number keys of that security code number and enter key on PhonExpress telephone account-code keypad, keyboard or remote keypad used.
METHOD OF USAGE: By entering these numbers, FIG. II PhonExpress telephone, FIG. III PhonExpress telephone adapter, FIG. IV PhonExpress cellular telephone, FIG. VII PhonExpress computerized keyboard or FIG. VIII PhonExpress TV remote electronically transmits digital signals to FIG. X P.E.A.C.E. system base unit. Which intern engages into electronic operations of that account which is activated and accessible for removal of funds.
FIG. X P.E.A.C.E. system base unit electronically engages into operations of locating place of computerized account resource server, activating account, enabling account accessible for removal of an amount out of that account.

### STEP 2 METHOD OF FIG. II-FIG. VIII A1 [A] Account-Code key

FIG. II-FIG. VIII indicated by numbers A1: [A] Account-Code key: located above the number 2 key, in between PhonExpress letter [P] key and [S] key. Which PhonExpress operations intern simultaneously activates choice for entry to electronic modes of account-code options.

METHOD OF USAGE by pressing letter A key and enter key on PhonExpress keypad, keyboard or remote keypad used. Activates electronic options entry of choices. For either Options 1 Amount or Option 2 Tran-line or Option 3 Direct-line PhonExpress LCD A12, A12a or A12b screen displays options to choose from

### OPTION 1: AMOUNT

### OPTION 2: TRAN-LINE

### OPTION 3: DIRECT-LINE

METHOD OF USAGE: by pressing number keys indicating choice of option and then press enter key on PhonExpress keypad keyboard or remote keypad used.
CHOICE OF METHOD: OPTION 1: AMOUNT Activates changes of usage with original number keys into PhonExpress electronic operations accountant numbers for entry of dollar/cent amounts for account-code transactions of either funds currency or credit. Of either PhonExpress keypad PhonExpress keyboard or PhonExpress Remote-pad changes account-code keypad into accountant keypad
METHOD OF USAGE OPTION 1: AMOUNT by pressing number 1 key and Enter key on PhonExpress keypad PhonExpress keyboard, or PhonExpress Remote-pad.
PhonExpress LCD A12, A12a or A12b screen displays

### [Enter Amount]

METHOD: ENTER AMOUNT by pressing number keys indicating of dollar and cents for either currency or credit and then press enter key on PhonExpress keypad PhonExpress keyboard, or PhonExpress Remote-pad used.
PhonExpress device A12 A12a or A12b LCD Screen displays

### [Any Corrections] SEE METHOD OF CHOICE OF TWO ANSWER KEYS

### METHOD OF USAGE:

### Specification on Categories how it Works

SPECIFICATION OF FIG. I: PhonExpress system card

### SPECIFICATION OF ACCOUNT-CODE PORTALS:

### SPECIFICATION TWO OPEN/CLOSE KEYS

### SPECIFICATION OF ACCOUNT-CODE SLIP-PORTS

### METHOD OF SLIP-PORT USAGE OF ACCESSING FUNDS OF CURRENCY OR CREDIT

### METHOD OF LEFT-SIDE SLIP-PORTS FIVE ACCOUNT OPTIONS FOR FUNDS

### METHOD OF SLIP-PORT USAGE OF INFORMATIONAL DATA

### METHOD OF RIGHT-SIDE SLIP-PORTS FIVE ACCOUNT OPTIONS FOR INFORMATIONAL DATA

### METHOD OF USAGE: ACCOUNT-CODE PORTALS:

### FIG. I: SIDE 1: PORTAL B [1] Financial-line:

### FIG. I: SIDE 1: PORTAL C [2] Credit-line:

### FIG. I: SIDE 2: PORTAL G [3] Security-line: FOR INFORMATIONAL DATA

### FIG. I: SIDE 2: PORTAL H [4] Consumers-line: FOR ELECTRONIC SHOPPING

FIG. I-1: RETRIEVING INFORMATIONAL DATA: I [7] IDH-line or/and J [8] MDH-line

### P.E.A.C.E. System's SEVEN KEYS AND SLOT-PORT

### 1 METHODS OF DIGITAL FUNDS

### ACCOUNT TRANSACTIONS, PAYING ON ACCOUNTS, TRANSFERRING FUNDS, RECEIVING FUNDS

### 2 METHODS OF DIGITAL INFORMATIONAL DATA

### SENDING, TRANSFERRING, RETRIEVING

### 3 METHODS OF DIGITAL SHOPPING

### SHOPPING, PURCHASING, IMMEDIATE PAYING, DELIVERY

FIG. II: PhonExpress telephone
FIG. III: PhonExpress telephone adapter
FIG. IV: PhonExpress cellular telephone
FIG. V: PhonExpress store adapter
FIG. VI: A-E PhonExpress varies adapters
FIG. VII: PhonExpress keyboard
FIG. VIII: PhonExpress TV remote

### FIG. IX: P.E.A.C.E. CONVERTER

### FIG. X: P.E.A.C.E. Base Unit

### FIG. I: Phonexpress System Card

### 1. SPECIFICATION OF METHODS

FIG. I: PhonExpress system card establishes use of four account-code Portals, also two open/close keys, with usage of either one of the two open/close keys electronically releases four account-code Slip-ports concealed on FIG. I-1 PhonExpress slip-card that electronically interconnects with FIG. I PhonExpress system card.

By using one of the two-open/close keys releases electronically interconnects with a concealed FIG. I-1: PhonExpress slip-card establishing use of four main account-code Slip-ports. The concealed FIG. I-1: PhonExpress slip-card. For usage of, this establishes four personal accounts. Linking both together enables more usage with

METHOD OF ENTRY of electronic entry: Is by sliding either one-of the four Portals on FIG. I: PhonExpress system card One Portal digital strip using Faces in-ward as the sliding process is made through PhonExpress device A3 Slot-port. Or by using either one of the two open/close keys on side 1 of FIG. I: PhonExpress system card, releasing and expanding out the FIG. I-1: PhonExpress slip-card. Then by sliding either one-of the four Slip-ports digital strip using Faces in-ward as the sliding process is made through any of the PhonExpress devices A3 Slot-port.

SEE in drawings pages 20-34 for location of A3 Slot-port on either of FIG. II PhonExpress telephone, FIG. IV PhonExpress cellular telephone, FIG. III PhonExpress telephone adapter, FIG. V PhonExpress store adapter, FIG. VI A-F PhonExpress various adapters, FIG. VII PhonExpress computerized keyboard, FIG. VIII PhonExpress TV remote.

METHOD OF ONE SWIPE Of One Portal or One Slip-port using digital strip Faces in-ward as the sliding process is made through A3 Slot-port on either one of the PhonExpress devices electronically transmits digital signals to FIG. X: P.E.A.C.E. system base unit or opens a direct-line to FIG. IX: P.E.A.C.E. system converter. This engages simultaneously into electronic operations. Transmitting digital signals of communications between both of either one of the PhonExpress devices and FIG. IX: P.E.A.C.E. converter that is connected to business or companies computerized resource server used.

### 2. METHOD OF PORTALS

SPECIFICATION OF FIG. I: PhonExpress system card
METHOD OF USAGE: by sliding either choice of using one-Portal the digital strip facing in-ward as the sliding process is made through A3 Slot-port on any of PhonExpress devices used.

### SPECIFICATION OF FRONT-SIDE 1

METHOD OF USAGE: FIG. I-F: PORTAL A [1] Financial-line is by sliding Side 1 Portal A [1] Financial-line of FIG. I PhonExpress system card Portal using digital strip Faces in-ward through a PhonExpress device A3 Slot-port. Enables an electronic entry, for accounts of currency, activating, accessing, processing account transactions with business or companies computerized resource servers of account system.
METHOD OF USAGE: FIG. I-F: PORTAL B [2] Credit-line is by sliding Side 1 Portal B [2] Credit-line of FIG. I PhonExpress system card Portal using digital strip Faces in-ward through a PhonExpress device A3 Slot-port. Enables an electronic entry, for accounts of established credit, activating, accessing, processing credit account transactions, with credit companies computerized resource server of credit account system.

### SPECIFICATION OF BACK-SIDE 2

METHOD OF USAGE: FIG. I-B: PORTAL G [3] Security-line is by sliding Side 2 Portal G [3] Security-line of FIG. I PhonExpress system card Portal using digital strip Faces in-ward through a PhonExpress device A3 Slot-port. Enables an electronic entry, for code numbers, for sending or retrieving informational data from a business or company's computerized resource data system.

METHOD OF USAGE: FIG. I-B: PORTAL H [4] Consumers-line is by sliding Side 2 Portal H [4] Consumers-line of FIG. I PhonExpress system card Portal using digital strip Faces in-ward through a PhonExpress device A3 Slot-port. Enables an electronic entry for codes and numbers, for electronic shopping selecting items purchasing items immediately and delivery to any address from a business or company's resource data of inventory and price system. Along with consumer uses either account portals of currency or credit, operations for account transactions with business or companies computerized resource server. Purchasing items.

### 3. METHOD OF FIG. K1 AND K2 TWO OPEN/CLOSE KEYS

### SPECIFICATION METHOD OF USAGE FOR ACCESSING SLIP-PORTS

### SPECIFICATION METHOD OF TWO OPEN/CLOSE KEYS

FIG. 1 PhonExpress system card establishes two open/close keys, both are located on top of Side 1, the Left-side is K1 open/close key and the Right-side is K2 open/close key by pressing either one-of choice on FIG. 1: PhonExpress system card. Releases FIG. I-1 PhonExpress slip-card Slip-ports to protract-out, then repress same key retracts FIG. I-1 PhonExpress slip-card back-in the ONE FIG. 1 PhonExpress system card.
METHOD OF USAGE: LEFT-K1 OPEN/CLOSE KEY located on Side 1 of the Left-side of FIG. I: PhonExpress system card
STEP 1 by pressing K1 open/close key electronically releases and protracts-out FIG. I-1: PhonExpress slip-card from inside of FIG. I: PhonExpress system card. Expanding out to the Left Two Slip-ports, [5] Reserve-line, [6] Express-line.
STEP 2 by repressing the same K1 open/close key retracts both Slip-ports on FIG. I-1-L: PhonExpress slip-card back-in the left-side concealed into the left-side of FIG. I: PhonExpress system card.
METHOD OF USAGE: RIGHT-K2 OPEN/CLOSE KEY located on Side 1 of the Right-side of FIG. I: PhonExpress system card
STEP 1 by pressing K2 open/close key electronically releases and protracts-out FIG. I-1: PhonExpress slip-card from inside of FIG. I: PhonExpress system card. Expanding out to the Right Two Slip-ports, [7] IDH-line, [8] MDH-line.
STEP 2 by repressing the same K2 open/close key retracts both Slip-ports on FIG. I-1-R: PhonExpress slip-card back-in the right-side concealed into the right-side of FIG. I: PhonExpress system card.

### 4. METHOD OF SLIP-PORTS

### SPECIFICATION OF P.E.A.C.E. System's ONE CARD

SPECIFICATION OF FIG. I: PhonExpress system card ACCOUNT-CODE SLIP-PORTS
FIG. 1: PhonExpress system card conceals the FIG. I-1 PhonExpress slip-card, which electronically establishes four digital account-code Slip-ports that are accessible for cardholder's usage.
METHOD OF USAGE: of choice, by pressing on either one of the two open/close keys, then by sliding either choice of one-Slip-port using digital strip Faces in-ward through A3 slot-port on any of PhonExpress devices. The One Slip-port using digital strip Faces in-ward as the sliding process is made.

### FOLLOW METHOD OF USAGE: FIG. I-L: LEFT A1 OPEN/CLOSE KEY

### SPECIFICATION OF LEFT-SIDE OF FIG. I-1 PhonExpress Slip-card FOR ACCESSING FUNDS

METHOD OF USAGE: SLIP-PORT D [5] Reserve-line: accessing five digital computerized accounts, by pressing on K1 open/close key and slide Slip-port using digital strip Faces in-ward through A3 Slot-port on any of PhonExpress devices Intern PhonExpress A12 LCD screen displays a list of five computerized account options to choose from.

### PROCEED ON WITH METHOD OF SLIP-PORT USAGE OF ACCESSING FUNDS

### FOLLOW METHOD OF USAGE: FIG. I-L: LEFT A1 OPEN/CLOSE KEY

### SPECIFICATION OF LEFT-SIDE OF FIG. I-1 PhonExpress Slip-card FOR ACCESSING FUNDS

METHOD OF USAGE: SLIP-PORT I [6] Express-line: accessing five digital computerized accounts, by pressing on K1 open/close key and slide Slip-port using digital strip Faces in-ward through A3 Slot-port on any of PhonExpress devices Intern PhonExpress A12 LCD screen displays a list of five computerized account options to choose from. PROCEED ON WITH METHOD OF SLIP-PORT USAGE OF ACCESSING FUNDS

### METHOD OF USAGE: FIG. I-F: RIGHT A2 OPEN/CLOSE KEY

### SPECIFICATION OF RIGHT-SIDE OF FIG. I-1-R PhonExpress Slip-card FOR INFORMATIONAL DATA

METHOD OF USAGE: SLIP-PORT [7] IDH-line accessing five digital computerized accounts, by pressing on K2 open/close key and slide Slip-port using digital strip Faces in-ward through A3 slot-port on any of PhonExpress devices Intern PhonExpress A12 LCD screen displays a list of five computerized account options to choose from.

### PROCEED ON WITH METHOD OF SLIP-PORTS FIVE ACCOUNT OPTIONS

### METHOD OF USAGE: FIG. I-R: RIGHT A2 OPEN/CLOSE KEY

### SPECIFICATION OF RIGHT-SIDE OF FIG. I-1R PhonExpress Slip-card FOR INFORMATIONAL DATA

METHOD OF USAGE: SLIP-PORT [8] MDH-line accessing five digital computerized accounts, by pressing on K2 open/close key and slide Slip-port using digital strip Faces in-ward through the A3 Slot-port on any of PhonExpress devices. Intern PhonExpress A12 LCD screen displays a list of five computerized account options to choose from.

### PROCEED ON WITH METHOD OF SLIP-PORTS FIVE ACCOUNT OPTIONS

5. METHODS OF SLIP-PORT D [5] Reserve-line: Entry to Five computerized digital accounts

### SIDE 1: LEFT-SIDE FIG. I-1: SLIP-PORTS OF FIG. I:

### BY AFTER METHOD OF USAGE: FIG. I-F: SIDE 1-L: LEFT A1 OPEN/CLOSE KEY

### METHOD FIVE-ACCOUNT OPTIONS

### FOR ACCESSING FUNDS OF CURRENCY OR CREDIT

METHOD OF USAGE: OPTION 1 Conserve-line=by pressing on number 1 and enter key on PhonExpress device keypad, keyboard, remote keypad used. Enables for funds to be electronically placed into digital computerized account to maintain a budget and accessibility to electronic funds for spending
METHOD OF USAGE: OPTION 2 Employ-line=by pressing on number 2 and enter key on PhonExpress device keypad, keyboard, remote keypad used. Distribution employment funds and accessibility to electronic funds for spending
METHOD OF USAGE: OPTION 3 Unemploy-line=by pressing on number 3 and enter key on PhonExpress device keypad, keyboard, remote keypad used. Distribution unemployment funds and accessibility to electronic funds for spending
METHOD OF USAGE: OPTION 4 EBT-line=by pressing on number 4 and enter key on PhonExpress device keypad, keyboard, remote keypad used. Distribution food stamps funds and accessibility to electronic funds for spending
METHOD OF USAGE: OPTION 5 DDF-line=by pressing on number 5 and enter key on PhonExpress device keypad, keyboard, remote keypad used. Distribution disability funds and accessibility to electronic funds for spending
   6. METHODS OF SLIP-PORT I [6] Express-line: Entry to Five digital computerized accounts

### SIDE 2: LEFT-SIDE FIG. I-1-L: SLIP-PORTS OF FIG. I:

### BY AFTER METHOD OF USAGE: FIG. I-F: SIDE 1: LEFT A1 OPEN/CLOSE KEY

### METHOD FIVE-ACCOUNT OPTIONS

FOR ACCESSING FUNDS OF CURRENCY OR CREDIT

METHOD OF USAGE: OPTION 1 Express-fuel=by pressing number 1 and enter key on PhonExpress device keypad, keyboard, remote keypad used. Enables accessibility to electronic funds for spending of credit funds established with businesses for pay-at-the-pumps,
METHOD OF USAGE: OPTION 2 Express-store=by pressing number 2 and enter key on PhonExpress device keypad, keyboard, remote keypad used. Enables accessibility to electronic funds for spending usage of in-store credit funds established at any company or business
METHOD OF USAGE: OPTION 3 Express-call=by pressing number 3 and enter key on PhonExpress device keypad, keyboard, remote keypad accessibility to electronic funds for spending currency or credit prepaid PhonExpress usage for minutes
METHOD OF USAGE: OPTION 4 Express-ride=by pressing number 4 and enter key on PhonExpress device keypad, keyboard, remote keypad accessibility to electronic funds for spending cardholder's funds for busses or taxi's
METHOD OF USAGE: OPTION 5 Express-disc=by pressing number 5 and enter key on PhonExpress device keypad, keyboard, remote keypad enables accessibility to electronic discounts at any business or companies establishments
7. METHODS OF SLIP-PORT E [7] IDH-line: entry to Five digital computerized accounts

### SIDE 1 RIGHT-SIDE FIG. I-1-R: SLIP-PORTS OF FIG. I:

### BY AFTER METHOD OF USAGE: FIG. I-F: SIDE 1: RIGHT A2 OPEN/CLOSE KEY

### METHOD FIVE-ACCOUNT OPTIONS

### FOR ACCESSING INFORMATIONAL DATA

METHOD OF USAGE: OPTION 1 ID-line=by pressing number 1 and enter key on PhonExpress device keypad, keyboard, remote keypad used. Enables PhonExpress A12 LCD screen to display a list of cardholder's Name, DOB, Driver's license, Social Security number
METHOD OF USAGE: OPTION 2 ED-line=by pressing number 2 and enter key on PhonExpress device keypad, keyboard, remote keypad used. Enables PhonExpress Alt LCD screen to display a list of cardholder's educational history
METHOD OF USAGE: OPTION 3 Chan-line=by pressing number 3 and enter key on PhonExpress device keypad, keyboard, remote keypad used. Enables PhonExpress A12 LCD screen to display a list of enables cardholder for entry to change data on account
METHOD OF USAGE: OPTION 4 Employ-line=by pressing number 4 and enter key on PhonExpress device keypad, keyboard, remote keypad used. Enables PhonExpress A12 LCD screen to display a list of cardholder's employment history
METHOD OF USAGE: OPTION 5 BG-line=by pressing number 5 and enter key on PhonExpress device keypad, keyboard, remote keypad used. Enables PhonExpress Alt LCD screen to display a list of cardholder's background history
8. METHODS OF SLIP-PORT J [8] MDH-line: entry to Five digital computerized accounts

### SIDE 2 RIGHT-SIDE FIG. I-1-R: SLIP-PORTS OF FIG. I-F:

### BY AFTER METHOD OF USAGE: FIG. I-F: SIDE 1: RIGHT A2 OPEN/CLOSE KEY

### METHOD FIVE-ACCOUNT OPTIONS

### FOR ACCESSING INFORMATIONAL DATA

METHOD OF USAGE: OPTION 1 Medic-line=by pressing number 1 and enter key on PhonExpress device keypad, keyboard, remote keypad used. Enables PhonExpress A12 LCD screen to display a list of cardholder's present medical problems
METHOD OF USAGE: OPTION 2 Med-line=by pressing number 2 and enter key on PhonExpress device keypad, keyboard, remote keypad used. Enables PhonExpress A12 LCD screen to display a list of cardholder's usage of present medications
METHOD OF USAGE: OPTION 3 Chan-line=by pressing number 3 and enter key on PhonExpress device keypad, keyboard, remote keypad used. Enables PhonExpress A12 LCD screen to display a list of enables cardholder, doctors entry to change data on account
METHOD OF USAGE: OPTION 4 Access-line=by pressing number 4 and enter key on PhonExpress device keypad, keyboard, remote keypad used. Enables PhonExpress to transmit electronic medical device signals with digital transmission for ICD-pace maker, pacemakers
METHOD OF USAGE: OPTION 5 History-line=by pressing number 5 and enter key on PhonExpress device keypad, keyboard, remote keypad used. Enables PhonExpress Alt LCD screen to display a list of cardholder's medical history, childhood records

### 9. METHOD LEFT-SIDE SLIP-PORT ACCESSING FUNDS

METHOD OF USAGE: By usage of K1 open/close key on Side 1 of FIG. I PhonExpress system card, protracts out the Left-side Two Slip-ports concealed FIG. I-1 PhonExpress slip-card.
METHOD OF USAGE: By sliding either One of the Left-side Two Slip-ports of choice through A3 Slot-port on PhonExpress device in use. The One Slip-port using the digital strip Faces in-ward as sliding process is made. Usage of Then PhonExpress electronically transmits to FIG. X PEACE base unit. Which intern engages into operations. Simultaneously PhonExpress A12 LCD screen displays a list of five digital computerized account options.
METHOD OF USAGE: By pressing on number indicating which one of the five digital computerized accounts with funds of currency or credit to use, then press enter key on PhonExpress keypad, keyboard, remote pad used.

### ACTIVATION

PhonExpress device A12 LCD screen displays [enter security code] By pressing on numbers indicating the security code number of that account number entered and then press enter key on either PhonExpress keypad, keyboard, remote pad used.

### ACCESSIBILITY.

### PROCEED ON METHODS

### ACTIVATION OF [A] Account-code key

### OPTION 1: AMOUNT ENTRY

### 10. FIG. I-I-R ; RIGHT-SIDE SLIP-PORT ACCESSING INFORMATIONAL DATA

METHOD By usage of K2 open/close key on Side 1 of FIG. I-F PhonExpress system card, protracts out the right-side Two Slip-ports concealed FIG. I-1-R PhonExpress slip-card.
METHOD OF USAGE: By sliding either choice of one on the right-side two Slip-ports using digital strip Faces in-ward through A3 Slot-port on PhonExpress device in use. Then PhonExpress electronically transmits to FIG. X PEACE base unit. Which intern engages into operations. Simultaneously PhonExpress A12 LCD screen displays a list of five digital computerized account options.
METHOD OF USAGE: By pressing on number indicating which one of the five digital computerized accounts chosen.
Then press enter key on PhonExpress keypad, keyboard, remote pad used.
PhonExpress device A12 LCD screen displays [enter security code]
By pressing on numbers indicating the security code number of that account number entered and then press enter key on either PhonExpress keypad, keyboard,

### 11. SIDE 1 METHODS OF ACCOUNT PORTALS

SPECIFICATION OF FIG. I-F: PhonExpress system card:

### METHODS OF ACCOUNT-CODE PORTALS

### FIG. I-F: SIDE 1: PORTAL B [1] Financial-line:

### FIG. I-F: SIDE 1: PORTAL C [2] Credit-line:

When account Portals are activated usage accessed is same (currency with currency) (credit with credit) no mixing FIG. I-F: SIDE 1: PORTAL B [1] Financial-line: electronic digital terminal Social Security Number [01- - -/- -/- - - -] of the cardholder engraved for transmitting electronically digital signals for accessing account options of the cardholder. Any accounts pertaining to currency anywhere.
USAGE: By swiping of FIG. I-F PhonExpress system card Portal using digital strip Faces in-ward through A3 Slot-port on any PhonExpress devices transmits an account-code of portal 01-line and Social Security number [01- - -/- -/- - - -] to FIG. X: P.E.A.C.E. base unit which intern engages into portal terminal 01 for operations and obtaining all accounts of currency under that Social Security number. Cardholder then enters an account number through number keys and enter key on any of the PhonExpress devices keypad, keyboard, or remote pad. Intern FIG. X: P.E.A.C.E. base system computerized electronics recognizes and obtains that account number then locates the server through account number entered. Which intern activates that FIG. IX: P.E.A.C.E. converter to converse with that server of that account number. Which intern activates that account number at that location. Then by entering security code number enables that account to be accessible for account transactions of currency funds.
FIG. I-F: SIDE 1: PORTAL C [2] Credit-line: electronic digital terminal Social Security Number [02- - -/- -/- - - -] of the cardholder engraved for transmitting electronically digital signals for accessing credit account options of the cardholder. Any credit accounts wherever credit is established USAGE: By swiping of FIG. I-F PhonExpress system card Portal using digital strip Faces in-ward through A3 Slot-port on any PhonExpress devices transmits an account-code of portal 02-line and Social Security number [02- - -/- -/- - - -] to FIG. X: P.E.A.C.E. base unit which intern engages into portal terminal 02-line for operations obtaining all accounts of credit under that Social Security number. Cardholder enters a credit account number through number keys on the PhonExpress device keypad, keyboard, or remote pad using. Intern FIG. X P.E.A.C.E. base system computerized electronics recognizes and obtains that account number then locates the server through credit account number entered. Which intern activates that FIG. IX: P.E.A.C.E. converter to converse with that server of that credit account number. Which intern activates that credit account number at that location. Then by entering security code number of that credit account wherever credit is established. This enables that credit account to be accessible for usage of credit account transactions of credit funds.
12. FIG. I-B PhonExpress system card SIDE 2 METHODS OF CODE PORTAL
SPECIFICATION OF FIG. I-B: PhonExpress system card

### METHODS OF ACCOUNT-CODE PORTALS

### FIG. I-B: SIDE 2: PORTAL G [3] Security-line: FOR INFORMATIONAL DATA

Is an electronic digital terminal for informational data. 03-line, Social Security and P.E.A.C.E. code for converter Number [03- - -/- -/- - - - P.E.A.C.E.] which opens a direct line to any FIG. IX: P.E.A.C.E. converters that are connected to business or companies resource server to engage and obtain informational data with FIG. IX: PEACE system's converter processing program
METHOD 1: By swiping of FIG. I-B: PhonExpress system card Portal using digital strip Faces in-ward through A3 Slot-port on any FIG. II-FIG. VIII PhonExpress devices transmits digital signals of an account-code portal 03-line, Social Security Number and P.E.A.C.E. code to FIG. X: P.E.A.C.E. base unit. Which intern engages into [3] Security-line portal terminal for entry to any P.E.A.C.E. converter. Which intern PhonExpress screen displays [enter code] By usage of either PhonExpress keypad, keyboard, or remote pad, entering code of numbers pertaining to country, state, area code, building code, zip code [-/- -/- - -/- - - -/- - - - -] 15 digits.
METHOD 2: by activation of A [P] PhonExpress key, by pressing the letter [P] key that's located on the top left side above the number 1 key, and press the enter key which is located above on FIG. II PhonExpress telephone See in drawing page 20-40. See in drawings for locations on other PEACE system devices. PEACE system's FIG. II PhonExpress telephone LCD screen displays electronic options. By using the electronic option 1 P.E.A.C.E., by pressing number 1 and enter key on PhonExpress keypad, keyboard, remote pad. PhonExpress screen displays options of 1 Portals or 2 Slip-Portals, by choice of number 1 Portals enables ability to enter any portal terminal. By pressing on number 1 key and enter key on PhonExpress keypad, keyboard, or remote pad. Enables options of Portals. By choosing number 3 portal which is G [3] Security-line by pressing on number [3] key and enter key on PhonExpress keypad, keyboard, or remote pad. Enables entry into FIG. X: PEACE base unit digital code terminal. Intern engages into G [3] Security-line portal terminal. Intern PhonExpress A12 LCD screen displays [Enter PEACE Code]. This enables entry for any FIG. IX: P.E.A.C.E. converter

### SIDE 2 METHODS OF CODE PORTALS

SPECIFICATION OF FIG. I: PhonExpress system card

### METHODS OF ACCOUNT-CODE PORTALS

### FIG. I-B: SIDE 2: PORTAL G [3] Security-line: FOR INFORMATIONAL DATA

### METHOD OF USAGE: PEACE-CODE DIGITAL TRANSMISSION FOR LOCATION

The P.E.A.C.E. code is a combination of codes 15 digits one digit for country code, two digits for state code, three-digit area code, four digits of building code and five digits of zip code
1 digit for country code locates Country for account-code transaction
2 digits for state code electronically locates State, of Country, for account-code transaction
3 digits for area code electronically locates Area, of that State, of that Country, for the account-code transaction
4 digits for building code and 5 digits for zip code electronically locates FIG. IX PEACE converter connection of business or companies computerized resource which intern engages into operations.
USAGE By either PhonExpress number or letter keys on keypad, keyboard, or remote pad, entering of PEACE Code of numbers or/and letter pertaining to country, state, area code, building code, zip code [-/- -/- - -/- - - -/- - - - -] 15 digits.
METHOD OF USAGE: AFTER ENTRY FIG. X: P.E.A.C.E. base unit locates and engages operations opening a direct line of electronic digital communication to FIG. IX: P.E.A.C.E. converter that is connected to business or companies computerized resource server of the PEACE code numbers-letters entered in.
Intern PhonExpress A12 LCD screen displays [Enter Code] by entering numbers and letters on either of PhonExpress keypad, keyboard, or remote pad.
USAGES By pressing on the number-letter keys and enter key, enables entry of choice of a code, pertaining to informational data such as either a reference code, record code, document code of numbers.
Then FIG. IX: P.E.A.C.E. converter engages into operations data processing program obtaining the informational data of code entered in. FIG. IX: P.E.A.C.E. converter retrieves data from business or companies computerized resource server and a convert transmission to digital signals transmitting data directly back to any of the PhonExpress devices is being used.

### FIG. I-B SIDE 2 METHODS OF CODE PORTALS

SPECIFICATION OF FIG. I-B PhonExpress system card

### METHODS OF ACCOUNT-CODE PORTALS

### FIG. I-B: SIDE 2: PORTAL G [3] Security-line: FOR INFORMATIONAL DATA

### IF COST-METHOD OF PAYING ACCESSING FUNDS

### METHOD OF USAGE: By sliding choice of either FIG. I-F: PhonExpress system card Portal B [1] Financial-line for funds of currency or FIG. I-F: Portal C [2] Credit-line for usage of credit funds. Portal using digital strip Faces in-ward Through A3 Slot-port on any of FIG. II-FIG. VIII PhonExpress device being used. Then enter account number enables activation, enter security code number enables accessible by pressing on number keys indicating entry and press enter key on either PhonExpress keypad, keyboard, remote pad that's in use.

If choice of paying is with entry of FIG. I-1 PhonExpress slip-card Slip-port.

### PROCEED WITH METHODS OF OPEN/CLOSE KEY AND METHOD OF SLIP-PORT ACCESSING FUNDS

### METHOD OF ENTRY FOR AMOUNT OF FUNDS.

METHOD OF USAGE: by activation of A1 [A] Account-Code key, by pressing on letter [A] key located in-between letters [P] and [S] keys, then press enter key. PhonExpress device A12 LCD screen displays choice of options. Option 1 Amount Option 2 Tran-line Option 3 Direct-line.
METHOD OF USAGE: By choosing Option 1 Amount, by pressing number 1 key and then enter key on PhonExpress device keypad, keyboard or remote keypad. Which intern PhonExpress device changes usage in keys into either PhonExpress accountant keypad, PhonExpress accountant keyboard or PhonExpress accountant remote pad. Intern PhonExpress A12 LCD screen displays [Enter Amount] or on PhonExpress system's upper-right corner A12a LCD square on TV screen.
METHOD OF USAGE: Then by pressing number keys that indicate to dollar/cents amount and press enter key. Usage is with either currency or credit amounts. IF NO COST—PROCEED ON METHOD OF PRINT-OUT

### METHOD OF PRINT-OUT

By activation of A2 [S] System key, located on the right-side of [A] key and above the number 3 key.
METHOD OF USAGE: By pressing the letter [S] key and press enter key on either PhonExpress devices keypad, keyboard or remote pad using.
PhonExpress A12 screen displays a list of electronic mode of options to choose from.
METHOD OF USAGE: By choosing number 4 Ship-line, by pressing number 4 key and enter key on either PhonExpress keypad, keyboard or remote pad that is now using. Enters into choice and PhonExpress A12 screen displays options 1 Delivery or 2 Print-out.
METHOD OF USAGE: By choosing and pressing number 2 Print-out and enter key on PhonExpress device using, then PhonExpress device with printer connected. Prints out the informational data of the choice chosen.
13. FIG. I-B PhonExpress system card SIDE 2 METHODS OF CODE PORTALS
SPECIFICATION OF FIG. I-B: PhonExpress system card

### METHODS OF ACCOUNT-CODE PORTALS

### FIG. I-B: SIDE 2: PORTAL H [4] Consumers-line: FOR ELECTRONIC SHOPPING

Is an electronic digital terminal for informational data. 04-line, Social Security and P.E.A.C.E. code for converter Number [04- - -/- -/- - - - P.E.A.C.E.] which opens a direct line to any FIG. IX: P.E.A.C.E. converters for informational data processing program
Binary codes product codes, USP labels, stock numbers shipping codes price numbers, numbers and letters to obtain METHOD 1: By swiping FIG. I: PhonExpress system card Portal using digital strip Faces in-ward through A3 Slot-port on any FIG. II-FIG. VIII PhonExpress devices transmits digital signals of an account-code portal 04-line, Social Security Number and P.E.A.C.E. code to FIG. X P.E.A.C.E. base unit. Intern engages into H [4] Consumers-line portal terminal for entry to any P.E.A.C.E. converters. Intern PhonExpress screen displays [Enter Code].
USAGE is By pressing on the numbers or/and letters keys and after entering in the full 15-digits then press enter key on either of the PhonExpress keypad, keyboard, or remote pad. PEACE code system's15-digit code pertains to 1-digit country, 2-digit state, 3-digit area code, 4-digit building code and 5-digit zip code [-/- -/- - -/- - - -/- - - - -].

### OR

METHOD 2: by activation of A [P] PhonExpress key, by pressing on the letter [P] key and then enter key on any FIG. II-FIG. VIII PhonExpress devices. Then the PhonExpress device A12 LCD screen displays electronic options to choose from. Option 1 PEACE-line Option 2 Trans-line Option 3 Direct-line
By choosing entry of electronic option 1 P.E.A.C.E.
METHOD OF USAGE by pressing number 1 key and enter key on either PhonExpress keypad, keyboard, or remote pad using. Then PhonExpress screen displays choice of electronic options of 1 Portals or 2 Slip-Portals. By choosing 1 Portal enables for choice of PhonExpress Portals PhonExpress A12 screen displays options of Portals By choosing Portal number H [4] Consumers-line enters into account-code digital portal terminal for shopping. USAGE By pressing number 4 and enter key on either PhonExpress keypad, keyboard, or remote pad using. FIG. X: P.E.A.C.E. base unit Intern engages into H [4] Consumers-line portal terminal for entry to any FIG. IX: P.E.A.C.E. converters. Intern PhonExpress A12 LCD screen displays [Enter PEACE Code]
METHOD OF USAGE By usage of either PhonExpress keypad, keyboard, or remote pad using. By entering code numbers pertaining to country, state, area code, building code, zip code [-/- -/- - -/- - - -/- - - - -] 15 digits.
METHOD OF USAGE By pressing either numbers or letter of choice to indicate which country, state, area, building and zip for location and then press enter key on PhonExpress device using of keypad, keyboard or remote keypad.
FIG. I-B PhonExpress system card SIDE 2 METHODS OF CODE PORTALS
SPECIFICATION OF FIG. I-B: PhonExpress system card

### METHODS OF ACCOUNT-CODE PORTALS

### FIG. I-B: SIDE 2: PORTAL H [4] Consumers-line FOR ELECTRONIC SHOPPING

AFTER CHOICE OF EITHER METHODS of entry, then Intern FIG. X: P.E.A.C.E. base unit locates and engages operations into opening a direct line of digital signals communication to any FIG. IX: P.E.A.C.E. converter that is connected to business or companies computerized resource server and obtaining informational data processing program of inventory and prices. Through binary codes, department numbers, product codes, USP labels, stock numbers shipping codes, price numbers, numbers and letters to obtain data of items, products, merchandize from any business or company computerized resource server. PhonExpress screen displays a list number of departments to choose from. By pressing number indicated to department of choice and enter key by using number keys on either of the PhonExpress keypad, keyboard, or remote pad.
FIG. X: P.E.A.C.E. converter obtains information and then with operations transmits to PhonExpress device and displays on the screen a list of numbered items to choose from. By the pressing number selected indicating item of choice and press enter key on either PhonExpress keypad, keyboard, remote pad/using.
FIG. IX: P.E.A.C.E. converter operations obtains information, transmits back to PhonExpress device A12 LCD screen displays, amount of item chosen and prices. PhonExpress A12 LCD screen displays [any corrections] proceed on to answer with
METHOD OF ANSWERS answering by pressing on either then press enter key on either PhonExpress keypad, keyboard, remote pad/using.
A8 “YES” if answer “YES” press A8 [*] Star key and then enter key.
A9 “NO” if answer “NO” press A9 [#] Pound key and then enter key.

METHOD OF ANSWERS FOR ANY CORRECTIONS

METHOD OF ANSWER YES by answering yes enables change or removes item and price
If answer “YES” press A8 [*] Star key for “YES” and then enter key on either PhonExpress keypad, keyboard, remote pad/using.
ANSWERED “YES” Then PhonExpress A12 LCD screen displays a list of numbers indicating the items and prices. Proceeding on by choosing the number indicating the item to be electronically removed from list.
By pressing the number indicated and enter key on either of PhonExpress keypad, keyboard, remote pads using. PhonExpress subtracts item most recently chosen. PhonExpress Promptly asks if want to continue by displaying on A12 LCD screen [continue]. Proceed on with
METHOD OF ANSWER “NO” PhonExpress continues on with shopping
If answers “NO” press A9 [#] Pound key for “NO” and then enter key on either PhonExpress keypad, keyboard, remote pad/using. PhonExpress Promptly asks if want to continue by displaying on A12 LCD screen [continue]. Proceed on with
FIG. I-B PhonExpress system card SIDE 2: METHODS OF ACCOUNT-CODE PORTALS
SPECIFICATION OF FIG. I-B: PhonExpress system card

### METHODS OF ACCOUNT-CODE PORTALS

### FIG. I-B: SIDE 2: PORTAL H [4] Consumers-line: FOR ELECTRONIC SHOPPING

### METHOD OF ANSWER FOR CONTINUE

CONTINUE PhonExpress A12 LCD screen displays [Continue] Proceed on with Method of Answers
Answering by pressing either A8 Star key for “YES” or Pound key for “NO” then enter key on either of PhonExpress keypad, keyboard, remote pad using.
METHOD OF ANSWERING by answering of either A8 [*] Star key for “YES” or Pound key for “NO”
ANSWERED “YES” PhonExpress continues on with shopping
If answer “YES”
METHOD OF USAGE: By pressing on A8 [*] Star key for “YES” and then enter key on either PhonExpress keypad, keyboard, remote pad used
ANSWERED “NO” By answering “NO” PhonExpress Stops shopping, finishes the amount of the transaction by displaying total on A12 LCD screen [dollar/cents] amount
If answer “NO”
METHOD OF USAGE: By pressing on A9 [#] Pound key for “NO” and then enter key on either PhonExpress keypad, keyboard, remote keypad used.

METHOD OF PAYING USAGE OF PORTAL

By sliding choice of either FIG. I-F: Portal A [1] Financial-line for funds of currency or FIG. I-F: Portal C [2] Credit-line for usage of credit funds, through A3 Slot-port. Then PhonExpress A12 LCD screen displays [enter account number] By pressing on number keys indicating the account number and then press enter key on either PhonExpress keypad, keyboard, remote pad/using. ACTIVATION
PhonExpress device A12 LCD screen displays [enter security code] By pressing on numbers indicating the security code number of that account number entered and then press enter key on either PhonExpress keypad, keyboard, remote pad used. ACCESSIBILITY. Proceed on method of A Account-code key, electronic option 1 Amount key for entry of amount.

### 14. FIG. I-I-L Slip-card LEFT-SIDE SLIP-PORT METHOD OF PAYING

METHOD OF USAGE: By pressing on K1 open/close key on Left-side Side 1 of FIG. I-F PhonExpress system card, protracts out the concealed left-side Two Slip-ports FIG. I-1 PhonExpress slip-card.
METHOD OF USAGE: By sliding either One of the FIG. I-I-L Two Slip-ports of choice using digital strip Facing in-ward through A3 Slot-port on PhonExpress device in use. Then PhonExpress electronically transmits to FIG. X PEACE base unit. Which intern engages into operations. Simultaneously PhonExpress A12, A12a or A12b LCD screen displays a list of five computerized digital account options.

### SEE METHODS FIG. I-I-Lb SIDE 2 LEFT-SIDE SLIP-PORTS FIVE ACCOUNT OPTIONS OF CURRENCY OR CREDIT

### OPTION 1: OPTION 2: OPTION 3: OPTION 4: OPTION 5:

METHOD OF USAGE: By pressing on number keys indicating which one of choice chosen of the five digital computerized account with funds of currency or credit to use, then press enter key on PhonExpress keypad, keyboard, remote pad used.

### ACTIVATION OF ONE COMPUTERIZED DIGITAL ACCOUNT

Intern PhonExpress device A12, A12a or A12b LCD screen displays [enter security code]
METHOD OF USAGE: By pressing on number keys indicating the Security Code number of that account number entered and then press enter key on either PhonExpress keypad, keyboard, remote pad used.

### ACCESSIBILITY.

PROCEED ON METHOD OF AMOUNT ENTRY of [A] Account-code key, electronic option 1 Amount key for entry of amount.

### 15. FIG. I-B SIDE 2: METHODS OF CODE PORTALS

SPECIFICATION OF FIG. I-B: PhonExpress system card

### METHODS OF ACCOUNT-CODE PORTALS

### FIG. I-Ba: SIDE 2: PORTAL G [3] Security-line: FOR INFORMATIONAL DATA

### FIG. I-Bb: SIDE 2: PORTAL H [4] Consumers-line: FOR ELECTRONIC SHOPPING

### METHOD OF ENTERING AMOUNT

### METHOD OF ACTIVATION OF A1 [A] Account-code key

METHOD OF USAGE: By pressing on A1 [A] Account-code key and press enter key on PhonExpress keypad, keyboard, remote pad used
PhonExpress A12 LCD screen displays a list of options to choose.

### OPTION 1 AMOUNT

### OPTION 2

### OPTION 3

METHOD OF USAGE: OPTION 1 AMOUNT By choosing option 1 Amount key, by pressing number 1 key and enter key on PhonExpress device keypad, keyboard or remote keypad. Enables PhonExpress system to electronically change the original usage of keys on either keypad, keyboard, remote pad used, into Accountant keys on either keypad, keyboard, remote pad used. Enables PhonExpress operations for entry of a dollar/cent amount for funds of either currency or credit.
Intern PhonExpress A12, A12a or A12b LCD screen displays [Enter Amount]
METHOD OF USAGE: ENTER AMOUNT: By pressing on the numbers indicating the dollar or/and cents of amount on accountant number keys and then press enter key on PhonExpress accountant keypad, accountant keyboard or accountant remote pad used. Enables amount for either currency or credit processing for paying or sending funds.

### DELIVERY METHOD

METHOD OF USAGE: By activation of A2 [S] System key, by pressing letter [S] and enter key. PhonExpress screen displays a list of options to choose.

### OPTION 1 PEACE-LINE: OPTION 2 TRANS-LINE OPTION 3 PASS-LINE: OPTION 4 SHIP-LINE

METHOD OF USAGE: By choosing number 4 Ship-line, by pressing 4 and enter key on either PhonExpress device using keypad, keyboard or remote pad. PhonExpress A12 LCD screen displays

### OPTION 1 Delivery or OPTION 2 Print-out.

METHOD OF USAGE: By choosing number 1 Delivery, by pressing number 1 key and enter key on PhonExpress device keypad, keyboard or remote keypad used.
Which intern PhonExpress device A12, A12a, or A12b LCD screen displays [Enter address]
By pressing letter or/and number keys indicating address to deliver items to and then press enter key on either of PhonExpress device keypad, keyboard or remote pad used.
Then electronically through system's FIG. IX PEACE converter communicates and relates the obtained data of items, products or merchandize chosen and purchased from business or company computerized resource server. Then FIG. IX PEACE system's converter and engages into operations with business or company computerized resource server for delivery of purchased products. Along with simultaneously Distributes out receipts to both PhonExpress device used and business or company computerized resource server. And obtains account-code transactions between both parties for records, and distributes out P.E.A.C.E. monthly statement, to both parties.

### 16. SPECIFICATION OF FIG. X P.E.A.C.E. BASE UNIT: DIGITAL SIGNALS TRANSMISSION

PhonExpress Account-Code Electronic system P.E.A.C.E

P.E.A.C.E's ONE World system's usage through its PhonExpress devices of telephones, cellular telephones, telephone adapters, computerized keyboard, TV remote, store adapters, machine adapters, electronic doorways adapters, all done with usage of One PhonExpress system card.

FIG. X P.E.A.C.E-system base unit: is a computerized digital account-code electronic system. Electronically transmitting digital signals of communication simultaneously, digitally through FIG. II PhonExpress telephones, FIG. IV PhonExpress cellular telephones, FIG. III PhonExpress telephone adapters, FIG. V PhonExpress Store adapters, PhonExpress many other adapters FIG. VI A-FIG.-VI F and FIG. VII PhonExpress computerized keyboard, FIG. VIII PhonExpress TV remote and electronic operations of FIG. IX P.E.A.C.E. system digital converter. Activating and engaging into P.E.A.C.E. system's base unit operations, along with activation is accessing, transferring, sending, retrieving, processing account-code transactions and transferring informational data, with usage of binary number and code sequences, and electronic accountant.

P.E.A.C.E. system's operations Translating data into electronic digital signals engaging and obtaining data of electronic digital signals and transmitting operational methods. Combining digitally of account systems and code system's operations of accountants, retrieving digital informational data, electronically transmitting computerized digital signals between PEACE system's devices and business or companies computerized resource servers.

FIG. X P.E.A.C.E. BASE UNIT: DIGITAL SIGNALS TRANSMISSION PhonExpress Account-Code Electronic system P.E.A.C.E Electronic Transmission of digital signals of numbers and codes

METHOD Each Portal is an electronic entryway of activation to a line of terminals, transmitted through fiber-optic cable, or via radio waves transmitted through via satellite, transmits to P.E.A.C.E. system base unit that identifies and recognizes analyzes computerized digital signals, electronically transmitting digital signals. With P.E.A.C.E. system operations of interlocking numerals and alphabetical code and binary code systems simultaneously electronically communicates digital signals back and forth. Opening a line with both PhonExpress telephone through via satellite, to wide area network W.A.N. then local area network L.A.N. to a computerized resource systems of accounts and/or codes with FIG. IX P.E.A.C.E. converter connected to businesses or companies computerized resource servers. This activates and access electronically through the transmitting of digital signals from PhonExpress telephone operational keys and/or electronic transmission of account-code slot-port. Transmitting digital signals through fiber-optic cable through via satellite system to P.E.A.C.E-system base unit. This activates P.E.A.C.E. system base unit to engage into operations. Of electronic operational modes, with activation, accessing, transferring, sending, retrieving, processing account transactions and transferring informational data, with usage of binary number and code sequences, and electronic accountant. Translating data into electronic digital signals, transmitting through via satellite system or via radio waves to either of PhonExpress telephones, PhonExpress cellular telephones PhonExpress telephone adapters. Which intern distributes receipts or/and informational data through connections of printer.

### 17. SPECIFICATION OF FIG. I-1 P.E.A.C.E. ELECTRONIC CONVERTER: DIGITAL SIGNALS TRANSMISSION:

Electronic Transmission of digital signals of numbers and codes
P.E.A.C.E. system's Converter is electronically connected to business or companies computerized resource server. This engages into businesses or companies computer servers of which data is translated into electronic digital signals, then transmitted back to PhonExpress telephones. Transmitting data of any records, documents, reference numbered documents, inventory, prices, item/item codes, P.E.A.C.E. system's Converter electronically enables to recognize and relay all data. Transmitting data through PhonExpress telephone where caller engages in retrieves informational data, of records, documents etc. this way for caller usage of P.E.A.C.E. system operations for retrieving informational data and Shopping for items, pricing items, anywhere anytime worldwide. Enables caller to purchase items and pay immediately to the businesses or companies account systems, and caller is able to have item/items delivered.
FIG. IX: P.E.A.C.E. converter that is connected to business or companies computerized resource server and obtaining informational data processing program of inventory and prices. Through binary codes product codes, USP labels, stock numbers department numbers, shipping codes, price numbers, numbers and letters to obtain items, products, merchandize from any business or company PhonExpress telephone, PhonExpress cellular telephone, PhonExpress adapters, PhonExpress account-code electronic system is built into original telephone systems, and cellular telephone systems, PhonExpress computerized keyboard, PhonExpress TV remote, PhonExpress adapters, which enables P.E.A.C.E. system's PhonExpress into operations. PhonExpress telephone works the same as the original telephone, cellular telephone, computerized keyboard, TV remote, except by adding and usage of PhonExpress account-code electronic system operational keys, PhonExpress card system slot-port, PhonExpress receipt distributor.
And FIG. III PhonExpress telephone adapter is built the same way as FIG. II PhonExpress telephone.
FIG. IV PhonExpress cellular telephone does not display the same. For options of receipts this does have connectors of printer or receive monthly P.E.A.C.E. statement.

DESCRIPTION OF LOCATION: ATTACHMENTS PhonExpress attachments: see in drawings

FIG. II PhonExpress telephone: attachments are located at the top of PhonExpress telephones, attachment for an original telephone cord that connects into telephone wall out-let, attachment for computer is in-between attachment of telephone cord that plugs into wall out-let , attachment to printer located at the top, on right side of attachment to computers, FIG. III PhonExpress telephone adapter: attachments are located at the top of FIG. III PhonExpress telephone adapter. Attachment for an original telephone system, located at the top, left side, attachment for computer is located at the top, between an original telephone attachment and an attachment for printer, attachment for printer is located at the top, on right side, enables ability for printer for larger prints of data.

FIG. IV PhonExpress cellular telephone: attachments are located at the bottom of FIG. IV PhonExpress cellular telephone. Attachment for out-let, located on left side at bottom. Attachment for printer is located in between attachment for charger wall out-lets and attachment for car charger, the car charger attachment is located on the right side at the bottom of PhonExpress cellular telephone. Enables for printing of classified informational data.

LOCATION OF: FIG. IX P.E.A.C.E. Converter: FIG. IX P.E.A.C.E. system Converter is located at business or companies computers, electronically connected to business or companies computerized resource server

I claim:

1. I Patricia Grace Martin am the sole-proprietor

2. INVENTION OF: The P.E.A.C.E. System: PhonExpress Account-Code Electronic System:

3. Idea

4. Title Names

5. Makings

6. Designs

7. Drawings
Methods of combining usage and electronic operation.
I CLAIM

1. P.E.A.C.E. system's ONE PhonExpress system card and two open/close keys and its hidden PhonExpress slip-card.

| 1. | P.E.A.C.E. system's ONE PhonExpress system and two open/close keys and its hiddent PhonExpress slip-card. | | |
|---|---|---|---|
| 2. | FIG I-F PhonExpress system card | | Front-side of card |
| 3. | PORTAL A | [1] Financial-line | Portal to accounts-code process of any type of currency |
| 4. | PORTAL B | [2] Credit-line | Portal to accounts-code of any type of credit |
| 5. | LK1 LEFT-SIDE Open/Close key | | |
| 6. | RK2 RIGHT-SIDE Open/Close key | | |
| 7. | FIG I-B PhonExpress system card | | Backside of card |
| 8. | PORTAL C | [3] Security-line | Portals to codes-account of any type of informational data |
| 9. | PORTAL D | [4] Consumers-line | Portals to codes-account for electronic shopping for any |
| | | | type of product |
| 10. | FIG I-1-L PhonExpress Slip-card | | Protracts-out and retracts-in the Left-side |
| 11. | SLIP-PORT E | [5] Reserve-line | Slip-ports to Five computerized account options any type |
| | | | of currency |
| 12. | SLIP-PORT F | [6] Express-line | Slip-ports to Five computerized account options any type |
| | | | of credit |
| 13. | FIG I-1-R PhonExpress Slip-card | | Protracts-out and retracts-in the Right-side |
| 14. | SLIP-PORT G | [7] IDH-line | Slip-ports to Five computerized account options that |
| | | | pertains to sustaining and accessibility for |
| | | | ‘card-owner’ informational data, Identifiable of only |
| | | | the ‘card-owner’ |
| 15. | SLIP-PORT H | [8]MDH-line | Slip-ports to Five computerized account options that |
| | | | pertains to sustaining and accessibility for |
| | | | ‘card-owner’ informational data, Identifiable Medical |
| | | | usage and data of only the ‘card-owner’ |

I Patricia Grace Martin CLAIMS the following
I CLAIM
The P.E.A.C.E. system's built in electronic components of PhonExpress system operations of ‘7’ keys

16. KEY [P] PhonExpress

17. KEY [A] Account-code ACCOUNTANT KEY

18. KEY [S] System

19. Slot-port

20. KEY C/C/C

21. KEY PhonExpress placement key

22. KEY SAVE ‘IN P.E.A.C.E. System’

23. KEY ENTER ‘INTO P.E.A.C.E. System’

24. ADDITION ATTACHMENTS

25. Electronic mathematical calculator

26. Distribution of receipts,

27. P.E.A.C.E. receipts

28. Printer accessibility
I CLAIM

29. P.E.A.C.E. system's Combining Process operations built into various devices; telephones, cellular telephones, computer key board, electronic door-entry ways, any kind of vehicles' transportation, adapters, product machines.

30. P.E.A.C.E. system's formula usage of account-codes and code-accounts, of electronic transmission of digital numbers P.E.A.C.E. system's usage with accounts of any type of currency and any type of credit, and usage of codes for obtaining informational data of inventory, address, and any codes to obtain informational data of documents, records, est. and electronic shopping worldwide process, immediate purchase of product, and delivery capabilities Process enabling people themselves control over their own account-code and code-account transactions, at residence, office, anywhere, anytime, day or night worldwide.
I CLAIM

31. Combining all electronic operations P.E.A.C.E. system activation, accessibility to send, receive, retrieve, obtain, transfer, through electronic usage of transmission through the ‘4’ Portals, and the ‘4’ Slip-ports, and combines all businesses and companies accounts and codes all process together into the P.E.A.C.E. system's ONE PhonExpress system card and usage of two open/close keys that activates its hidden PhonExpress slip-card.

32. P.E.A.C.E. converter P.E.A.C.E. system electronic computerized process that relays in-put and out-put of account-code and code-account data; of any type of accounts, currency and credit, and product pricing, inventory, delivery codes, computerized processing of transmission synchronizing with P.E.A.C.E. system built-in devices of operations', and P.E.A.C.E. system base unit electronic transmission of digital or non digital signals through

33. P.E.A.C.E. system's base unit coordinated through satellites to and from devices used by ‘card-owner’ any time day or night worldwide.
P.E.A.C.E. system operations built into each of the following devices:
FIG. II PhonExpress system telephone
FIG. III PhonExpress system desk telephone
FIG. IV PhonExpress system cellular telephone
FIG. V PhonExpress system adapters A-E
FIG. VI PhonExpress system store adapter
FIG. VII PhonExpress system computerized keyboard
FIG. VIII PhonExpress system TV remote
FIG. IX PhonExpress system Converter
FIG. X PhonExpress system base unit
P.E.A.C.E. system electronic transmission of account-codes and code-accounts process
FIG. XI Transmission
FIG. XI A-B-C Transmission.
